(19) United States
(12) Patent Application Publication
(10) Pub. No.: US 2025/0343448 A1
(43) Pub. Date: Nov. 6, 2025

(54) MOTOR

(71) Applicant: Masayuki NASHIKI, Aichi (JP)

(72) Inventor: Masayuki NASHIKI, Aichi (JP)

(21) Appl. No.: 18/281,841

(22) PCT Filed: Jan. 13, 2022
(86) PCT No.: PCT/JP2022/001004

§ 371 Date: Jun. 30, 2025

(30) Foreign Application Priority Data
Mar. 26, 2021 (JP) 2021-054408

(51) Int. Cl. H02K 1/17; H02K 1/16; H02K 1/24; H02K 1/276; H02K 3/28; H02K 11/00

(52) U.S. Cl. CPC H02K 1/17; H02K 1/16; H02K 1/24; H02K 1/276; H02K 3/28; H02K 11/0094; H02K 2213/03

(57) ABSTRACT

[Problem] To improve the torque of a motor.

[Solution] There is provided a motor in which a rotor is driven to rotate by driving stator magnetic poles which are able to generate torque in a desired direction. In the motor, rotor N and S magnetic poles are arranged alternately in a circumferential. Between the N and S magnetic poles, a permanent magnet is arranged such that a polarity direction of the permanent magnet is oriented in a direction of the polarities of the rotor magnetic poles. The respective rotor magnetic poles are configured to be able to supply more magnetic fluxes by utilizing magnetic fluxes which pass the adjacent rotor magnetic poles in the circumferential. As such a configuration, the stator N magnetic poles and stator S magnetic poles which are magnetically excited by a unidirectional electric current are arranged alternately in the circumferential.

### TECHNICAL FIELD

Due to global environmental issues, there is a movement to replace fossil fuels and other energy sources with natural energy. In addition, gasoline engine drives are being replaced by motor drives, and the importance of motors and their drive systems is increasing. The present invention relates to motors for the main engines of electric vehicles, motors for home appliances, motors for industrial machinery, and driving technology for motors. The present invention also concerns high torque, high efficiency, downsizing, weight reduction, cost reduction, or other advantageous effects of such a motor.

Since conventional motors and drives often inherit and share common conventional motor technology, conventional power elements, and conventional control technology, such as 3-phase AC or sinusoidal voltage and current, motors and drives have sometimes been discussed separately. However, when new possibilities are pursued, they can sometimes be realized by combining a new motor with new drive circuits and new control technology. The motor of the present invention cannot be driven by a commercially available 3-phase inverter. In the present invention, the motor, drive circuit, and control are combined to achieve higher torque, higher efficiency, smaller size, lighter weight, and lower cost.

### BACKGROUND ART

FIG. 63 shows an example of a cross-sectional view of a conventional 3-phase switched reluctance motor. A reference number 639 indicates a stator, which is composed of a 3-phase stator provided with 6 butt-shaped stator magnetic poles. A reference number 63B indicates a rotor shaft. Reference numbers 63A, 63F indicates rotor butt-shaped magnetic poles, which are located at four locations around the entire circumference, wherein the four locations are equally spaced with a circumferential width of 30°. A reference number 631 indicates an A/-phase stator magnetic pole, and a reference number 637 indicates an A-phase concentrated winding wound as shown by double lines at the coil end thereof. The current flowing through each of the windings of this motor is a unidirectional current, and each winding is indicated by a current symbol to show the direction of current flow. The symbol circled with an X letter shape energizes A-phase current Ia, which flows from the front side of the paper to the back side, and the symbol circled with a black circle energizes A-phase current Ia, which flows from the back side of the paper to the front side. Therefore, when energizing the current, the A/-phase stator magnetic pole 631 becomes S-pole. A reference number 632 represents an A/-phase stator magnetic pole, which has an inverse phase relationship to the A phase structure. An A/-phase concentrated winding 638 is wound as shown by the double lines at the coil end. The A-phase current Ia is also energized to the A/-phase winding, so that the A/-phase stator magnetic pole 632 becomes the N pole. The magnetic poles 631 and 632 are excited simultaneously to produce an A-phase flux component pa, indicated by an arrow 63E, in the rotor. The A-phase magnetic flux component φa is passed, toward from the lower side to the upper side of the paper, through the stator magnetic pole 632, the rotor magnetic pole 63F, the rotor magnetic pole 63A, and the stator magnetic pole 631, thereby making the A-phase magnetic flux component φa circulate through the back yoke of the stator. In the state shown in FIG. 63, the rotor is subjected to a torque generated in the counterclockwise direction CCW of the rotor.

In the same way, a reference number 633 indicates a B-phase stator magnetic pole, around which a concentrated winding 63C is wound to energize a B-phase current Ib. A reference number 634 indicates a B-PHASE stator magnetic pole, around which a concentrated winding 63D is wound to energizes the B-phase current. B-phase flux passing from the stator magnetic pole 634 to the stator manganic pole 633 is shown by φb. A reference number 635 indicates a C-phase stator magnetic pole, which is wound by a concentrated winding 63G so that a C-phase current Ic is energized. A reference number 636 indicates a C-PHASE stator magnetic pole, which is wound by a concentrated winding 63G so as to energizes the C-phase current Ic. C-phase flux passing from the stator magnetic poles 636 to the stator magnetic pole 635 is shown by φc. The circumferential width of each of the stator magnetic poles is 30°, and the stator magnetic poles are equally spaced at six locations around the entire circumference. The name of each stator magnetic pole, such as phase A, is shown in brackets (A) on the outside of the stator 639 for clarity.

The operation of the switched reluctance motor shown in FIG. 63 is now described. For the rotational positions of the rotor, the rotational position of the clockwise direction end of the A/phase stator magnetic pole 631 is defined as the starting point of the rotor. The rotor rotation angle θr is defined as the rotation angle from this starting point to the CCW directional end of the rotor pole 63A, as shown in the figure.

How the switched reluctance motor in FIG. 63 rotates in the counterclockwise direction CCW will now be described. When the rotor rotation angle θr is between 0° and 30°, currents Ia in the A-phase and the A/-phase are energized to generate CCW torque. When the rotor rotation angle θr is between 30° and 60°, currents Ib in the B-phase and the B/-phase are energized to generate CCW torque. When the rotor rotation angle θr is between 60° and 90°, currents Ic in the C-phase and the C/-phase are energized to generate CCW torque. These A-phase, B-phase, and C-phase operations are repeated four times to make one rotation of the rotor.

Next, an example of the generated torque is described as shown in FIG. 64. When a constant A-phase current Ia is applied to the A-phase and A/phase of the switched reluctance motor shown in FIG. 63. The horizontal axis indicates the rotor rotation angle θr, which is shown from −5° to 30°. The vertical axis indicates the relative value of the torque T. For example, in FIG. 63, when the A-phase current Ia is the continuous rated current, torque is generated from around θr=−5° as shown by the solid line in FIG. 64, before rotor magnetic pole 63A has yet to face the stator magnetic pole 631, and a large amount of torque is generated in the vicinity of θr=0°, and the torque gradually decreases after θr=15°. When the A-phase current Ia is twice the continuous rated current, the peak torque increases as shown by the broken line in FIG. 64, and when it is three times the rated current, the peak torque increases as shown by the dotted line, but the angle range over which torque is generated decreases relatively. The causes of this decrease in the torque range are related to the distribution of the leakage magnetic fluxes in the air gap between the stator magnetic poles and the rotor magnetic poles and in the area around them, as well as to the magnetic saturation of the stator teeth and the rotor teeth.

One of the advantages of the conventional switched reluctance motor shown in FIG. 63 is that the rotor has a simple structure and is robust, making high-speed rotation easy.

In addition, it can be driven without using permanent magnets. Torque is generated by the attractive force of the reluctance force, and the drive algorithm is relatively simple. The stator winding is also simple and easy to manufacture, with a concentrated winding configuration for the armature. And because expensive rare earth permanent magnets are not required, the motor system can be configured at low cost.

Next, the problems with the conventional switched reluctance motor shown in FIG. 63 are now explained. The first problem is that when a large torque is generated, magnetic saturation occurs in the stator teeth and rotor teeth, which lowers the torque constant. The second problem is that since torque is generated sequentially using ⅓ of the total windings, the utilization rate of the windings is low at 33%, and the winding resistance is relatively large, resulting in large copper loss. The burden of exciting the magnetic fluxes of each phase is also large. Compared to other permanent magnet motors, it is easy for the motor to become large in size thereof. The third problem is that when a large torque is generated, torque saturation occurs in some parts, and as a result, the inverter becomes large in size thereof. The fourth problem is that, compared to other permanent magnet motors, the torque ripple is likely to be larger, and there is also a lot of vibration and noise due to fluctuations in the attractive force between the stator and rotor.

### CITATION LIST

### Patent Literature

[PTL 1] JP-B 3157162
[PTL 2] JP-A 2020-025377

[Non-Patent Literature]
[Non PTL1] 2016 IEE Japan, 3-36 (formula 1)

### SUMMARY OF THE INVENTION

### Problems to be Solved

In the present invention, permanent magnets are used in the rotor to achieve rotor magnetic poles that greatly increase the magnetic fluxes that can pass in the forward direction, and at the same time, a motor is proposed that is composed of rotor magnetic poles that allow little magnetic fluxes to pass in the reverse direction. As a result, torque is increased, motor efficiency is improved, and miniaturization of the size is achieved. In addition, permanent magnets are also used in the stator, and stator magnetic poles that greatly increase the amount of magnetic fluxes that can pass in the forward direction are achieved, while at the same time, stator magnetic poles that allow little magnetic fluxes to pass in the reverse direction are achieved. By increasing the amount of magnetic fluxes that pass through both the rotor and stator sides, it is also possible to achieve a large value of magnetic flux density in the airgap portion exceeding 2 [T], and to increase torque and reduce copper loss in the stator windings. As a result, it is possible to achieve a more compact, lighter and lower cost motor. In addition, as a method of constructing the motor, the combination of the number of stator magnetic poles and the number of rotor magnetic poles are optimized, the utilization rate of the windings and drive transistors are improved, and a smaller and lower cost motor and inverter is achieved. In addition, technologies for optimizing the shape of each part and combining magnetic materials are proposed.

### Solution

The invention according to claim provides a motor comprising:
a plurality of stator magnetic poles Ps arranged in a stator in a circumferential thereof;
a plurality of slots SLs each provided between adjacent two of the respective stator magnetic poles Ps;
a plurality of stator windings each provided at each of the slots SLs and configured to magnetically excite each of the stator magnetic poles Ps;
unidirectional drive circuits Dhv each driving one-way current to each of the stator windings Ws;
a plurality of rotor N magnetic poles Prn arranged in a rotor in a circumferential thereof;
a plurality of rotor S magnetic poles Prs arranged in the rotor alternately to each of the rotor N magnetic poles Prn in the circumferential of the rotor;
a magnetic path MPrn made of a soft magnetic material and configured to magnetically connect each of the rotor N magnetic poles Prn to a rotor-common back yoke;
a magnetic path MPrs made of the soft magnetic material and configured to magnetically connect each of the rotor S magnetic poles Prs to the rotor-common back yoke; and
a permanent magnet PMrbi arranged between the magnetic path MPrn and the magnetic path MPrs which are arranged in the circumferential and provided to have magnetic poles whose direction is matched with both the rotor magnetic poles Prn and Prs.

According to this configuration, a large magnetic flux can be applied to the rotor magnetic poles which are excited and act, so a large torque can be generated.

The invention according to claim 2 provides the motor, which is dependent from claim 1, characterized in that
the stator magnetic poles Ps are equipped with
stator N magnetic poles Psn, functioning as N magnetic poles, which are N magnetic poles and S magnetic poles alternately arranged in the circumferential;
stator S magnetic poles Pss, functioning as S magnetic poles, which are alternately arranged with the stator N magnetic pole Psn in the circumferential; and
permanent magnets PMsbi, each of which is arranged between the stator N magnetic pole Psn and the stator S magnetic pole Pss which are aligned in the circumferential, the permanent magnets being arranged to be oriented such that that the magnetic poles of the respective permanent magnets are made to agree with magnetic poles of both the stator magnetic poles Psn and Pss.

According to this configuration, a large magnetic flux can be applied to the stator magnetic poles and rotor magnetic poles Prn and Prs, which act by magnetic excitation, so that a large torque can be generated.

The invention according to claim 3 provides the motor, which is dependent from claim 1, characterized in that the stator magnetic-pole windings Ws are concentrated windings Wscp that magnetically excite each of the stator magnetic poles Ps.

According to this configuration, each stator magnetic pole winding Ws is less affected by the control state of other stator magnetic poles, and can be freely magnetically excited to drive the rotor.

The invention according to claim 4, which is dependent from claim 1, characterized in that the stator magnetic-pole windings Ws are full-pitch stator windings Wsfp with a winding pitch having approximately ½ of a cycle of magnetic-pole pairs of the stator.

According to this configuration, the exciting current components of the stator magnetic poles that are in action and the exciting current components of the neighboring stator magnetic poles in the circumferential are controlled so that they become current components in the same direction and do not overlap each other. As a result, copper loss in the slots can be reduced by about half.

The invention according to claim 5, which is dependent from claim 1, characterized in that the motor comprises
Nps stator magnetic poles Ps, wherein Nps=2+4×Ns; and
rotor N magnetic poles Prn and rotor S magnetic poles Prs, which are in total Npr pieces, wherein Npr=2+4×Nr, Ns and Nr being integers greater than or equal to 1.

According to this configuration, the N-polarity stator magnetic poles Psn, S-polarity stator magnetic poles Pss, each stator winding, N-polarity rotor magnetic poles Prn, and S-polarity rotor magnetic poles Prs can be arranged evenly in the circumferential. This makes for high torque generation efficiency and excellent motor manufacturability.

The invention according to claim 6, which is dependent from claim 1, characterized in that
the number of phases of the plurality of stator magnetic poles Ps is Nph, and
the motor is provided with Nph stator magnetic poles which are partially provided in the stator in the circumferential, wherein phases of the stator magnetic poles to the rotor magnetic poles differ from each other by (2×θppr)/Nph, which are provided when the pitches of the rotor magnetic poles of the N-magnetic poles Prn and the S-magnetic poles Prs which are arranged alternately in the circumferential of the rotor, is given as θppr, and Nph is an integer greater than or equal to 2.

According to this configuration, it is possible to achieve a motor configuration with two or three phases without having to arrange those components evenly in the circumferential, and to obtain desired specific characteristics.

The invention according to claim 1, which is dependent from claim 1, characterized in that when a circumferential length of the magnetic poles facing an air gap portion of the stator magnetic poles Ps is Lsg, a circumferential width of a portion of teeth of the stator magnetic poles Ps is a width which is larger than Lsg by an amount of 20% or more.

According to this configuration, the restriction on the magnetic fluxes passing through the stator magnetic pole can be reduced, so that the motor torque can be increased.

The invention according to claim 8, which is dependent from claim 1, characterized in that the motor is equipped with permanent magnets PMssur whose polarities are made to agree with the polarities of the stator magnetic poles, the permanent magnets being arranged closer to an air gap faced to the N-magnetic pole Psn and the S-magnetic pole Pss of the stator magnetic pole Ps.

According to this configuration, the burden of exciting the magnetic fluxes can be reduced, in other words, the reactive currents that excite the magnetic fluxes can be reduced. This reduces the adverse effects of voltage caused by the flow of magnetic energy between the power supply and the motor.

The invention according to claim 9, which is dependent from claim 4, characterized in that the motor is provided with
the stator magnetic poles Ps whose number is Nkb×N1, of which stator magnetic poles Ps1, Ps2, Ps3, Ps4, and Ps5 are aligned in the circumferential;
a slot SLs1 located between the stator magnetic poles Ps1 and Ps2;
a slot SLs2 located between the stator magnetic poles Ps2 and Ps3;
a slot SLs3 located between the stator magnetic poles Ps3 and Ps4;
a slot SLs4 located between said stator magnetic pole Ps4 and Ps5;
a full-pitch winding Wsfp1, which is wound between two slots approximately ½ of a cycle of the stator pole pairs apart and is located in slot SLs1;
similarly, a full-pitch winding Wsfp2 arranged in the slot SLs2;
similarly, a full-pitch winding Wsfp3 arranged in the slot SLs3;
similarly, a full-pitch winding Wsfp4 arranged in the slot SLs4;
a rotor equipped with at least Nkb×N2 rotor magnetic poles of N-polarity and S-polarity arranged alternately in a circumference;
a transistor TR1 connected in series with the full-pitch winding Wsfp1;
a transistor TR2 connected in series with the full-pitch winding Wsfp2;
a transistor TR3 connected in series with the full-pitch winding Wsfp3; and
a transistor TR4 connected in series with the full-pitch winding Wsfp4;
wherein
the transistor TR1 energizes the full-pitch winding Wsfp1 with a DC current Isfp1 and connects the full-pitch winding Wsfp1 and the full-pitch winding Wsfp2 in series with the transistor TR2,
the transistor TR2 energizes the full-pitch winding Wsfp2 with a DC current Isfp2 and connects the full-pitch winding Wsfp2 and the full-pitch winding Wsfp3 in series with the transistor TR3;
the transistor TR3 energizes the full-pitch winding Wsfp3 with a DC current Isfp3 and connects the full-pitch winding Wsfp3 and the full-pitch winding Wsfp4 in series with the transistor TR4;
the transistor TR4 energizes the full-pitch winding Wsfp4 with a DC current Isfp4;
each of the full-pitch windings connected in series and each of the transistors TR1, TR2, TR3, and TR4 magnetically excite each of the stator magnetic poles Ps1, Ps2, Ps3, Ps4, and Ps5 by energizing each exciting current thereto; and
when the motor has three full-pitch windings, the full-pitch winding Wsfp1 and the full-pitch winding Wsfp4 are composed of the same winding, and the full-pitch winding Wsfp3 and the full-pitch winding Wsfp1 are arranged in parallel and connected to the transistor TR4 to conduct a DC current thereto,
wherein Nkb is the number of stator pole pairs and is an integer greater than or equal to 1, N1 is an integer greater than or equal to 6, and N2 is an integer greater than or equal to 6.

According to this configuration, it is possible to accurately excite a specific stator magnetic pole with its exciting current component, and that exciting current components will not affect the stator magnetic poles of the other phases. In addition to this, the magnetic flux linkage of the other phases is canceled out by the two windings connected in series, and the magnetic fluxes of the other phases are minimized, allowing the currents to be passed and controlled.

The invention according to claim 10, which is dependent from claim 1, characterized in that the respective phase windings of the stator windings Ws is configured to be supplied continuously with magnetic flux exciting current components depending on drive conditions thereof, or, magnetic flux exciting windings are wound in respective slots of the stator and connected in series to supply magnetic flux exciting currents thereto.

According to this configuration, magnetic energy is automatically transferred in and out between the power source and the motor by continuously energizing a constant current. In particular, large changes in magnetic fluxes when regenerating magnetic energy, i.e., excessive voltage, can be reduced. This reduces harmful effects on the current control of other phases.

The invention according to claim 11, which is dependent from claim 1, characterized in that the motor is equipped with
a DC power source POS2;
a DC power source POS3 connected in series with the DC power source POS2;
an intermediate potential portion TYV located between the DC power source POS2 and the DC power source POS3;
a transistor TR7 connected to the DC power source POS2;
a winding Ws2 arranged between the transistor TR7 and the intermediate potential portion TYV;
a transistor TR8 connected to the DC power supply POS3; and
a winding Ws3 arranged between the transistor TR8 and the intermediate potential portion TYV,
wherein both the DC power supply POS2 and the DC power supply POS3 are configured to supply the currents to the respective stator windings Ws.

According to this configuration, one DC current can be driven by a single transistor. This is particularly effective in terms of space and cost when the number of currents to be controlled is large.

The invention according to claim 12, which is dependent from claim 1, characterized in that the motor is equipped with a reverse direction driving circuit Drhv configured to add negative current components to positive current components passing the stator windings Ws.

This configuration allows positive and negative bidirectional currents to be energized. This doubles the opportunity to generate torque, thus increasing motor torque and improving motor efficiency.

The invention according to claim 13, which is dependent from claim 1, characterized in that the motor is equipped with a full-pitch winding Wsfpv1 arranged in a slot Slsv located adjacently to one of the stator magnetic poles Psv1, the full-pitch winding Wsfpv1 being supplied with a current component Isfpv1, and
the stator magnetic poles Psv1 include one or more full-pitch windings WsfpvN, arranged in one or more slots which are apart, by 2 or more slots, from the slot Slsv in an opposite direction to the slot Slsv in the circumferential, the one or more full-pitch windings WsfpvN being supplied with a part or all of a current component −Isfpv1.

According to this configuration, the motor can operate as a vernier motor, reducing copper loss and increasing efficiency.

The invention according to claim 14, which is dependent from claim 13, characterized in that
when the rotor is driven at a low-speed rotation, the stator magnetic poles PsvN are excited by the current component Isfpv1 and the part or all of a current component −Isfpv1 supplied to the one or more full-pitch windings WsfpvN, and
when the rotor is driven at a high-speed rotation, full-pitch windings WsfpvF and Wsfpv, which are mutually adjacently located in the circumferential, are serially connected among the stator magnetic poles PsvN and supplied with a current component IsvN for exciting the stator magnetic poles PsvN.

According to this configuration, the motor can rotate and drive as a vernier motor with high torque and high efficiency in low-speed rotation. At high speeds, each stator magnetic pole is individually excited and driven, thus minimizing the effect on the magnetic fluxes of other phases and enabling high torque output.

The invention according to claim 15, which is dependent from claim 1, characterized in that the rotor includes a main magnetic circuit composed of a soft magnetic member MagA, and
a soft magnetic member MagB is provided at a portion of both the rotor N magnetic poles Prn and the rotor S magnetic poles Prs, the portion being closer to the air gap, the soft magnetic member MagB being larger, in a saturation magnetic flux density, than the soft magnetic member MagA.

According to this configuration, the features of multiple types of soft magnetic members are combined and utilized more effectively to configure the motor. For example, the soft magnetic member MagA is made of amorphous magnetic steel sheet with low iron loss but low saturation magnetic flux density. Furthermore, the soft magnetic member MagB can be made of permendur electromagnetic steel plate, which has high saturation magnetic flux density but is expensive and has high iron loss. This enables a motor that can be operated at high efficiency up to high speeds and has high maximum torque.

### Effect of the Invention

The present invention proposes new rotor magnetic poles that utilize permanent magnets, and new stator magnetic poles that utilize permanent magnets.

The present invention can achieve a smaller in size, lighter in weight, and lower-cost motor by increasing the magnetic flux density in the air gap, increasing the motor torque, and reducing the copper loss in the stator.

### BRIEF DESCRIPTION OF THE DRAWINGS

FIG. 1 is a sectional view showing a motor according to the present invention;

FIG. 2 is a sectional view showing magnetic flux components;

FIG. 3 is a sectional view showing magnetic flux components;

FIG. 4 is a sectional view showing magnetic flux components;

FIG. 5 is a sectional view showing magnetic flux components;

FIG. 6 is a graph wowing an exciting current and a magnetic flux density;

FIG. 7 is a linearly developed view of a section;

FIG. 8 is a linearly developed view of a section;

FIG. 9 is a linearly developed view of a section;

FIG. 10 is a linearly developed view of a section;

FIG. 11 is a linearly developed view of a section;

FIG. 12 is a linearly developed view showing operations;

FIG. 13 exemplifies current waveforms;

FIG. 14 is a sectional view showing a motor according to the present invention;

FIG. 15 is a linearly developed view of a section;

FIG. 16 is a linearly developed view of a section;

FIG. 17 is a linearly developed view of a section;

FIG. 18 is a linearly developed view of a section;

FIG. 19 is a linearly developed view of a section;

FIG. 20 is a partially enlarged view of a section;

FIG. 21 is a sectional view of a rotor having 40 rotor magnetic poles;

FIG. 22 exemplifies partial enlarged view of the rotor section;

FIG. 23 is a sectional view showing a motor according to the present invention;

FIG. 24 is a graph showing current waveforms and voltage waveforms;

FIG. 25 exemplifies a drive circuit which uses one-way currents;

FIG. 26 is a sectional view showing the full pitch windings;

FIG. 27 is a sectional view of a motor with 2 pole pairs of the full-pitch windings;

FIG. 28 is an example showing current and volage waveforms;

FIG. 29 is an example showing the driving circuit of a motor equipped with 3-phase full-pitch windings;

FIG. 30 exemplifies a double-layered compound motor with inner and outer diameter structures;

FIG. 31 is a linearly developed view showing operation;

FIG. 32 is a sectional view showing a motor according to the present invention;

FIG. 33 is a linearly developed view showing 7-phase operations;

FIG. 34 is a sectional view showing a motor with 2 pole pairs, which is according to the present invention

FIG. 35 is an example showing the driving circuit of a motor with 7-phase full-pitch windings;

FIG. 36 is an example showing current waves of the motor with 7-phase full-pitch windings;

FIG. 37 is a linearly developed view showing operations;

FIG. 38 is a sectional view of a 5-phase motor according to the present invention;

FIG. 39 is a linearly developed view showing operations;

FIG. 40 is an example showing current waveforms of a 5-phase motor with full-pitch windings;

FIG. 41 is a linearly developed view showing operations;

FIG. 42 is a sectional view showing a 2-phase motor according to the present invention;

FIG. 43 is a linearly developed view showing operations;

FIG. 44 is an enlarged view of shapes of both stator magnetic poles and rotor magnetic poles, which are opposed to each other via an air gap;

FIG. 45 shows current waveforms of a 2-phase motor with concentrated windings;

FIG. 46 is an example showing the driving circuit of a 2-phase motor with concentrated windings;

FIG. 47 is a partially enlarged view showing shapes of teeth of a stator;

FIG. 48 is an example showing the shapes of end portions of teeth of the stator;

FIG. 49 exemplifies a characteristic of both a magnetomotive force H and a magnetic flux density B of the respective permanent magnets;

FIG. 50 is an example showing the driving circuit of a 7-phase motor with full-pitch windings;

FIG. 51 exemplifies a driving circuit for a 3-phase motor with full-pitch windings;

FIG. 52 exemplifies the 3-phase current and voltage waveforms;

FIG. 53 is an example showing a driving circuit in which a unidirectional electric current is supplied from two power supplies;

FIG. 54 exemplifies a driving circuit in which flywheel currents flow;

FIG. 55 exemplifies a driving circuit in which reverse direction driving circuits are additionally provided;

FIG. 56 is an example showing a driving circuit for a 5-phase motor;

FIG. 57 is a sectional view of a 5-phase motor according to the present invention;

FIG. 58 is a linearly developed view showing operations of the 5-phase motor;

FIG. 59 is a linearly developed view showing operations of the 5-phase motor;

FIG. 60 exemplifies a driving circuit which supplies both bidirectional electric currents and a unidirectional electric current to the 5-phase motor with the full-pitch windings;

FIG. 61 exemplifies an arrangement of soft magnetic members having different characteristics, in which soft magnetic members are arranged at tip portions of magnetic poles of both the stator and rotor;

FIG. 62 exemplifies a vertical cross section showing the structure of a motor which uses ultra-thin electromagnetic steel sheets;

FIG. 63 is a cross section of a conventional switched reluctance motor; and

FIG. 64 shows a torque characteristic.

### DETAILED DESCRIPTION OF THE PREFERRED EMBODIMENTS

### First Embodiment

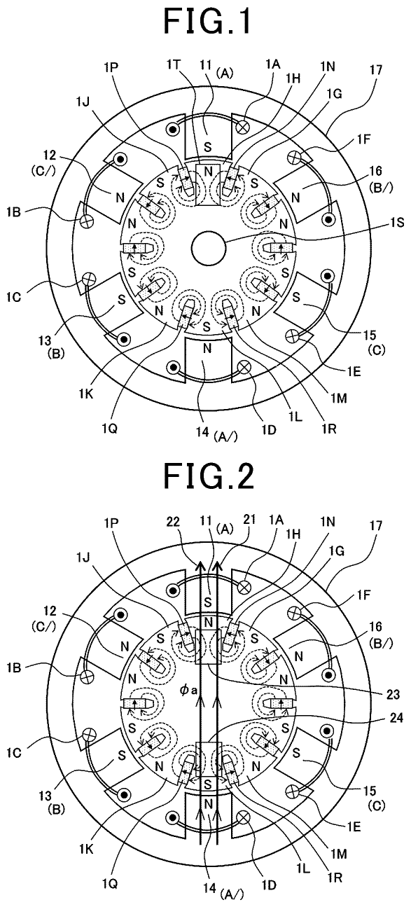

An example according to claim 1 of the present invention will now be shown in FIG. 1, which illustrates a lateral section of a motor.

A reference number 17 shows a stator with a circular circumferential portion functioning as a back yoke, which is a radially outside portion. A reference number 11 shows an A-phase stator magnetic pole, and a reference number 1A shows an A-phase winding. This A-phase stator magnetic pole is composed of a concentrated winding, and its coil end portion is symbolically indicated by a double line. The current flowing through each of the windings of this motor is a one-way current, and each winding is indicated by a current symbol to show the direction of a current flow. The symbol with a circled X letter shape energizes an A-phase Ia, which flows from the front side of the paper to the back side thereof, and the symbol with a circled black circle energizes the A-phase Ia, which flows from the back side of the paper to the front side thereof. Therefore, the A-phase stator magnetic pole 11 becomes an S pole when the A-phase current Ia is energized. A reference number 14 is an A/-phase stator pole, which is wound with an A/-phase winding showing a coil end portion by a double line. This A/-phase winding 1D is energized with the foregoing A-phase current Ia, which is a one-way current, and the A/-phase stator magnetic pole 14 becomes an N pole. Normally, the same phase-A current Ia is supplied to the A-phase winding 1A and A/-phase winding 1D to generate an A-phase magnetic flux φa between the A-phase stator magnetic pole 11 and the A/-phase stator magnetic pole 14. This A-phase magnetic flux φa travels in a cycle through the back yoke of the stator.

Similarly, a reference number 13 shows a B-phase stator magnetic pole, which is wound with a concentrated winding 1C and energizes a unidirectional B-phase current Ib. The B-phase stator magnetic pole 13 becomes an S pole when the B-phase current Ib is energized. A reference number 16 shows a B-phase stator magnetic pole, around which the concentrated B/-phase winding 1F is wound. This B/-phase winding 1F is energized with the B-phase current Ib, so that the B-phase stator magnetic pole 16 becomes an N magnetic pole. The same B-phase current Ib is supplied to the B-phase winding 1C and B/-phase winding 1F, and a B-phase magnetic flux φb is generated between the B-phase stator magnetic pole 13 and the B-phase stator magnetic pole 16. This B-phase magnetic flux φb travels in a cycle through the back yoke of the stator.

Similarly, a reference number 15 shows a C-phase stator magnetic pole, which is wound with the concentrated C-phase winding 1E and energizes a unidirectional C-phase electric current Ic, which is a one-way current. A C-phase stator magnetic pole 15 functions as an S magnetic pole when the C-phase current Ic is energized. A reference number 12 shows a C-phase stator magnetic pole, around which the concentrated C/-phase winding 1B is wound. This C/-phase winding 1B is energized with the C-phase current Ic, and thus the C-phase stator magnetic pole 12 becomes an N magnetic pole. The same C-phase current Ic is supplied to the C-phase winding 1E and the C/-phase winding 1B, and a C-phase magnetic flux φc is generated between the C-phase stator magnetic pole 15 and the B-phase stator magnetic pole 12. This C-phase magnetic flux φc travels in a cycle through the back yoke of the stator. For clarity, symbols (A), (A/), (B), (B/), (C), and (C/) are appended near the outer circumference of the motor in FIG. 1 to indicate the position of each of the stator magnetic poles.

A reference number 1S indicates a rotor shaft. A reference number 1H indicates an N magnetic pole of the rotor, where the N magnetic pole is composed of a soft magnetic member. A reference number 1L indicates an S magnetic pole, which is apart 180 degrees from the rotor N magnetic pole 1H and positioned on the opposite side of the rotor. A reference number 1J indicates an S magnetic pole of the rotor, where the S magnetic pole is composed of a soft magnetic member. A reference number 1M indicates an N magnetic pole, which is apart 180 degrees from the rotor S magnetic pole 1J and positioned on the opposite side of the rotor. The two rotor poles which are 180° apart from each other have their polarities reversed. However, in terms of shape, the configuration is point symmetrical with respect to the rotor center. The rotor N magnetic pole and rotor S magnetic pole are arranged alternately in the circumferential for a total of 10 rotor poles. The circumferential widths of both the stator magnetic pole and the slot opening in the air gap plane are 30° by way of example in the present disclosure. The circumferential width of the soft magnetic members of the rotor poles 1G, 1H, 1J, etc. is also 30° by way of example in the present disclosure. The circumferential width of the air gap surface in the area where permanent magnets 1N, 1P, etc. are placed between the rotor poles is 6° by way of example in the disclosure.

A permanent magnet 1N whose polarities are oriented in the direction of the rotor magnetic poles is placed between the rotor S magnetic pole 1G and the rotor N magnetic pole 1H. When the magnetomotive force from the stator side is not acting, the magnetic flux of the permanent magnet 1N is generated as shown in the dashed lines with arrows.

A permanent magnet 1P whose polarities are oriented in the direction of the rotor poles is placed between the rotor N magnetic pole 1H and the rotor S magnetic pole 1J. When the magnetomotive force from the stator side is not acting, the magnetic flux of the permanent magnet 1N is generated as shown in the dashed lines with arrows. The area enclosed by a square line 1T and its vicinity is a soft magnetic member portion of the rotor N magnetic pole 1H, where the magnetic flux of the permanent magnet shown by the dashed lines with arrows passes through, as described above in FIG. 1.

As will be explained later, the magnetic flux in this soft magnetic member portion changes in various ways depending on the rotor rotation positions θr and the values of each current in the stator. Between the rotor N magnetic pole 1K and the rotor S magnetic pole 1L, a permanent magnet 1Q is placed with its polarities facing in the direction of the rotor poles. When the magnetomotive force from the stator side is not acting, the magnetic flux of the permanent magnet 1Q is generated as shown in the dashed lines with arrows. A permanent magnet 1R whose polarities are oriented in the direction of the rotor poles is placed between the rotor S magnetic pole 1L and the rotor N magnetic pole 1M. When the magnetomotive force from the stator side is not acting, the magnetic flux of the permanent magnet 1R is generated as shown in the dashed lines with arrows. The other six permanent magnets are also arranged at the boundaries of the rotor N magnetic poles and the rotor S magnetic poles, respectively, and have the same characteristics. The directions of polarities of each of the permanent magnets 1N, 1P, 1Q, and 1R are indicated by small arrows in the center of the permanent magnets 1N, 1P, 1Q, and 1R. When the magnetic flux of each of these permanent magnets is large, some of the flux of each permanent magnet passes through the air gap side outside the rotor and the stator side, but this is omitted and not shown here.

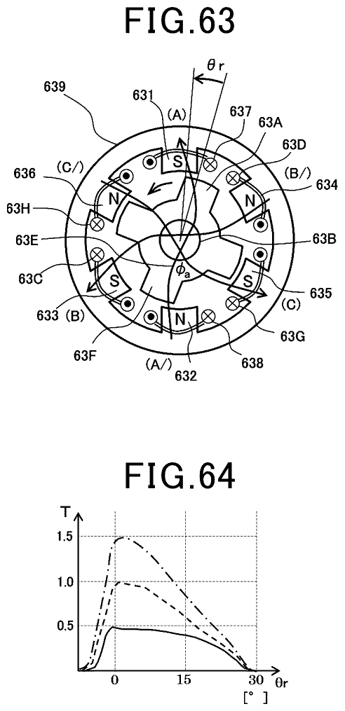

The rules of description in the specification of the invention are defined and described. If the number of stator magnetic poles Ps is Nps and the total number of rotors N magnetic poles Prn and S magnetic poles Prs is Npr, we call the motor model (Nps)S(Npr)R. For example, the motor in FIG. 1 is shown by a reference number 6S10R. In conventional IPMSM and SPMSM, the electrical angle of the motor is defined as the circumferential width of the rotor magnetic pole between the N and S magnetic poles, with an electrical angle of 360°. However, as in the conventional switched reluctance motor shown in FIG. 63, when the stator magnetic pole is configured with a circularly separated structure and the rotor magnetic pole also has a circularly separated structure, the conventional electrical angle may be insufficient for explaining the electromagnetic relationship. As there may be cases where the definition is insufficient even for the present invention motor, such as FIG. 1, the present invention is explained by defining “the cycle of one magnetic pole pair of the stator as 360° in electrical angle”. For example, the motor in FIG. 1 has a stator magnetic pole count of Nps=6, and a rotor magnetic pole count of Npr=10, which is the total of the rotor N magnetic pole count Prn and the rotor S magnetic pole count Prs, the full circumference is 360° in electrical angle and 360° in mechanical angle. The six stator magnetic poles are called one magnetic pole pair of the stator, and the electrical angle of the stator is determined with the stator as the reference. For example, when the motor configuration in FIG. 1 is arranged in two sets in the circumferential, it is composed of 12 stator magnetic poles (Ps) and 20 rotor magnetic poles (Npr), and the total circumference is 720 electrical degrees and 360 mechanical degrees. Later, the stator magnetic pole pitch Opps, rotor magnetic pole pitch θppr, etc. will be expressed in [°] of this electrical angle and explained.

In conventional IPMSM and SPMSM, the definition of a motor's magnetic pole pair is that the rotor magnetic pole of the N and S poles has a circumferential width of 360° in electrical angle, and the width between them is defined as one magnetic pole pair. However, in the case of the present motor, such as the one shown in FIG. 1, where the rotor has two magnetic poles (north and south), the basic motor configuration does not fit within the circumferential width. As a response to this, the motor configuration is defined and indicated using “number of stator pole pairs Nkb” so that all stator magnetic poles are included. For example, in the motor shown in FIG. 1, if the number of stator magnetic poles Ps is Nps=6 and the number of rotor magnetic poles Npr=10, then the number of stator magnetic pole pairs Nkb=1. In addition, if the motor configuration in FIG. 1 is arranged in two sets in the circumferential, the number of stator magnetic poles Ps is Nps=12. Furthermore, in the case of a rotor with magnetic pole number Npr=20, the number of magnetic pole pairs in the stator is Nkb=2. In other patents and documents, the rotor magnetic pole pitch is sometimes used as a reference, so it is confirmed so that the definition of the motor configuration will not be confused.

As shown in the configuration in FIG. 1, some motor configurations are also symmetrical about the center of the rotor. In this case, the stator magnetic pole of one phase and the stator magnetic pole 180° opposite to it are counted as one phase. In the case of the motor configuration shown in FIG. 1 with the symbol 6S10R, it is also called a three-phase motor. However, as will be explained later, the motor shown in FIG. 1 is a motor that conducts unidirectional electric current, and is different from conventional three-phase alternating current motors. There are also motors with an odd number of stator magnetic poles that are not symmetrical about the center of the rotor, and in this case, they are referred to as the (Nps)R(Npr)S motor model described above. In addition, a circular winding (toroidal winding) is wrapped around the back yoke from the slot in the stator. This winding is composed of two circular windings that are 180° apart in electrical angle connected in series. This series winding is almost equivalent to a full-turn winding, so the explanation of a full-turn winding shall also apply to a circular winding.

Furthermore, the characters used in the description of this invention treat full-width and half-width characters as the same character and do not distinguish between them. Capital and lower-case letters are treated as different characters. The operation of the motor is explained using a development diagram that shows the stator magnetic pole shape and rotor magnetic pole shape, which are opposite the air gap of the motor, in a linear form. In addition, for the sake of simplicity, the resistance value of the stator winding is assumed to be 0[Ω], and the resistance value is ignored in the explanation. It is also assumed that the magnetic flux passing between the stator magnetic pole and the rotor magnetic pole passes only through the parts where the stator magnetic pole and rotor magnetic pole face each other. This is used to explain the magnitude of magnetic flux, etc. The magnetic properties of the soft magnetic member are treated as simplified properties, as shown in FIG. 6 below.

If the electromagnetic steel sheet is a normal silicon steel sheet, the maximum magnetic flux density is assumed to be 2 [T]. Using this assumption, it will be explained using simplified calculations. This section explains a basic model that ignores the magnetic resistance of soft magnetic members such as the back yoke. However, if the magnetic flux density in the air gap exceeds 2.0 [T], the state of the part of the air gap vicinity will be explained separately from the characteristics shown in FIG. 6. The magnetic resistance [A/Wb] of the air gap section shall be included in the characteristics shown in FIG. 6. The regeneration of magnetic energy, which is one of the key issues for this motor, will be explained separately. In this way, when evaluating a motor in a model-based way, the problem is identified using a simplified model, and a solution is proposed for the problem. This allows qualitative evaluation and explanation. When carrying out accurate motor evaluation, investigation and design, these simplified matters obviously cannot be ignored. In order to evaluate the magnetic flux density, torque and voltage of each part of the motor accurately, it is necessary to use a computer to perform electromagnetic field analysis using the finite element method (FEM).

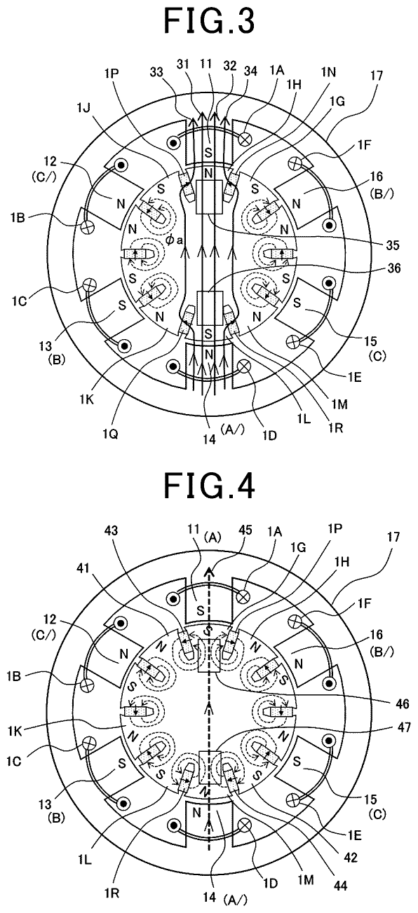

The operations of the motor in FIG. 1 provided when current is passed through the windings are explained with reference to FIGS. 2 and 3. FIG. 2 shows the state in which the A-phase stator magnetic pole 11 and the rotor N magnetic pole 1H are exactly opposite each other, and the A-phase stator magnetic pole 14 and the rotor S magnetic pole 1L are exactly opposite each other, and the A-phase current Ia is passed through the A-phase winding 1A and the A/phase winding 1D. The A-phase magnetic flux component φa (shown by reference 21 and 22) is then excited by the A-phase current Ia described above. In the area enclosed by the square lines 23 and 24, the A-phase magnetic flux component φa (indicated by reference 21 and 22) is shown superimposed on the magnetic flux component of the permanent magnets 1N, 1P, 1Q, and 1R, which is indicated by a broken line. At this time, the direction of the magnetic flux of the A-phase magnetic flux component φa is opposite to the direction of the magnetic flux of the permanent magnets 1N, 1P, 1Q, and 1R, and therefore, in the area enclosed by the square lines 23 and 24, the two magnetic fluxes cancel each other out. In the soft magnetic member of the area enclosed by the lines 23 and 24 in the above diagram, the value of the magnetic flux density component that moves from the bottom of the paper to the top becomes smaller.

FIG. 3 shows the actual magnetic flux distribution rewritten as the two magnetic flux components superimposed in FIG. 2. Thus, FIGS. 2 and 3 show the same magnetic flux distribution. Specifically, the overlap of the two magnetic flux components in the area enclosed by square lines 35 and 36 in FIG. 3 is eliminated. The magnetic flux components indicated by reference signs 31, 32, 33, and 34 in FIG. 3, passes from the stator N magnetic pole 14 of phase A/to the stator S magnetic pole 1L of phase A, and from the stator N magnetic pole 1H to the stator S magnetic pole 11 of phase A. These magnetic fluxes travel in a cycle through the back yoke of the stator. Inside the rotor, the magnetic flux can pass through without difficulty at any location. However, near the tips of the rotor S magnetic pole 1L and the rotor N magnetic pole 1H, i.e., near the air gap, the magnetic flux concentrates from three directions, resulting in a large magnetic flux density.

The distribution of magnetic flux inside the rotor and the way the flux passes through the rotor in FIG. 3 are considered. Of the flux components 31, 32, 33, and 34 passing through rotor N magnetic pole 1H, the magnetic flux components 31 and 32 pass through the soft magnetic path of rotor S magnetic pole 1L and the soft magnetic path of rotor N magnetic pole 1H. However, the magnetic flux 33 is guided by the action of the permanent magnet 1P through the soft magnetic path of the rotor S magnetic pole 1J, which is not used in the condition of FIG. 3, to the air gap surface of rotor N magnetic pole 1H. The same is true for the magnetic flux 34, which is guided by the action of the permanent magnet 1N through the soft magnetic path of the rotor S magnetic pole 1G, which is not used in the condition of FIG. 3, to the air gap surface of the rotor N magnetic pole 1H mentioned above.

Therefore, in the rotor configuration shown in FIG. 3, the magnetic flux of the rotor magnetic pole that generates torque by excitation also passes through the soft magnetic path of the adjacent rotor magnetic pole in the circumferential. This allows a larger magnetic flux to pass through the rotor N magnetic pole 1H. However, when the magnetic flux near the air gap exceeds 2 [T], the burden of exciting the air gap and the soft magnetic member portions in the vicinity increases since the specific magnetic permeability decreases even for soft magnetic member portions. The interior of the rotor and the back yoke portion of the rotor can pass large magnetic fluxes, so the excitation burden is not excessive. Compared to the conventional motor shown in FIG. 63, the torque can be increased because the magnetic resistance of the rotor is smaller. The size of the magnetic flux that can pass through the stator magnetic pole, indicated by reference 11 and 14 in FIGS. 1, 2, and 3, is limited by its shape and configuration, and some further improvements can be made, which will be explained later.

As a result, the rotor configuration shown in FIG. 3 can provide a magnetic flux density on the surface of the rotor magnetic pole that is larger than 2 [T]. The output torque of the motor can be increased by increasing the magnetic flux density at the air gap, as will be explained later using equation (19) and other equations. The configuration and method for giving the magnetic flux density of the air gap section a flux value greater than 2 [T] will be explained later. The rotor S magnetic pole 1L shown in FIG. 3 also has an action that is similar to the action of the magnetic flux passing through the rotor N magnetic pole 1H. In the case of the rotor rotation positions shown in FIGS. 1, 2, and 3, the A/-phase stator magnetic pole 11 and A/-phase stator magnetic pole 14 cannot generate torque. In this rotor rotating position, the stator magnetic poles 11 and 14 can pass through the largest flux section. As will be explained later, the magnitude of the magnetic flux that can pass through is roughly proportional to the magnitude of the output torque.

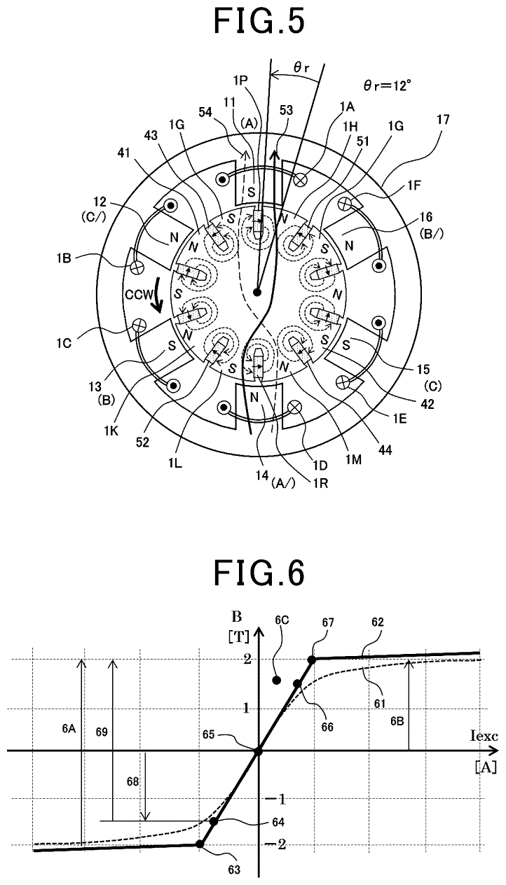

Next, FIG. 4 shows the characteristics obtained when stator magnetic pole Ps and rotor magnetic pole Pr have the same magnetic pole and face each other through an air gap. In this specification, the rotor rotation angle θr=0° is defined as the rotor rotation position er just before the stator S magnetic pole 11 of phase A acts electromagnetically on the rotor N magnetic pole 1H to generate a CCW torque. Specifically, on the paper surface of FIG. 4, the rotor rotation position is defined as θr=0°, where the counterclockwise corner of the rotor N magnetic pole 1H is approaching the lower right corner of the stator S magnetic pole 11 in phase A. FIG. 5 illustrates an example where the rotor rotation position θr is 12°. The rotor rotation position shown in FIG. 4 is θr=−6°, which deviates from the position θr=0° by 6°, the circumferential width of the permanent magnet 1P. The rotor rotation angle shown in FIGS. 1, 2, and 3 is the position rotated from the rotor rotation position of θr=0° to CCW by 30° in the circumferential width of the stator magnetic pole, indicating a rotor rotation angle θr=30°.

In FIG. 4, when the A-phase current Ia is energized to the A-phase winding 1A and the A/phase winding 1D, the magnetic flux component shown by the dashed line (reference 45) is generated. However, in the area enclosed by square line 46, the flux component of the permanent magnet is directed upward from below the paper surface, shown by the dashed line with arrow. Therefore, if the magnetic flux generated by the permanent magnets 43 and 1P is large enough, the magnetic resistance that passes through them will be large because the direction of the flux component 45 is the same. Similarly, in the area enclosed by the square line 47, the magnetic resistance through which the magnetic flux 45 passes is increased due to the action of the permanent magnets 1R and 44. Thus, in the configuration of FIG. 4, the flux component 45 is suppressed to a relatively small value.

The degree to which the magnetic resistance to the magnetic flux moving from downward to upward in the drawing paper of FIG. 4 increases depends on the characteristics of the permanent magnets and the shape of each part. The effect of increased magnetic resistance in FIG. 4 is the opposite of the effect of decreased magnetic resistance in the area enclosed by square lines 23 and 24 in FIG. 2. FIG. 4 also shows the rotor rotation position θr where the torque that can be generated by phase A stator magnetic pole 11 and phase A/stator magnetic pole 14 is exactly 0 [Nm]. The following matters are explained with the rotor rotation position in the state of FIG. 4 as θr=−6 [°]. FIG. 1 shows the rotor rotation position θr=30 [°].

Next, FIG. 5 shows an example of a state in which torque T in the counterclockwise direction CCW is generated. In FIG. 5, the rotor rotation position θr is illustrated by an arrow. The rotational position of θr=12 [°] is the position where the rotor of θr=−6 [°] shown in FIG. 4 is rotated 16° counterclockwise CCW. In FIG. 5, when the A-phase current Ia is energized to the A-phase winding 1A and the A/phase winding 1D, the magnetic flux component shown by the thick solid line with reference 53 is generated. This flux component 53 is the flux component shown in FIGS. 2 and 3. In this case, the magnetic resistance in the rotor is small, resulting in a large magnetic flux density in the air gap plane. In parallel, a magnetic flux component is also generated, indicated by the thin dashed line in reference 54. This flux component 54 is the flux component shown in FIG. 4. In this case, the magnetic flux density generated at the air gap surface is relatively small because the magnetic resistance in the rotor is large. As a result, the magnetic flux density at the air gap surface created by the magnetic flux component 53 is dominant, and torque T [T] in the counterclockwise direction CCW is generated.

Here is how the soft magnetic members of the stator and rotor are treated in this specification. Specifically, an example of the magnetic properties of a soft magnetic member is shown in FIG. 6. The magnetic properties of electromagnetic steel sheets, such as silicon steel sheets, are nonlinear, as shown by the dashed line 61 in FIG. 6. In FIG. 6, the horizontal axis is the exciting current Iexe [A] and the vertical axis is the magnetic flux density B [T]. If the motor is magnetically nonlinear, the description of the schematic characteristics of the motor becomes complicated. For this reason, the thick solid 62 characteristic shown in FIG. 6 is assumed to illustrate the basic motor model characteristics. In situations where large torque is generated, the left or right large current region in FIG. 6 will be used.

In particular, the motor is driven by current in one direction, but magnetically by utilizing permanent magnets, utilizing both the positive and negative magnetic flux density regions shown in FIG. 6. For example, with no stator current in FIG. 1, in and near the area enclosed by the square line 1T, which is the soft magnetic member portion of the rotor N magnetic pole 1H, there is a magnetic flux going from the top to the bottom of the paper surface of the permanent magnets 1P and 1N. The magnetic operating point of the area with the highest magnetic flux density in the region, for example, takes values in the range from sign 63 to 64 in FIG. 6. Next, the magnetic flux passing through the area enclosed by the square line 35 shown in FIG. 3 is from the bottom side of the paper to the top side. For this reason, the magnetic flux density, for example, takes values in the range from sign 67 to 66 in FIG. 6. Thus, the magnetic flux density B of the soft magnetic member portion of the rotor N magnetic pole 1H varies from −2 [T] to +2 [T] in the characteristics shown in FIG. 6.

As shown in FIG. 5, when this motor generates torque, the magnetic flux passes from the bottom side of the paper to the top side and acts as an N magnetic pole. For this reason, the soft magnetic member portion indicated by the sign 1T on the rotor N magnetic pole 1H in FIG. 1 can be regarded as a state in which the magnetic flux is inversely biased by the permanent magnets 1P and 1N. By using up to the negative magnetic flux density region in FIG. 6, the possibility of utilizing twice the conventional magnetic flux density is created. This utilization will be further detailed later. In the case of the conventional switched reluctance motor shown in FIG. 63, the drive current is unidirectional electric current, and the magnetic flux density of each motor part is also driven using only the unidirectional magnetic characteristics of each part.

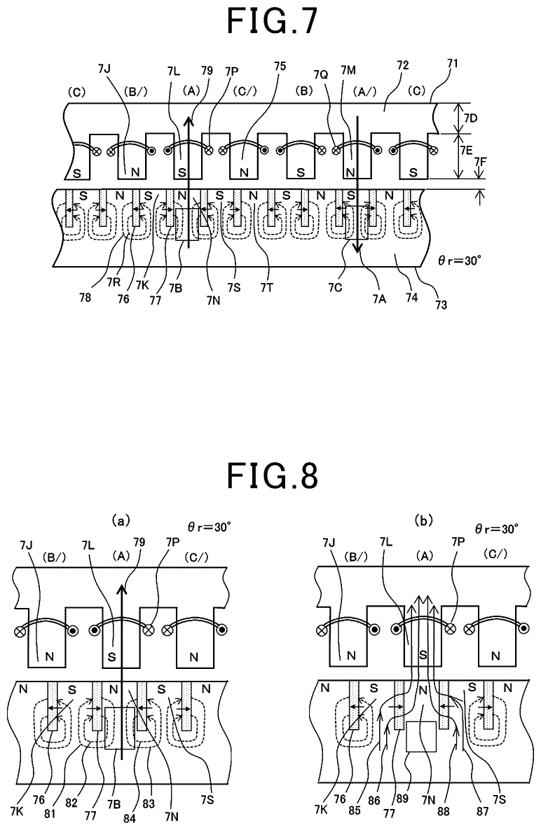

Next, the motor shown in FIGS. 1 and 2 is represented in a linearly developed view shown in FIG. 7. A circular motor is often easier to understand in terms of its overall operations when it is developed into a straight-line configuration. In FIGS. 1 and 2, the cross-section of one magnetic pole pair of the stator is shown, so that the shape of the soft magnetic member portion of each rotor magnetic pole becomes fan-shaped. Furthermore, the shape of each stator slot is also fan-shaped. In the view shown in FIG. 7, the soft magnetic member portion of each rotor magnetic pole and the shape of each stator slot are deformed into straight lines, thus becoming rectangular and changing shape. However, in motors with large output capacities (e.g., output capacity=3 kW to 100 KW), the motor shape becomes larger and is often multi-polarized. In such cases, the soft magnetic member portion of the rotor magnetic pole and the shape of each slot of the stator approach a rectangular shape from the fan-shaped shape.

Furthermore, the motor shown in FIGS. 1 and 2 are three-phase motors, but the configuration described herein can also be applied to five-phase, seven-phase, nine-phase, and eleven-phase motors, which will be explained later. Therefore, as the number of phases increases, the number of stator magnetic poles and rotor magnetic poles increases, thereby causing the fan-shaped shape to be changed closer to rectangular. Thus, while the cross-sectional shape of the stator single magnetic pole pair shown in FIG. 1 and the linearly developed view in FIG. 7 differ significantly in the fan-shaped sections, such shape changes do not pose a major issue in the preliminary evaluation of motor models with a high number of magnetic poles. However, when evaluating the motors more accurately, attention must be paid to this shape difference.

The linearly developed view shown in FIG. 7 shows the motor configuration in FIG. 2 developed in a straight-line configuration. As shown in the motor configuration shown in FIG. 2, A-phase current Ia is applied, and the magnetic flux φa of the A phase is generated as shown by reference numbers 79 and 7A. A reference number 71 indicates a stator, and a reference number 73 indicates a rotor. Each stator magnetic pole Ps of the stator 71 and each rotor magnetic pole Pr of the rotor 73 are oppositely arranged to be opposed across an air gap. A reference number 7F indicates the air gap length. This air gap length 7F is greatly enlarged in the figure for clarity. In motors with an output of approximately 10 kW, the air gap length is typically around 0.5 mm to 1 mm. A reference number 72 indicates a stator back yoke, and a reference number 74 indicates a rotor back yoke. A reference number 7D indicates a stator back yoke, and a reference number 7E indicates a tooth length of the stator, which corresponds to a slot depth. In FIG. 7, the left and right ends are represented by wavy lines, indicating that the left and right ends in FIG. 7 are connected in a closed loop. FIG. 7 is drawn slightly wider than the electrical angle of 360° for one magnetic pole pair of the stator.

The direction of the linearly developed view in FIG. 7 is toward the right on the page, corresponding to the counterclockwise (CCW) rotation direction of the rotor in FIGS. 1 and 2. However, this may cause visual confusion and requires attention. In the case of rotational motion as shown in FIGS. 1 and 2, the counterclockwise (CCW) direction from the first quadrant to the second quadrant is used as the reference direction. On the other hand, for linear motion, the movement from left to right is used as the reference direction. Therefore, the arrangement of the stator magnetic poles in the motor configuration shown in FIGS. 1 and 2 is represented in the opposite direction compared to the motor configuration shown in FIG. 7. Additionally, the leftward movement of the rotor near the S-pole stator magnetic pole 11 of phase A in FIGS. 1 and 2 corresponds to the rightward movement of the rotor near the S-pole stator magnetic pole 7L of phase A in FIG. 7. In other words, visually, these movements are in opposite directions. It is noted that in FIGS. 1 and 2, if viewed from the back of the paper and considered as a straight-line projection, the visual left-right movements align with those in FIG. 7.

In FIG. 7, a reference number 7J indicates a B-phase N-pole stator magnetic pole, corresponding to the reference number 16 in FIG. 2. A reference number 7L indicates an A-phase S-pole stator magnetic pole, corresponding to the reference number 11 in FIG. 2. A reference number 75 indicates a C-phase N-pole stator magnetic pole, corresponding to the reference number 12 in FIG. 2. A reference number 7M indicates an A/phase N-pole stator magnetic pole, corresponding to the reference number 14 in FIG. 2. A reference number 7N indicates a rotor N magnetic pole, corresponding to the reference number 1H in FIG. 2. A reference number 7P indicates an A-phase S-pole stator magnetic pole 7L excitation winding, corresponding to the reference number 1A in FIG. 2. A reference number 7Q indicates an A/phase N-pole stator magnetic pole 7M excitation winding, corresponding to the reference number 14 in FIG. 2.

As shown in FIG. 7, the rotor 73 has N-pole and S-pole rotor magnetic poles arranged alternately in the circumferential. For example, a reference number 7N indicates a rotor N magnetic pole, and a reference number 7K indicates a rotor S magnetic pole. Permanent magnets 76 and 77, whose magnetic poles are aligned with the direction of the rotor magnetic poles, are arranged at the boundaries of each rotor magnetic pole. When no stator current is applied, the magnetic fluxes generated by each permanent magnet primarily circulates within the soft magnetic member of the rotor, thus forming a closed loop. Around the permanent magnets 76, magnetic fluxes indicated by the dashed lines 78 and 7R are generated, and most of the magnetic fluxes circulate within the soft magnetic member, thus forming a closed loop. It is noted that in FIG. 7, a rotor rotation angle is θr=30°.

In order to improve the motor torque, the magnet performance of the permanent magnets (indicated by the reference numbers 76, 77, etc.) may be increased. In this case, the magnetic flux components shown by the dashed lines 78 and 7R increase the leakage flux components to the air gap side even when the stator current is not energized. Although not shown in FIG. 7, part of the leakage flux components also passes through the stator magnetic pole and circulates therearound. The leakage flux components to the air gap side are also explained in FIG. 10 and other figures. Naturally, when the stator current is energized, the above flux components (indicated by the reference numbers 78, 7R, etc.) follow complicated flux paths 20 as shown in FIGS. 8, 9, 10, and 11.

When the A-phase current Ia is energized in the A-phase winding 7P and A/phase winding 7Q in FIG. 7, an A-phase magnetic flux component φa is generated as shown by reference numbers 79 and 7A. This A-phase magnetic flux component φa passes through the back yoke 72 of the stator and the back yoke 74 of the rotor in one cycle. In the area enclosed by square lines 7B and 7C, the A-phase magnetic flux component φa shown by the reference numbers 79 and 7A is superimposed on the flux component of the permanent magnet shown by the dashed line with an arrow. The names of the A-phase, B-phase, C-phase, etc. of each stator magnetic pole are shown in parentheses at the top of FIG. 7 for reference.

Next, to show the magnetic flux distribution in more detail, a part of FIG. 7 is enlarged and shown in FIG. 8. FIG. 8(a) is an enlarged view showing the area around the stator S magnetic pole 7L shown in FIG. 7. The dashed lines with arrows, such as lines 81, 82, 83, and 84, indicate the magnetic flux components of the permanent magnets. The A-phase magnetic flux φa indicated by the reference number 79 and the magnetic flux components of the permanent magnets indicated by the dashed lines are superimposed in the area enclosed by the rectangular line 7B.

FIG. 8(b) is a figure in which the overlapping magnetic flux components shown in FIG. 8(a) have been replaced with the actual magnetic flux distribution, and the A-phase current Ia flows through the A-phase winding 7P and the A/phase winding 7Q. For example, when the A-phase current Ia is not flowing, the area enclosed by a square line 89 is assumed to be at the magnetic operating point 64 shown in FIG. 6, and is the magnetic flux density 68. In this case, assuming that the magnetic flux density from the bottom to the top of the paper in FIG. 8 is positive, the sign of the magnetic flux density 68 is negative. That is, in FIG. 8(a), when the A-phase current Ia is 0 [A], the area enclosed by the rectangular line 7B indicates a magnetically reverse-biased state. This state is a preparatory state for utilizing a large change in magnetic flux density indicated by the reference number 69 or 6A in FIG. 6, and the reverse bias is important. Now, FIG. 8(b) shows a state where the A-phase current Ia is energized to the extent that the magnetic flux density in the area enclosed by a square line 89 becomes 0 [T]. Magnetic flux lines 85, 86, 87, and 88 passing through the S-pole stator magnetic pole 7L do not pass through the aforementioned rectangular area 89 of the rotor, but instead, pass through the permanent magnets located on the left and right sides of the paper plane of the N-pole rotor magnetic pole 7N, thus supplying magnetic fluxes to the aforementioned S-pole stator magnetic pole 7L.

In the magnetic flux distribution state shown in FIG. 8(b), the magnetic fluxes 85, 86, 87, and 88 passing through the stator S magnetic pole 7L are supplied to the stator S magnetic pole 7L by passing through the magnetic paths of the rotor magnetic poles 7K and 7S, which are adjacent to the rotor N magnetic pole 7N on the paper plane. Therefore, in the area enclosed by the rectangular line 89 around the rotor N magnetic pole 7N, the magnetic flux density is 0 [T], so that there is still sufficient residual magnetic flux supply capacity to the stator. In other words, the rotor of this structure can also be described as follows: “The magnetic flux utilizes the soft magnetic member of the rotor magnetic pole adjacent in the circumferential as a magnetic path to supply magnetic flux to the vicinity of the air gap of the rotor magnetic pole and then to the stator magnetic pole.” Additionally, the teeth of the stator shown in FIG. 1 and other figures have sufficient space in the slots between the teeth, thus allowing the circumferential width of the teeth to be increased to enhance the passing magnetic fluxes, as will be explained in detail later. Furthermore, permanent magnets can be added between the teeth of the stator to increase the magnetic fluxes acting on the stator magnetic poles, as will be explained in detail later.

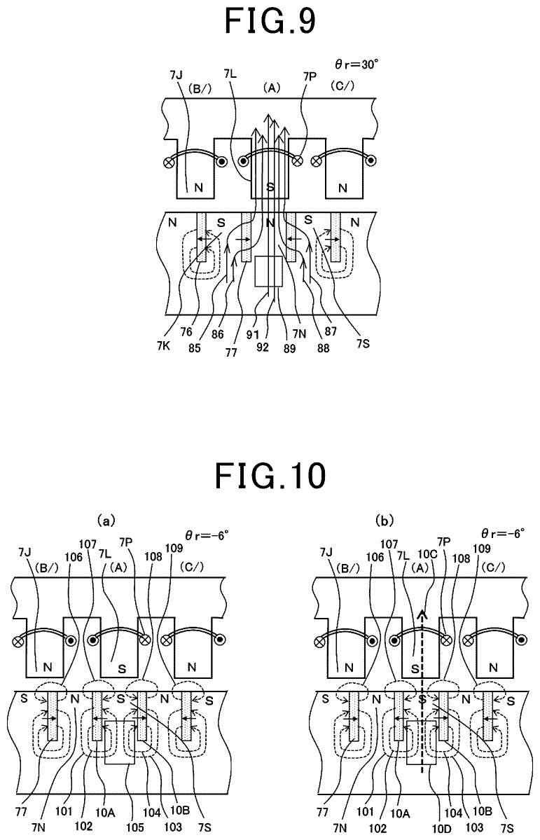

Next, FIG. 9 shows the magnetic flux distribution when the A-phase current Ia, shown by a reference number 7P, is increased from the state shown in FIG. 8(b).

In FIG. 9, the magnetic fluxes 91 and 92 increase compared to those in the state shown in FIG. 8(b). Furthermore, the magnetic fluxes passing through the area enclosed by the square line 89 increases. When expressing this change in terms of the magnetic operating point in FIG. 6, if the A-phase current Ia is 0 [A] at the operating point 64 in the aforementioned region 89, and assuming that the magnetic flux density has increased to 2 [T] in the state shown in FIG. 9, it can be understood that the magnetic flux density in the aforementioned region 89 has increased in the same manner as shown by the reference number 69 in FIG. 6. That is, the A-phase current Ia serves as the excitation for the unidirectional electric current, but by effectively utilizing the permanent magnets of the rotor, the magnetic flux density of the rotor magnetic poles is changed from negative to positive values, as shown in FIG. 6. Additionally, this technology also utilizes the magnetic paths of the soft magnetic members of the rotor magnetic poles that are adjacent in the circumferential and are not in use.

Next, FIG. 10(a) shows a linearly developed view of the stator A-phase stator S magnetic pole 7L and rotor S magnetic pole 7S which are opposed to each other, with the result that the A-phase current Ia of the A-phase winding 7P is not energized. The rotor rotation position is the same as in FIG. 4, with θr=0°. FIG. 10 shows an example where the permanent magnets 77, 10A, 10B, etc., of the rotor are slightly more high-performance, resulting in a higher magnetic flux density. For example, the magnetic flux components of the rotor permanent magnets 10A and 10B, which are represented by the dashed lines 101, 102, 103, and 104, circulate through the rotor back yoke side. However, as the magnetic flux density passing through the rectangular area 105 approaches 2 [T], the magnetic resistance increases. As a result, the magnetic flux components 107 and 108 on the air gap side become sufficiently large to be significant. The same principle as the above can be applied to the other magnetic flux components 106 and 109. In the previous FIGS. 8 and 9, the magnetic flux components on the air gap side were ignored, but in FIG. 10, the foregoing magnetic flux components 106, 107, 108, and 109 have been added.

In FIG. 10(b), the A-phase current Ia is applied to the A-phase winding 7P and the A/-phase winding 7Q shown in FIG. 10(a) to excite a magnetic flux component of 10C. The magnetic flux components indicated by the dashed lines for each permanent magnet of the rotor are overlapped with the foregoing magnetic flux component 10C. As described above, the magnetic flux density in the rectangular region 105 is already high, so that the magnetic flux component 10C passing through the rectangular region 10D cannot reach a large value.

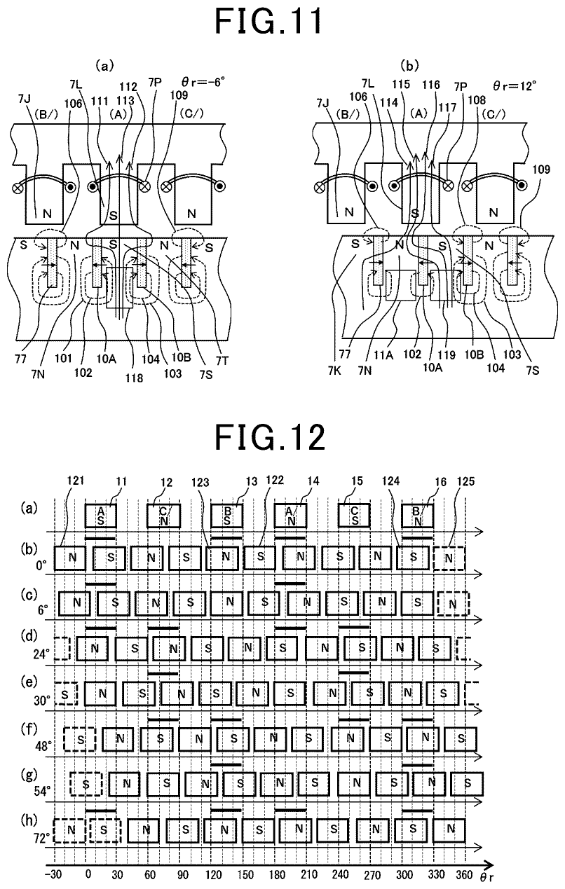

FIG. 11(a) is a diagram that qualitatively reinterprets the magnetic flux distribution obtained by combining the two types of magnetic flux components overlaid in FIG. 10(b). For example, the magnetic flux component 107 in FIG. 10(b) becomes the magnetic flux component indicated by a reference number 111 in FIG. 11(a). Similarly, the foregoing magnetic flux component 108 becomes a magnetic flux component 112. Additionally, the magnetic flux component passing directly from a rotor S magnetic pole 7S to a stator S magnetic pole 7L is indicated by a reference symbol 113. Since the magnetic flux density in the rectangular region 118 is already high, the magnetic resistance increases as the passing magnetic flux further increases, resulting in small values for the magnetic flux components 111, 112, and 113.

FIG. 11(b) shows an example of the magnetic flux distribution when the rotor rotation angle is set to θr=12° and the A-phase current Ia is applied to the A-phase winding 7P and the A/-phase winding 7Q at the position where torque T can be generated. It is noted that the rotor rotation angle θr=12° corresponds to the rotor position where the rotor N magnetic pole 7N and the adjacent S magnetic pole 7S are approximately aligned with the stator S magnetic pole 7L. The magnetic flux 114 passes through the magnetic path of the S magnetic pole 7K adjacent to the left of the rotor N magnetic pole 7N, which generates force due to the aforementioned A-phase current Ia, through the permanent magnets 77, and then through the stator S magnetic pole 7L of the A-phase stator. Magnetic fluxes 115 and 116 passes through the magnetic path of the S magnetic pole 7S adjacent to the right of the rotor N magnetic pole 7N, through the permanent magnets 10A, and then through the stator S magnetic pole 7L of the A-phase stator. The magnetic flux 117 passes through the aforementioned rotor S magnetic pole 7S and directly through the stator S magnetic pole 7L of the A-phase of the stator. Since the magnetic flux density in the rectangular area 119 is already high, the magnetic resistance is large, and the magnetic flux 117 does not reach a large value. It is noted that the magnetic flux density in the rectangular area 11A is negative because the magnetic flux from the permanent magnets 77 and the magnetic flux 102 passes from the upper side of the paper to the lower side, and the magnetic flux density from the lower side of the paper to the upper side is negative. Therefore, there is sufficient excess magnetic flux to pass through and be supplied from the rotor N magnetic pole 7N to the stator S magnetic pole 7L.

FIGS. 1 to 11 explain the passage and interruption of the magnetic flux φ [Wb] between the stator and rotor. Additionally, FIG. 11(b) explains the generation of torque T [Nm] due to the passage and interruption of the magnetic flux φ [Wb]. Furthermore, the relationships between the magnetic flux φ [Wb] and the torque T [Nm] are shown in Equations (1) to (7), which are below. In motors such as those shown in FIG. 1, in order to obtain a larger torque T [Nm], and to make the rotor rotation angle that can be generated by one rotor magnetic pole as close as possible to the rotation angle width of the respective rotor magnetic poles, the following is important. Specifically, it is important to increase the value of the magnetic flux component 79 shown in FIG. 8(a) and suppress the value of the magnetic flux component 10C shown in FIG. 10(b) to a small value. The maximum value of torque T [Nm] is proportional to a difference between the maximum values of such magnetic flux components 79 and 10C.

In particular, the methods for blocking or reducing magnetic fluxes shown in FIG. 10(b) and FIG. 11(a) are important. That is, for example, as shown in FIG. 11(a), the configuration is such that the magnetic flux density B in the rectangular region 118 is close to the maximum value 2 [T] of the soft magnetic member when the stator magnetic poles and the rotor magnetic poles of the same pole are opposed to each other. In the region 118, where the magnetic flux density increases, the relative permeability decreases, thus resulting in a large magnetic resistance, which suppresses the magnetic flux 113 to a small value. The magnetic flux components 111 and 112 that wrap around are also suppressed in magnitude due to the effect of the increased magnetic resistance in the region 118.

There are several methods for suppressing the magnetic flux 113 to a small value.

One such method involves increasing the magnitude of the magnetic flux generated by the permanent magnets of the rotor, as shown in FIG. 10(b). However, in this method, the magnetic fluxes 106, 107, 108, 109, etc., as shown in FIG. 10(b), increases, so that care must be taken to avoid drawbacks such as increased torque ripples. Another suppression method involves arranging permanent magnets near the surface of the rotor which faces the air gap, which is oriented toward the direction of the rotor magnetic poles. Another suppression method involves adding field winding coils inside the rotor and applying field current. The magnitudes of the field currents can also be controlled.

Here, the relationship between the interlinkage magnetic flux φ [Wb] of the winding and the torque T [Nm] is confirmed. One method for observing and evaluating the motor torque T [Nm] is to observe the interlinked magnetic flux φ [Wb] with the windings. That is, the magnitude of the magnetic flux change Δφ [Wb], which is a change in the interlinked magnetic flux φ [Wb] with the windings as the rotor rotates, can be used for evaluation. Now, assuming that the power Pe [W] supplied from a power source to the motor, the voltage V [V], and the current I [A] correspond to a mechanical output Pm [W], the torque T [Nm], and the rotational angular frequency ω [rad/sec], and assuming that there are no internal losses, the following relationship holds based on Faraday's law of electromagnetic induction. Let the sum of the number of turns of the A-phase and A/phase windings be Nw [turn], and the rotor rotation angle be θ [rad], in which ω=dθ/dt is provided.

$$Pe = V \times I \qquad ( 1 )$$

$$= Nw \times d φ / dt \times I \qquad ( 2 )$$

$$= Nw \times d φ / d θ \times d θ / dt \times I = Nw \times d φ / d θ \times ω \times I \qquad ( 3 )$$

$$Pm = T \times ω \qquad ( 4 )$$

$$= T \times d θ / dt \qquad ( 5 )$$

For example, in FIG. 1, the A-phase winding 1A and the A/-phase winding 1D are connected in series to conduct the A-phase current Ia therethrough. The sum of the number of turns of both windings is referred to as Nw [turn]. The number of turns of the A-phase winding 1A is Nw/2.

If the values of a supplied power Pe [W] given by equation (3) and a mechanical output Pm [W] of the motor given by equation (5) are equal, a torque T [Nm] can be approximately expressed by equation (7).

$$T = Nw \times d φ / d θ \times I \qquad ( 6 )$$

$$= Nw \times I \times Δ φ / Δ θ . \qquad ( 7 )$$

From equation (7), it can be seen that the torque is proportional to changes in the interlinkage magnetic flux Δφ [Wb] between the rotor small rotation angle Δθ [rad]. Therefore, from the position shown in FIG. 11(a) to the state where θr=0° (by a shift of 6°), the torque T [Nm] is obtained in proportion to the changes in the interlinkage magnetic flux Δφ [Wb] of the A-phase winding 7P, as shown in FIG. 9. From this perspective, the interlinkage magnetic fluxes and magnetic flux distribution at θr=30° are shown, where the torque becomes zero. Additionally, it is demonstrated that the magnetic flux supply capacity from the rotor side to the stator side is sufficiently large.

Furthermore, as shown in Equations (6) and (7), torque T [Nm] is not proportional to the magnitude of the interlinkage magnetic flux φ [Wb], but rather to the rate of changes in the interlinkage magnetic flux φ [Wb], which is explained as dφ/dθ or Δφ/Δθ. As shown in equation (2), electrical power Pe [W] is supplied, and as shown in equations (4) and (5), the power is converted into mechanical force Pm [W] through electromagnetic interactions. That is, in the conventional switch reluctance motor shown in FIG. 63, the changes in magnetic flux density [T] in one direction, as shown by a reference 6B in FIG. 6, is utilized. In contrast, in the rotor of the present invention motor shown in FIG. 1 and the stator described below, torque T [Nm] is generated by utilizing the changes in magnetic flux density [T] in bidirectional directions, as shown by references 69 and 6A shown in FIG. 6.

It is noted that, for simplicity, internal losses and magnetic energy are ignored in this explanation.

Next, FIG. 12 shows a linearly developed view illustrating the operations of the 6S10R motor shown in FIG. 1. The developed view shown in FIG. 12 shows the shapes of the stator magnetic poles facing the air gap surface and the rotor magnetic poles, enabling the mutual magnetic flux and electromagnetic effects to be analyzed. Specifically, this is a linearly developed view created to illustrate a region where CCW torque is generated. In FIG. 1, the CCW direction is defined as the positive rotation direction, while in FIG. 12, the right direction is defined as the CCW direction. As mentioned earlier, it is important to note that this may visually appear to be the reverse direction. In FIG. 12, the horizontal axis represents the rotor rotation angle θr. In FIG. 1, there is established a rotation position of the rotor at which an upper left corner of the rotor N magnetic pole 1H comes to the lower right corner of the stator S magnetic pole 11 which is the first phase in the A phase. This rotor rotation position is defined as θr=0°. FIG. 12 shows the rotor rotation angle θr from −30° to 360°. Although slightly confusing, in FIG. 12, the horizontal axis Or indicates the position of each part of the rotor and also the rotational direction of each part of the stator.

The rotor rotational position is shown on the left side of each row in FIG. 12. It is noted that the rotor rotational position shown in FIG. 1 is θr=30°.

For example, the circumferential width of each stator magnetic pole is 30°, the circumferential width of each slot is 30°, and a stator magnetic pole pitch Opps is 60°. Furthermore, in this example, a pitch Opps of each rotor magnetic pole is 36°, and a total of 10 rotor N and S magnetic poles are alternately arranged on the circumference. FIG. 12 shows a structure in which the circumferential width of each rotor magnetic pole is 30°. FIG. 12(a) shows the shape of each stator magnetic pole opposed to the air gap surface. The A-phase stator S magnetic pole is shown between θr=0° and 30°, using the same reference number as the number 11 shown in FIG. 1. On the right side of the A-phase, the stator magnetic poles of the C/-phase, B-phase, A/-phase, C-phase, and B/-phase are arranged in the same manner. It is noted that the circumferential width of the stator magnetic poles and the circumferential width of the rotor magnetic poles can be reduced or expanded within the space allowed by the motor design.

In a linearly developed view such as that shown in FIG. 12, the position of the stator magnetic pole in FIG. 12(a) is fixed, and the positions of the rotor magnetic poles are moved left and right on the paper surface. The description is then made as explained in FIG. 12(b) and subsequent figures, and the range where CCW torque can be generated is checked. At the top of each row, the regions where counterclockwise (CCW) torque can be generated are indicated by thick lines on the upper side of the rotor magnetic pole shapes. In this case, the position and width of the thick lines correspond to the positions and widths of the corresponding stator magnetic poles.

As mentioned earlier, FIG. 12(b) shows the shapes of the rotor magnetic poles positioned to be opposed to the air gap surface. The rotor N magnetic poles and S magnetic poles are arranged alternately, with a total of 10 rotor magnetic poles spaced at 36° intervals. Each stator magnetic pole shown in FIG. 12(a) is opposite to each rotor magnetic pole in FIG. 12(b) across the air gap. At the rotor rotation position θr=0° shown in FIG. 12(b), this corresponds to the rotor rotation position θr shown in FIG. 4. Additionally, the value of the rotor rotation position θr is indicated at the left end of FIG. 12(b).

Next, the torque generated and the torque generation interval in (b) of FIG. 12 will be explained. The counterclockwise torque generated by the configuration shown in FIG. 1 corresponds to the rightward torque generated by the configuration shown in FIG. 12. A reference number 121 indicates a rotor N magnetic pole, which is attracted by the A-phase stator S magnetic poles of the stator 11, thereby generating an attractive force in the right direction on the paper plane during the rotor rotation angle θr=0° to 30°. This attractive force generation interval is indicated by a thick line above and to the right of the N magnetic pole 121.

Similarly, a reference number 122 indicates a rotor S magnetic pole that is 180° away from the foregoing N magnetic pole 121 in terms of an electrical angle equal to ½ of the electrical angle of 360° of the stator one magnetic pole pair, and is attracted by the A/-phase stator N magnetic pole of the stator 14, thus generating an attractive force in the direction to the right of the paper plane during the rotor rotation angle θr=0° to 30°. This attraction force generation zone is indicated by a thick line to the upper right of the S magnetic pole 122. Additionally, a reference number 123 indicates a rotor N magnetic pole, which is attracted by the B-phase stator S magnetic pole of the stator 13, thus generating an attractive force in the direction to the right of the paper plane during the rotor rotation angle θr=−24° to 6°. This attraction force generation zone is indicated by a thick line approximately above the N magnetic pole 123 in the figure.

Similarly, a reference number 124 indicates a rotor S magnetic pole, which is attracted by the B/-phase stator N magnetic pole of the stator 16, thus generating an attractive force in the direction to the right of the drawing paper plane during the rotor rotation angle θr=−24° to 6°. The region where this attractive force is generated is indicated by a thick line approximately above the N magnetic pole 124 in the figure. As described above, at the position where the rotor rotation angle θr=0° in FIG. 12(b), the CCW torque can be generated at the four locations. It is noted that the rotor N magnetic pole 121 is the same as the N magnetic pole 125 indicated by a dashed line at a phase difference of 360°.

FIG. 12(c) shows that each rotor magnetic pole moves to the right, thereby indicating a rotor rotation angle θr=6°. At this position, the stator magnetic poles 13 and 16 can no longer generate an attractive force toward the right side of the paper. The A-phase stator S magnetic pole 11 and the A/-phase stator N magnetic pole generate an attractive force toward the right. As such, at the position shown in FIG. 12(c) where the rotor rotation angle θr=6°, the CCW torque can be generated at the two locations. Conversely, since the magnetic poles of the stator and rotor fix the N magnetic poles and S magnetic poles, the other four stator magnetic poles cannot generate the CCW torque.

In the case of (d) in FIG. 12, at the rotor rotation angle θr=24°, as shown in the figure, the stator magnetic poles 11, 12, 14, and 15 can generate torque. FIG. 12(e) shows that at the rotor rotation angle θr=30°, the stator magnetic poles 12 and 15 can generate torque, as illustrated. FIG. 12(f) shows that at the rotor rotation angle θr=48°, the stator magnetic poles 12, 13, 15, and 16 can generate torque, as illustrated. FIG. 12(g) shows the position where the rotor rotation angle θr=54°, and as shown in the figure, the stator magnetic poles 13 and 16 can generate torque. The state of FIG. 12(h) returns to the same state as that of FIG. 12(b). Then, the motor shown in FIG. 1 repeats the same operations five times at a 72° cycle, thereby causing the rotor to rotate once.

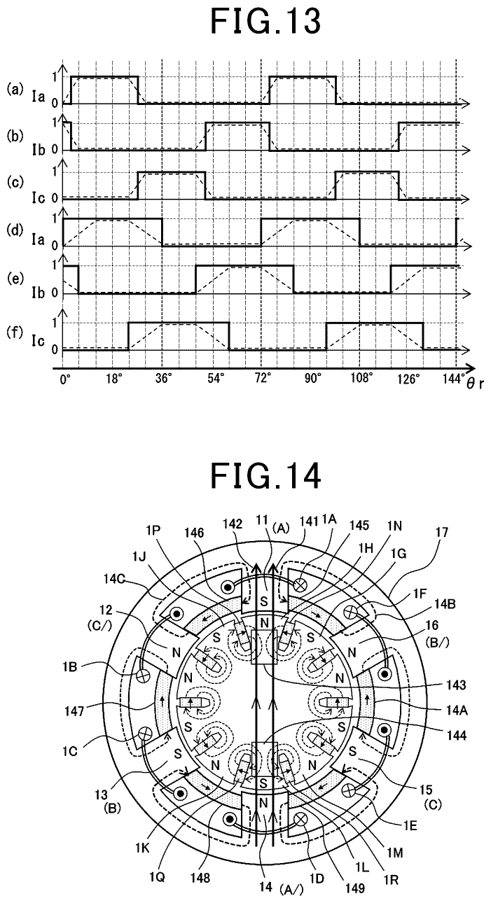

FIG. 13 shows examples of currents flowing through each phase winding and explains several methods of energization. FIGS. 13(a), (b), and (c) are examples of the A-phase current Ia, B-phase current Ib, and C-phase current Ic that flow through the motor in FIG. 1 during operations as shown in FIG. 12. The circumferential width of the respective stator magnetic poles and the circumferential width of the respective rotor magnetic poles are both 30°, and the motor rotates in the counterclockwise (CCW) direction, thereby generating torque in the CCW direction. In the case of the thick solid rectangular wave currents shown in (a), (b), and (c) of FIG. 13, the A-phase current Ia is energized from 3° to 27°, the C-phase current Ic is energized from 27° to 51°, and the B-phase current Ib is energized from 51° to 75°, with each of these operations repeating at a 72° cycle. The A-, C-, and B-phases generate torque sequentially at 24° intervals, which enables the motor model to continuously output toque of which waveforms are nearly uniform.

Additionally, the A-phase current Ia shown as trapezoidal waves by the dashed lines in FIGS. 13(a), (b), and (c), can also be applied to the B-phase current Ib and C-phase current Ic. The A-phase current Ia increases in a range from 0° to 6°, remains constant in a range from 6° to 24°, decreases in a range from 24° to 30°, and then returns to 0 [A], thus forming a trapezoidal current waveform. The C-phase current Ic also supplies a trapezoidal current in a range between 24° and 54°. The B-phase current Ib also supplies a trapezoidal current in a range between 48° and 78°. These operations are repeated at a 72° cycle. By summing the currents Ia, Ib, and Ic, the current is applied in such a way that the total current remains constant, logically resulting in uniform torque. Since the current increases and decreases gradually, the voltage load on the driving circuit during high-speed rotation is reduced, leading to reduced torque ripple, vibration, and noise. Additionally, it is possible to increase the average torque by using the current waveforms of the currents Ia, Ib, and Ic as rectangular waveforms with a 30° width. However, in such cases, measures to reduce torque pulsation must also be considered. Various current waveforms can be used as needed.

Next, FIGS. 13(d), (e), and (f) explain an example of a motor model where the circumferential width θsg of the stator magnetic pole facing the air gap in FIG. 1 and FIG. 12, and the circumferential width θrg of the rotor magnetic poles are both increased to 36°, thereby widening the magnetic pole width. One method involves driving the motor using the rectangular wave-shaped currents represented by the thick solid lines in FIGS. 13(d), (e), and (f). In FIG. 13(d), the A-phase current Ia is energized in a range of from 0° to 36°, in (f) thereof, the C-phase current Ic is energized in a range of from 24° to 60°, and, in (e) thereof, the B-phase current Ib is energized in a range of from 48° to 84°, with each of these operations repeated at a 72° cycle. While the average torque increases, an occurrence of torque pulsation is expected, resulting in that measures to reduce torque pulsation must also be considered. Various methods, such as amplitude correction, can be applied.

Next, as shown by the dashed lines in FIGS. 13(d), (e), and (f), trapezoidal currents Ia, Ib, and Ic can also be used for driving the motor. The A-phase current Ia in (d) of FIG. 13 increases from in a range of 0° to 12°, remains constant in a range of from 12° to 24°, and then decreases to 0 [A] in a range of from 24° to 36°, thereby applying a trapezoidal current. The C-phase current Ic is similarly supplied with a trapezoidal current between 24° and 60°. The B-phase current Ib is similarly supplied with a trapezoidal current between 48° and 84°. These operations are repeated at a 72° cycle. By summing Ia, Ib, and Ic, the total current remains constant, resulting in logically uniform torque. The increase and decrease in current, shown as trapezoidal shapes with dashed lines in FIGS. 13(a), (b), and (c), are even smoother than the trapezoidal shapes, which reduces the voltage load on the driving circuit during high-speed rotation and is expected to reduce torque ripple, vibration, and noise. For example, as a specific driving method, it is possible to drive the motor using a current waveform resembling a trapezoidal waveform close to a square wave at low to medium speeds to generate large torque, and then drive using a current waveform with a gradual increase and decrease in shape at high speeds.

The graphs (a), (b), and (c) of FIG. 12 and FIG. 13 show an examples where the stator magnetic pole width and rotor magnetic pole width are set to 30°. In this case, if the torque generation width is 24°, each phase torque is generated sequentially, enabling the motor to output continuous torque. In the conventional switch reluctance motor shown in FIG. 63, each phase torque must be generated in a torque generation width of 30° to output continuous torque from the motor. This characteristic differs from the motor configuration shown in FIG. 1. In the 6S10R motor configuration with the rotor magnetic pole characteristics shown in FIG. 1, since the torque width for each phase can be set to 24°, it is possible to add current increase/decrease times as shown by the dashed lines in (a), (b), and (c) of FIG. 13. This freedom in the energization time is one of the features of the motor shown in FIG. 1.

As shown in FIG. 13, even though the basic parts of the motor structure in FIG. 1 and the operations explained in FIG. 12 are the same, various modifications are possible in terms of the shape of the stator magnetic poles, the shape of the rotor magnetic poles, and the current waveforms. Measures such as driving in a region where torque can be generated more effectively to improve torque, reducing torque ripple, and reducing vibration and noise can be applied. Furthermore, for example, the magnetic pole shape can be adjusted not only by the circumferential width but also by skew, magnetic pole shape, unevenness in the radial direction, and internal gaps in the magnetic poles, thereby allowing for adjustments to magnetic resistance and the addition of permanent magnets. Regarding the current waveforms applied to the stator windings, various options are available, including rectangular wave currents, trapezoidal currents, sinusoidal currents, quadratic currents, or current amplitude corrections. For example, as a specific drive method, at low speeds, the motor is driven using a current waveform similar to a rectangular wave to increase the average torque, and at high speeds, the motor is driven using a trapezoidal current waveform to gradually increase and decrease the current, thereby reducing the current drive load. In addition, this drive method achieves reduced torque ripple and vibration noise. Regarding the current increase and decrease shown in FIG. 13 for the motor shown in FIG. 1, there are issues such as the timing of regenerating magnetic energy from each phase to the inverter, torque reduction at high speeds, and vibration and noise.

These issues will be addressed in detail later, including methods such as continuously applying a current component sufficient to excite magnetic flux in each phase current.

The examples explained with reference to FIG. 1 to FIG. 12 are summarized below. Conventional reluctance motors provided by the structure shown in FIG. 63, which are driven by unidirectional electric currents, have rotor magnetic poles composed of soft magnetic members and do not have magnetic polarity such as N magnetic poles and S magnetic poles. In contrast, in the configuration of FIG. 1 according to the present invention, the rotor magnetic poles have fixed magnetic polarities as N magnetic poles and S magnetic poles.

That is, the motor configuration has both the stator and rotor magnetic poles with N magnetic pole and S magnetic pole polarities. By fixing the stator magnetic poles as N magnetic poles and S magnetic poles, the motor can be driven by unidirectional electric currents, thus allowing the driving circuit to be simplified and the cost to be reduced. However, of course, attractive forces act between opposite magnetic poles (N and S), but no attractive forces act between same magnetic poles. Therefore, it is necessary to identify a special and convenient relative relationship between the stator magnetic poles and the rotor magnetic poles to construct the motor.

As shown in FIG. 1 and the like, the stator is similar to that of the conventional reluctance motor shown in FIG. 63, but, by fixing the rotor magnetic poles to N magnetic poles and S magnetic poles, permanent magnets can be used in the rotor. Furthermore, by utilizing the permanent magnets on the rotor in the unique configuration shown in FIG. 1, the soft magnetic member magnetic paths of the unused rotor magnetic poles that are circumferentially adjacent can be utilized in the same manner as the magnetic fluxes 85, 86, 87, and 88 shown in FIG. 8(b) and FIG. 9(a). As a result, the magnetic flux supply capacity on the rotor side is significantly increased, enabling torque enhancement. On the other hand, for magnetic flux components attempting to pass in the reverse direction, the square regions 118 become magnetically saturated, thus increasing magnetic resistance, and thereby suppressing and limiting magnetic flux passage, as shown by the magnetic fluxes 101, 102, 103, 104 in FIG. 11. Additionally, as shown in the current waveform exemplified in FIG. 13, the current waveforms have flexibility, thus allowing the current waveforms to be shaped into trapezoidal waveforms, thereby ensuring sufficient time for current increase and decrease. This facilitates current control and reduces motor vibration and noise. This is significantly different from the conventional reluctance motor shown in FIG. 63. Furthermore, as described above, in the present invention, the combination of the stator and rotor shown in FIG. 1 is used, and the mechanical angle of 360° is treated as the electrical angle of 360° for one magnetic pole pair of the stator. In the motor shown in FIG. 1, the circumferential range of 10 rotor magnetic poles is treated as an electrical angle of 360°.

Furthermore, by adding permanent magnets between the teeth of the stator shown in FIG. 1, it is possible to increase the magnetic flux acting on the stator magnetic poles, as will be described in an embodiment according to claim 2. Furthermore, the stator windings shown in FIG. 1 are explained as an example of concentrated windings, but such windings can also be full-pitch windings. This is a method of applying current to selectively excite specific parts of the rotor and specify the direction of excitation using full-pitch windings with unidirectional electric currents, as will be described in an embodiment according to Claim 4. Furthermore, the combination of stator magnetic poles and rotor magnetic poles have been explained using the three-phase structure in FIG. 1, but it can be extended to five phase, seven phase, nine phase, eleven phase, etc., and there are specific combinations that are highly practical and enable high efficiency, miniaturization, and weight reduction due to high utilization of the motor interior space. An embodiment according to Claim 5 and other embodiments will be described later. Furthermore, the teeth of the stator shown in FIG. 1 have sufficient space between the teeth slots, thus allowing the circumferential width of the teeth to be expanded and deformed to increase the passing magnetic fluxes, as will be described in an embodiment according to Claim 7. In this specification, the term “utilization rate of the motor windings” is used to refer to a percentage of the motor windings that are used. Furthermore, the term “transistor utilization rate” is used to refer to the usage ratio of the transistors TR used for current drive. The ratio of the current that can be supplied to the windings to generate torque ultimately relates to the motor winding resistance. For example, compared to a motor that can generate torque by continuously applying current to all windings for 100% of the time, a motor where 50% of the windings generate torque requires twice the current to be applied to half the windings, thereby resulting in a twofold increase in total copper loss. Similarly, the utilization rate of transistors TR also increases. Compared to a transistor utilization rate of 100%, a rate of 50% results in the total current capacity of all transistors TR in the inverter simply doubling. In summary, higher utilization rates enable miniaturization, lightweight design, and cost reduction.

An embodiment according to Claim 2 will now be described

FIG. 14 shows a configuration in which permanent magnets 145, 146, 147, 148, 149, and 14A are added to the configuration shown in FIGS. 1 and 2. An arrow mark on each permanent magnet indicate its magnetic pole directions. The dashed lines 14B and 14C indicate the magnetic flux components of the permanent magnets. An A-phase current Ia is applied to the A-phase winding 1A and the A/-phase winding 1D of the stator to excite the A-phase magnetic flux components 141 and 142. The area indicated by a square line 143 represents the soft magnetic member portion of the rotor N magnetic pole 1N. The area indicated by a square line 144 represents the soft magnetic member portion of the rotor S magnetic pole 1R. The aforementioned A-phase magnetic flux components 141 and 142 are overlaid on the magnetic fluxes indicated by the dashed lines of each permanent magnet of the rotor and the magnetic fluxes indicated by the dashed lines of each permanent magnet of the stator. The A-phase magnetic flux components circulate through the stator back yoke. The symbols for the other components in FIG. 14 are the same as those in FIG. 1 and FIG. 2.

In FIG. 14, the shapes of permanent magnets 145, 146, 147, 148, 149, and 14A are shown as circumferentially elongated shapes. This elongation is for illustrative purposes to model the motor configuration. At the motor design stage, the motor shown in FIG. 14, which has a configuration with two stator magnetic pole pairs, may be modified to have a higher number of magnetic pole pairs, such as eight. In this case, shortening the circumferential length of each permanent magnet to approximately ¼ reduces the cross-sectional shape of the permanent magnets to a parallelogram. Additionally, the shape of the soft magnetic member in contact with each permanent magnet can be freely deformed to match the shape of the permanent magnets.

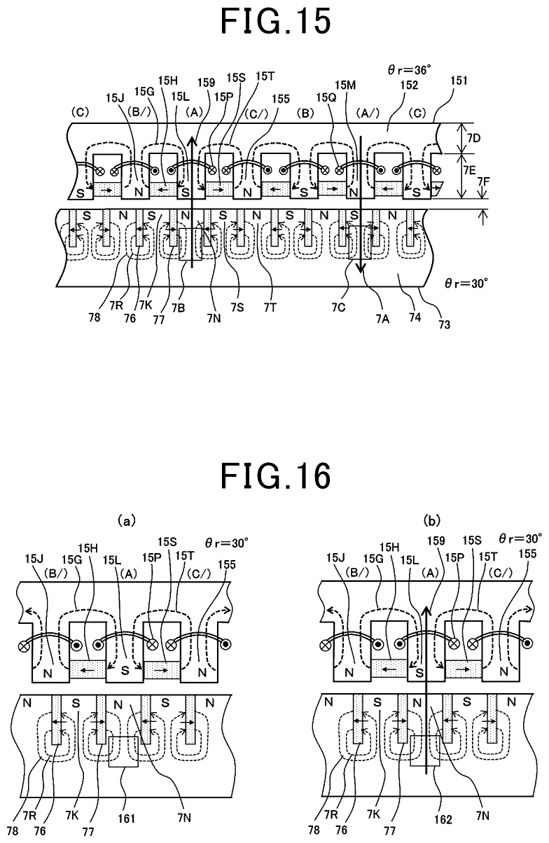

FIG. 15 shows a linear projection of a cross-sectional view of a motor shown in FIG. 14. A reference number 151 indicates a stator, and a reference number 152 indicates a stator back yoke. A reference number 15L indicates an A-phase stator S magnetic pole corresponding to the magnetic pole 11 shown in FIG. 14, a reference number 15M indicates an A/-phase stator N magnetic pole corresponding to the magnetic pole 14 shown in FIG. 14, a reference number 15J indicates a B/-phase stator N magnetic pole corresponding to the magnetic pole 16 shown in FIG. 14, and a reference number 155 indicates a C/-phase stator N magnetic pole corresponding to the magnetic pole 12 shown in FIG. 14. A reference number 15P indicates an A-phase winding, and a reference number 15Q indicates an A/-phase winding. By connecting the two windings in series and applying the A-phase current Ia, the magnetic fluxes 159 and 7A circulate through the back yoke. Between the stator magnetic poles, permanent magnets such as represented by reference numbers 15H and 15S are arranged in the direction of the magnetic polarities of the stator magnetic poles. A dashed line 15G represents the magnetic flux components of the permanent magnet 15H, and a dashed line 15T represents the magnetic flux components of the permanent magnet 15S. The magnetic flux components indicated by the dashed lines for the other permanent magnets of the stator are similarly provided.

Additionally, the numbers and symbols for respective parts of the rotor in the lower part of FIG. 15 have the same configuration as those shown in FIG. 7. However, the effects of the magnetic flux density distribution, etc., vary significantly due to increases in the magnetic flux density on the stator side, which will be explained later. Furthermore, an air gap length 7F is enlarged for clarity. The rotor rotation angle θr in FIG. 15 and FIG. 14 is set at 30°. Additionally, the counterclockwise rotation in FIG. 14 corresponds to the rightward movement of the rotor 73 in FIG. 15.

Next, to show the distribution of magnetic flux in more detail, parts of FIG. 15 are enlarged and shown in FIGS. 16, 17, 18, and 19. FIG. 16(a) is an enlarged view of an area around the stator S magnetic pole 15L shown in FIG. 15. In FIG. 16(a), the stator current is not energized, and the distribution of magnetic flux components 15G, 15T from each permanent magnet of the stator, and magnetic flux components 78 and 7R from each permanent magnet of the rotor are shown. The teeth of the A-phase stator S magnetic pole 15L are traversed by magnetic flux components 15G and 15T from the upper to the lower side of the paper plane. These magnetic flux components are directed in the reverse direction to the magnetic flux direction excited by the A-phase winding 15P and the A/phase winding 15Q, thus resulting in a magnetic flux density that is negatively biased. The magnetic flux in the area enclosed by an rectangular line 161 around the rotor N magnetic pole 7N flows from the upper side to the lower side of the paper surface. This direction is opposite to the magnetic flux direction in which the rotor N magnetic pole 7N interacts with the stator to generate torque, thus resulting in a magnetic flux density that is negatively biased. In the magnetic characteristics of the soft magnetic member shown in FIG. 6, this corresponds to an operating point at 63 or 64, where changes in magnetic flux density of 6 A or 69 are possible.

When the rotor rotation angle is θr=30°, the A-phase stator S magnetic pole 15L and the rotor N magnetic pole 7N are opposed to each other via the air gap. Therefore, since the S magnetic pole and N magnetic pole are opposed to each other, when A-phase current Ia is applied to the A-phase winding 15P and A/-phase winding 15Q, the rotor rotation position θr provides a position where the A-phase magnetic flux ca passes most easily. Furthermore, the maximum magnetic flux and maximum magnetic flux density that can pass between the stator and rotor can be analyzed and evaluated. It is noted that at the rotation position θr=30°, the A-phase stator S magnetic pole 15L cannot generate torque.

FIG. 16(b) shows a state in which an A-phase current Ia is supplied to an A-phase winding 15P and an A/phase winding 15Q which are provided in the state shown in FIG. 16(a), and such magnetic windings are excited by an A-phase magnetic flux 159 (φa). The magnetic flux components generated by the permanent magnets of the stator and rotor and the A-phase magnetic flux 159 (φa) are shown superimposed. In the area enclosed by a square line 161 in the rotor

N magnetic pole 7N, the magnetic flux components generated by the permanent magnets of the rotor and the A-phase magnetic flux 159 (φa) are directed in the opposite directions and canceled out. In the teeth of the stator S magnetic pole 15L, the magnetic flux components 15G generated by the stator permanent magnet 15H and the magnetic flux component 15T generated by the stator permanent magnets 15S are directed in the opposite directions to the A-phase magnetic flux 159 (φa), and cancel each other out.

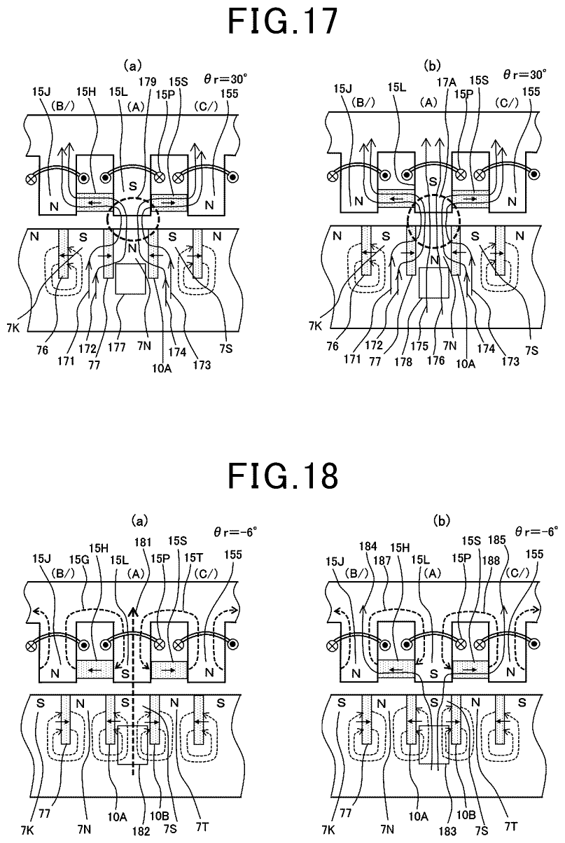

FIGS. 17(a) and (b) represent distributions provided by converting the superimposed magnetic fluxes in (b) of FIG. 16. FIG. 17(a) shows an example of magnetic flux distribution when the A-phase current Ia of the A-phase winding 15P is not very large, while FIG. 17(b) shows an example when the A-phase current Ia is large. The magnetic fluxes 171 and 172 in FIG. 17(a) pass through a soft magnetic member magnetic path of a rotor S magnetic pole 7K, through a permanent magnet 77, through the rotor N magnetic pole 7N, through the air gap, through a stator S magnetic pole 15L, through a permanent magnet 15H, and through a tooth of the stator N magnetic pole 15J, and returns to the stator back yoke. The magnetic fluxes 173 and 174 pass through a soft magnetic member magnetic path of rotor S magnetic pole 7S, through a permanent magnet 10A, through a rotor N magnetic pole 7N, through the air gap, through a stator S magnetic pole 15L, through a permanent magnet 15S, and through a tooth of the stator N magnetic pole 155, and returns to the stator back yoke.

In FIG. 17(a), the magnetic fluxes 171, 172, 173, and 174 are generated by the excitation of the A-phase current Ia in the A-phase winding 15P and the A/-phase winding 15Q, and pass through the air gap from the rotor N magnetic pole 7N to the stator S magnetic pole 15L. However, these magnetic fluxes have not yet passed through the area enclosed by the rectangular line 161, which is the soft magnetic member portion of the rotor N magnetic pole 7N, and the teeth of the stator S magnetic pole 15L. Therefore, by increasing the A-phase current Ia, the magnetic flux passing through the rotor N magnetic pole 7N and the stator S magnetic pole 15L can be increased.

Additionally, the magnetic flux passing through a portion, which is near the air gap, indicated by a thick elliptical dashed line 179 corresponds to the value of the magnetic flux component 159 shown in FIG. 16(b). As described above, even if the area 177, which is the soft magnetic member portion of the stator S magnetic pole 15L teeth and the rotor N magnetic pole 7N, is still negatively biased by the permanent magnets, the magnetic flux passing through the portion 179, which is near the air gap portion, is positive and has the same value as the magnetic flux component 159.

FIG. 17(b) shows an example of the magnetic flux distribution provided when the A-phase current Ia in FIG. 17(a) is increased. As shown in the figure, the magnetic fluxes 171, 172, 173, 174, 175, and 176 pass through a portion near the air gap, which is indicated by a thick elliptical dashed line 17A, from the rotor N magnetic pole 7N to the stator S magnetic pole 15L. Compared to FIG. 17(a), the magnetic fluxes 175 and 176 have increased. These magnetic fluxes 175 and 176 pass through the area enclosed by a rectangular line 161, which is the soft magnetic member portion of the rotor N magnetic pole 7N, pass through the vicinity of the air gap indicated by a thick elliptical dashed line 17A, and pass through the teeth of the stator S magnetic pole 15L.

In (b) of FIG. 17, the following assumptions are made. That is, the aforementioned A-phase current Ia is sufficiently large. In addition, due to the magnetic fluxes 175 and 176, the magnetic flux density at the teeth of the A-phase stator S magnetic pole 15L is provided by the magnetic flux φa1, which has a magnetic flux density of 2.0 [T], in the area enclosed by a rectangular line 161, which is composed of the soft magnetic member portion of the rotor N magnetic pole 7N. In addition, it is also assumed that the total of the magnetic fluxes 171, 172, 173, and 174 is equal to the magnetic flux φa2. Under these assumptions, the magnetic flux density Bagap in the air gap in an area indicated by a thick dashed line 17A overlaps with the magnetic fluxes φa1 and φa2. Therefore, considering a simple magnetic model, the magnetic flux density Bagap becomes 4.0 [T]. In the area indicated by the thick elliptical dashed line 17A, not only the air gap portion but also the magnetic resistance of the soft magnetic member portion near the air gap increases significantly. When assuming the magnetic characteristics of the soft magnetic member are as shown in FIG. 6, the relative permeability of the soft magnetic member approaches 1.0 for magnetic flux components exceeding 2.0 [T].

However, except for the area indicated by the thick broken line 17A, the magnetic flux density is configured so that it does not exceed 2.0 [T]. Therefore, increasing the A-phase current Ia results in a significant amount of magnetomotive force [A] which is applied to the area indicated by the thick dashed elliptical line 17A, thus leading to a high magnetic field strength [A/m] and causing the magnetic flux density to increase up to 4.0 [T]. The soft magnetic members outside the area 17A have a magnetic flux density of 2.0 [T] or less and a relative permeability of 100 or higher. Therefore, the required magnetomotive force, i.e., the excitation load, is relatively small. Additionally, the thickness of the back yoke portion of the stator can be sufficiently large to maintain low magnetic resistance. However, to achieve a magnetic flux density of 4.0 [T] in the air gap portion due to the A-phase current Ia, the magnetic paths of the adjacent rotor magnetic poles 7K and 7S, and the teeth of the adjacent stator magnetic poles 15J and 155 are utilized. Therefore, it is preferable not to excite the stator magnetic poles 15J and 155 simultaneously with the excitation of the stator S magnetic pole 15L, as this avoids the electromagnetic operation from being complicated. Additionally, a drive method where the circumferential adjacent stator magnetic poles are not used simultaneously when exciting a certain stator magnetic pole, or a drive method where they are used simultaneously but with reduced size and limited scope, or a drive method where they are used simultaneously will be described later.

Next, a case will be explained where the stator S magnetic pole 15L and the rotor S magnetic pole 7S are opposed to each other through an air gap, as shown in FIGS. 18(a) and (b). In this case, the rotor rotation angle is θr=−6°. This is the state where the S magnetic pole of the stator and the S magnetic pole of the rotor are positioned to be exactly opposite to each other, and the rotor rotation position θr=−6° is provided where magnetic flux is difficult to pass therethrough. In FIG. 18(a), an A-phase current Ia is applied to the A-phase winding 15P and the A/-phase winding 15Q, and the A-phase magnetic flux φa, which is shown by thick dashed lines with arrows, is excited. The A-phase magnetic flux φa, which is indicated by a reference number 181, and the magnetic flux components of the permanent magnets on the stator and rotor, shown by slightly thinner dashed lines, are overlaid. The A-phase magnetic flux φa, indicated by the reference number 181, can easily pass through because the teeth of the stator S magnetic pole 15L on the stator side are in a reverse bias state with respect to the magnetic fluxes. However, an area enclosed by a square line 182 around the rotor S magnetic pole 7S has permanent magnets 10A and 10B with magnetic fluxes in the same direction. This results in a higher magnetic flux density and increased magnetic resistance. Therefore, the passage of the A-phase magnetic fluxes ca is difficult. As a result, the value of the A-phase magnetic fluxes pa becomes smaller.

FIG. 18(b) shows a magnetic flux distribution, which is created by qualitatively converting the superimposed magnetic flux components shown in FIG. 18(a) into a distributed state. In FIG. 18(b), the A-phase magnetic flux (φa) component 184 passes through the soft magnetic member portion (the area enclosed by the rectangular line 183) of the rotor S magnetic pole 7S from the rotor back yoke. This magnetic flux component further passes through the tip of the stator S magnetic pole 15L on the stator side, through the permanent magnet 15H, through the teeth of the stator N magnetic pole 15J, and through the stator back yoke. The A-phase magnetic flux (φa) component 185 passes through the soft magnetic member portion (the area enclosed by the rectangular lines 183) of the rotor S magnetic pole 7S from the rotor back yoke. This magnetic flux component further passes through the tip of the stator S magnetic pole 15L of the A-phase on the stator side, through the permanent magnet 15S, 30 through the teeth of the stator N magnetic pole 155, and through the stator back yoke. The magnetic flux components 184 and 185 have a small value because the magnetic flux density in the area enclosed by the rectangular line 183 is already high, resulting in large magnetic resistance. Therefore, the magnetic flux component 187 of the 35 permanent magnets 15H and the magnetic flux component 188 of the permanent magnets 15S remain at a slightly reduced level.

Furthermore, the teeth of the stator S magnetic pole 15L in the A-phase remain in a magnetically reverse-biased state due to the magnetic flux components 187 and 188.

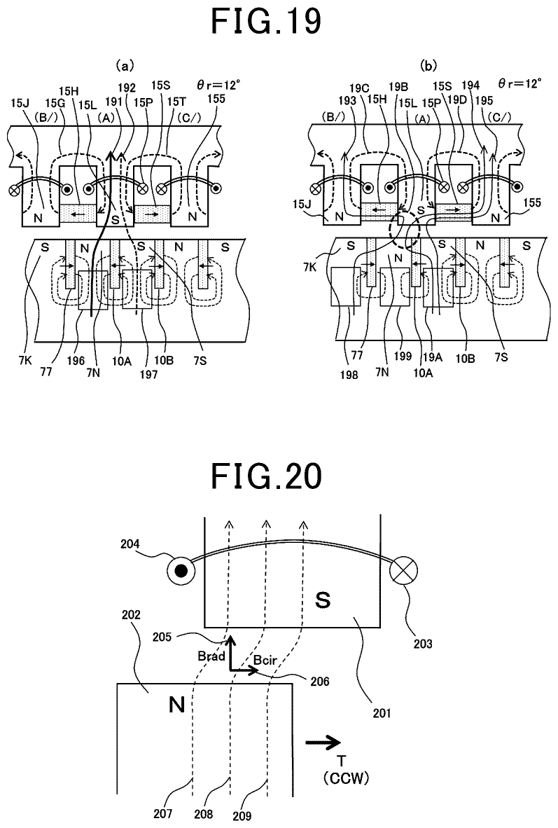

Next, FIGS. 19(a) and (b) show a state in which torque is generated in the counterclockwise (CCW) direction. In this state, the rotor rotation angle is θr=12°. The A-phase stator S magnetic pole 15L is opposed to a half of the rotor N magnetic pole 7N and a half of the rotor S magnetic pole 7S through the air gap. In FIG. 19(a), an A-phase current Ia is applied to the A-phase winding 15P and the A/-phase winding 15Q. As a result, the A-phase magnetic flux (φa) component passing through rotor N magnetic pole 7N, shown by the thick arrowed line, and the A-phase magnetic flux φa component passing through rotor S magnetic pole 7S, shown by the thin dashed line, pass through the A-phase stator S magnetic pole 15L. These magnetic flux components 191 and 192 are overlaid with the magnetic flux components of each permanent magnet indicated by dashed lines. The thick-lined magnetic flux components 191 mentioned earlier are generated in the area enclosed by the square line 196 of the rotor N magnetic pole 7N, where the magnetic flux components of the permanent magnets are generated in the reverse direction. In this state, since the magnetic flux components have a reverse direction bias, the magnetic flux components can easily pass therethrough. The magnetic flux components 192, indicated by the thin dashed lines, have the same direction as the magnetic flux components of the permanent magnets in the area enclosed by the square line 197 of the rotor S magnetic pole 7S. This results in high magnetic resistance, causing the magnetic flux passing through to be small.

FIG. 19(b) shows a magnetic flux distribution, which is created by qualitatively converting the superimposed magnetic flux components shown in FIG. 19(a) into a distributed state. A magnetic flux component 193 passes through the area enclosed by the square line 198 from the rotor back yoke to the rotor S magnetic pole 7K. This magnetic flux component 193 further passes the permanent magnets 77, the rotor N magnetic pole 7N, the air gap, the tip of the stator S magnetic pole 15L of the A phase on the stator side, the permanent magnet 15H, the teeth of the stator N magnetic pole 15J, and the stator back yoke. A magnetic flux component 194 passes through the area enclosed by the square line 19A of rotor S magnetic pole 7S from the rotor back yoke. This magnetic flux component 194 further passes permanent magnets 7A, rotor N magnetic pole 7N, the air gap, the tip of stator S magnetic pole 15L of the A-phase on the stator side, the permanent magnet 15S, the teeth of stator N magnetic pole 155, and the stator back yoke.

A magnetic flux component 195 passes through the area enclosed by the square line 19A from the rotor back yoke, through the rotor S magnetic pole 7S, and through the air gap. Furthermore, the magnetic flux component 195 passes through the stator S magnetic pole 15L of the A phase on the stator side, the permanent magnets 15S, the teeth of the stator N magnetic pole 155, and the stator back yoke. In this distribution state, there is no magnetic flux passing through the teeth of the stator S magnetic pole 15L of the A phase, and the magnetic flux is inversely biased by the permanent magnets 15H and 15S. Therefore, by increasing the aforementioned A-phase current Ia, a sufficient residual capacity remains in the magnetic fluxes for passing through the stator S magnetic pole 15L.

Furthermore, in this state, the magnetic flux component 193 is already a large value, and the magnetic flux component 19C of the permanent magnets 15H is a small value. Furthermore, when the A-phase current Ia increases or the rotor rotation angle θr increases, the magnetic flux component 193 increases. As a result, the initial magnetic flux component 19C of the permanent magnets 15H disappears. The magnetic flux component 194 is also already a large value, and the magnetic flux component 19D of the permanent magnets 15S is a small value. Furthermore, when the A-phase current Ia increases or the rotor rotation angle θr increases, the magnetic flux component 194 increases. Therefore, the initial magnetic flux component 19D of the permanent magnets 15S disappears. Furthermore, as the A-phase current Ia increases or the rotor rotation angle θr becomes larger, magnetic fluxes pass through the teeth of the A-phase stator S magnetic pole 15L from the lower side to the upper side of the paper, and increases. In this state, the magnetic fluxes passing through the teeth of the stator S magnetic pole 15L changes from a negative bias state to a positive bias state and increases. Additionally, the magnetic flux density in the area enclosed by the rectangular line 19A is already high due to magnetic resistance, thus resulting in the magnetic flux component 195 having a small value.

In this state, when the A-phase current Ia is further increased, the portion indicated by the thick dashed circle 19B, which corresponds to the soft magnetic member between the stator S magnetic pole 15L and the rotor N magnetic pole 7N and the air gap portion between them, experiences a concentration of magnetic flux, thus resulting in a high magnetic flux density. When excluding the thick dashed circular area 19B, the remaining magnetic fluxes can pass through other magnetic paths with sufficient capacity, thus resulting in low magnetic resistance. Therefore, a magnetomotive force [A·turn] corresponding to an increase in the A-phase current Ia can be applied to the thick dashed circular area 19B, thereby providing a strong magnetic field strength [A/m] and enabling magnetic excitation therefor. The thick dashed circular region 19B refers to both an air gap portion and a soft magnetic member portion near the tip of the stator magnetic pole where the magnetic flux density reaches 2.0 [T] or higher, thus causing the permeability to significantly decrease, as well as a soft magnetic member portion near the tip of the rotor magnetic poles. As shown in the magnetic characteristics in FIG. 6, when the magnetic flux density reaches 2.0 [T] or higher, the relative permeability of the soft magnetic member decreases to a small value close to 1.

However, in a very limited narrow area, it is possible to increase the A-phase current Ia [A·turn] to apply a higher magnetic field strength [A/m] to such a narrow area, and for example, the magnetic flux density in that part can be increased to a large value of 4.0 [T] or more. As will be explained later in equation (19), this results in a torque equal to the square of the magnetic flux density. For example, 35 the magnetomotive force corresponding to the increase in exciting current from 2 [T] to 4 [T] for a soft magnetic member with a permeability of 1 and a length of 5 mm is (4−2)/μo×0.005=7958 [A·turn]. μo is the vacuum permeability. For motors outputting 10 kW or more at the maximum torque, the current is a realistic value obtained by multiplying the magnetomotive force by the winding current and the number of turns. At 4.0 [T], the force and torque are four times greater than at 2.0 [T]. Of course, magnetic flux densities between 2.0 and 4.0 [T] can also be used. For example, at 3.0 [T], the force and torque are calculated to be 2.25 times greater than the value at 2.0 [T].

Next, an explanation is given in case where the changes in magnetic flux and torque T that occur when the motor shown in FIG. 14 is rotated from a rotor rotation angle θr=0° to 30°. It is assumed that an A-phase current Ia=Ia1 flows through the A-phase winding 15P and A/-phase winding 15Q for rotating the rotor. The circumferential width of the air gap between the stator magnetic poles and the rotor magnetic poles is set to 30°. Additionally, the rotor magnetic pole pitch is 36°. As shown in FIG. 1, the rotor rotation angle θr=0° is defined as the rotor rotation position immediately before the A-phase stator S magnetic pole 11 electromagnetically acts on the rotor N magnetic pole 1H to generate counterclockwise (CCW) torque. FIG. 5 shows an example where the rotor rotation angle θr is 12°. Hence, the rotor rotation angle in FIG. 18(b) is θr=−6°. The state where the rotor rotates counterclockwise by θr=12° is shown in FIG. 19(b). Further a counterclockwise rotation by θr=30° corresponds to either FIG. 17(a) or (b), but considering the condition where the current Ia1 is sufficiently large to excite the magnetic flux, the state shown in FIG. 17(b) is defined as the state where θr=30°. In this way, when the A-phase current Ia=Ia1 is applied, the rotor rotates from FIG. 18(b) to FIG. 19(b) and then to FIG. 17(b), and the distribution of magnetic fluxes changes.

Next, it is determined, in each state, the magnetic flux density Ba of the teeth of the status S magnetic pole 15L and the interlinkage magnetic flux φa of the A-phase winding 15P. The rotor position θr is considered at three points: θr=0° (6° advanced from the position in FIG. 18(b)), θr=15° (3° advanced from the position in FIG. 19(b)), and θr=30° (the same as in FIG. 17(b)), and the results are compared. At the position θr=0° (6° advanced from −6° in FIG. 18(b)), in the initial state, the magnetic flux density Ba1 in the area enclosed by the rectangular line 183 is assumed to be inversely biased by the permanent magnets, resulting in Ba1=−2.0 [T]. Since the motor is in a magnetic saturation state, the magnetic resistance is large, so that for the sake of simplicity, the magnetic flux 184 and 185 are assumed to be 0 [Wb]. It is noted that the radius of the rotor is Rr, and the axial length is Lr. The circumferential angle between the stator magnetic poles and the rotor magnetic poles at the air gap surface is 30°, and the circumferential width, i.e., the circumferential length Lpcir [m], is given by the following equation.

$$Lpcir = 30 ° \times ( 2 π / 180 ) \times Rr \qquad ( 8 )$$

In this state, the teeth of the stator S magnetic pole 15L are inversely biased with the permanent magnets 15H and 15S, thus resulting in negative magnetic fluxes and a negative magnetic flux density Ba2. Now, assume that the negative bias value Ba1 is exactly equal to the magnetic flux density Ba2=−2.0 [T]. In this state, the interlinkage magnetic flux φa1 [Wb] of the A-phase winding 15P is given by the following equations. Additionally, the magnetic flux density Bgap1 and magnetic flux φgap1 in the air gap portion are both 0 [Wb].

$$Bgap 1 = 0 \qquad ( 9 )$$

$$φ gap 1 = 0$$

$$Bag = - 2.$$

$$( 10 )$$

$$φ a 1 = Ba 1 \times 30 ° \times ( 2 π / 180 ) \times Rr \times Lr = - 2. \times 30 ° \times ( 2 π / 180 ) \times Rr \times Lr$$

And, at the position of θr=15°, which is 3° advanced from the state shown by (b) in FIG. 19, the current Ia1 is sufficiently large. Hence, it is assumed that the magnetic flux density Bgap2=+4.0 [T] in a 15° circumferential width of the air gap where the stator S magnetic pole 15L and the rotor N magnetic pole 7N are opposed to each other.

The magnetic flux φgap2 passing through the air gap is given by the following equation.

$$Bgap 2 = + 4. \qquad ( 11 )$$

$$φ gap 2 = Bgap 2 \times 15 ° \times ( 2 π / 180 ) \times Rr \times Lr = 4. \times 15 ° \times ( 2 π / 180 ) \times Rr \times Lr$$

The magnetic flux φa2 through the teeth 15l of the stator s magnetic poles is the sum of the inversely biased magnetic flux components 19c and 19d caused by the permanent magnets 15h and 15s, and the sum of the aforementioned φgap2, which exactly cancel each other out to 0 [wb]. As a result, this magnetic flux density ba2 is also 0 [t].

$$ba 2 = 0 \qquad ( 12 )$$

$$φ a 2 = φ a 1 + φ gap 2 = - 2. \times 30 ° \times ( 2 π / 180 ) \times rr \times lr + 4. \times 15 ° \times ( 2 π / 180 ) \times rr \times lr = 0$$

In FIG. 17(b), when θr=30°, the magnetic flux density Bgap3 in the 30° circumferential width of the air gap where the stator S magnetic pole 15L and rotor N magnetic pole 7N opposed to each other is assumed to be +4.0 [T] in terms of a model analysis. The magnetic flux φgap3 passing through the air gap is given by the following equation.

$$Bgap 3 = + 4. \qquad ( 13 )$$

$$φ gap 3 = Bgap 3 \times 30 ° \times ( 2 π / 180 ) \times Rr \times Lr = 4. \times 30 ° \times ( 2 π / 180 ) \times Rr \times Lr$$

The magnetic flux φa3 of the teeth of status s magnetic pole 15L is the sum of the inversely biased magnetic flux component φa1 and the aforementioned φgap3, and is given by the following equation.

$$φ a 3 = φ a 1 + φ gap 3 = - 2. \times 30 ° \times ( 2 π / 180 ) \times Rr \times Lr + 4. \times 30 ° \times ( 2 π / 180 ) \times Rr \times Lr = 2. \times 30 ° \times ( 2 π / 180 ) \times Rr \times Lr \qquad ( 14 )$$

The magnetic flux density Ba3 in this case is divided by the area Ss3 of the opposing stator magnetic poles, thus giving the following equation.

$$Ss 3 = Lpcir \times Lr = 30 ° \times ( 2 π / 180 ) \times Rr \times Lr \qquad ( 15 )$$

$$Ba 3 = φ a 3 / Ss 3 = 2. \times 30 ° \times ( 2 π / 180 ) \times Rr \times Lr / ( 30 ° \times ( 2 π / 180 ) \times Rr \times Lr ) = 2.$$

The foregoing shows the state where the rotor rotates to the positions θr of 0°, 15°, and 30° while the A-phase current Ia=Ia1 is applied. In other words, the magnetic flux density and magnetic flux in the airgap portion, as well as the magnetic flux density and magnetic flux in the teeth of the stator S magnetic pole 15L (i.e., the interlinkage magnetic flux φ of the A-phase winding 15P) are shown in equations (9) to (15). The interlinkage magnetic flux φ of the A-phase winding 15P changes from the negative value shown in equation (10) to 0 shown in equation (12) and then to the positive value shown in equation (14). On the other hand, the power supply to the motor when the motor rotates at a constant rotational speed w is shown to be expressed by equation (3). Equation (3) shows that the power supply is proportional to the rate of change of the interlinkage magnetic flux φ rather than its magnitude. That is, for example, when the interlinkage magnetic flux changes such as 0, 2, 4, and when the interlinkage magnetic flux changes such as −2, 0, 2, the power supply in Equation (3) is the same. Therefore, it has been demonstrated that the permanent magnets can be used to bias the magnetic paths of the stator and rotor with negative magnetic flux, as shown in FIG. 16. Additionally, as shown in FIG. 6, the magnetic characteristics of the soft magnetic member demonstrate that torque can be generated by utilizing the changes in magnetic flux density from negative to positive values (magnetic flux density 69, 6A) under the drive of unidirectional electric currents.

Additionally, the torque T [Nm] values of the motor shown in FIG. 14 is given by equation (7). Δφ/Δθ shows an angular rate in changes of the magnetic fluxes interlinking the windings, and this angular rate increases with the rotor rotation angle θr. The angular rate represents an angular rate in changes of the values to be calculated in equations (10), (12), and (14). The magnetic flux in equation (12) is zero. In FIG. 11(b), torque is generated when the rotor rotation angle θr is 12°. The torque is proportional to the angular rate of change of the magnetic flux interlinking the windings, rather than the magnitude of the magnetic flux itself. It is noted that the torque equation (7) is derived from power supplied to the motor, as shown in equations (2) and (3), and is used to indirectly estimate and calculate the torque. Internal losses within the motor are neglected.

The interlinkage magnetic flux φa of the A-phase winding 15P shown in equations (10), (12), and (14) is magnetically coupled with the magnetic flux φgap of the airgap portion shown in equations (9), (11), and (13).

As shown in (a) of FIG. 18, (b) of FIG. 16, and (a) of FIG. 19, the interlinkage magnetic flux φa of the foregoing A-phase winding 15P is a value obtained by subtracting the inversely biased magnetic flux φbias of the permanent magnets of the stator from the magnetic flux φgap of the airgap portion.

$$φ a = φ gap - φ bias \qquad ( 16 )$$

Assuming that the inversely biased magnetic flux φbias is a constant value, substituting the magnetic flux φ in equation (7) yields the following equation. Furthermore, the torque T is proportional to the rate in changes of the magnetic flux φgap in the air gap portion.

$$T = Nw \times I \times Δ ( ( φ gap - φ bias ) / Δθ \qquad ( 17 )$$

$$= Nw \times I \times Δφ gap / Δθ \qquad ( 18 )$$

Additionally, there is a method known for directly calculating electromagnetic forces and torque using an approach which is different from equations (7) and (17).

This method involves deriving Maxwell's stress, and the circumferential force Fmaxwell [N] generated in the air gap portion of the motor is given by the following equation.

$$Fmaxwell = Brad \times Bcir / μ o \qquad ( 19 )$$

In this equation, Brad [T] denotes the radial component of the magnetic flux density, Bcir [T] denotes the circumferential component of the magnetic flux density, and μo denotes the vacuum permeability. Examples of Brad and Bcir are shown in FIG. 20, which will be explained later. The circumferential force Fmaxwell [N] in equation (19) is determined by observing the magnetic flux distribution and magnetic flux density in the airgap portion, resulting from current excitation. Therefore, equation (19) does not include a current value. The force Fmaxwell [N] can be analyzed and designed using only the magnetic flux distribution and magnetic flux density. In addition, this circumferential force Fmaxwell [N] is a force density. By integrating the circumferential force Fmaxwell [N] generated in the airgap portion over one full rotation and multiplying by the rotor radius Rr [m] and the rotor axial length Lr [m], the motor torque T [Nm] can be calculated.

Additionally, it is known that the attractive force between the N magnetic pole and the S magnetic pole opposed to each other is proportional to the square of the magnetic flux density. Equation (19) also shows that the force Fmaxwell [N] is proportional to the square of the magnetic flux density. For example, if the magnetic flux density can be increased from 2.0 [T] to 4.0 [T], the force and torque will 15 increase fourfold. In principle, if the magnetic flux density can be further increased to 6.0 [T], there is a possibility that the force and torque could increase ninefold. Therefore, if a motor configuration that can increase the magnetic flux density can be realized, a significant increase in torque can be expected. Additionally, in the supply power in equations (1) and (2), the torque equation based on equation (7), and the Lorentz force based on equation (20), increasing the exciting current by a factor of two to double the magnetic flux density results in a fourfold increase in supply power, torque, and force, respectively. While conventional motors may occasionally exceed 2.0 [T] in certain areas, their magnetic circuits are designed to account for magnetic saturation of the soft magnetic members, so even when large currents [A·turn] are applied, the magnetomotive force [A·turn] is consumed throughout the entire magnetic circuit, and the magnetic flux density in the air gap portion does not increase significantly. Thus, the maximum torque of the motor is often limited by the magnetic saturation of the entire motor magnetic circuit.

When the magnetic flux density exceeds 2.0 [T], it may not be possible to increase the magnetic flux density in proportion to the exciting current due to the configuration of the magnetic circuit. For example, if the exciting current is increased to 2.5 times its original value from a state where the magnetic flux density is 2.0 [T], and the magnetic flux density finally reaches 4.0 [T], the torque will only increase to four times its original value, as per Equation (19). This occurs, for example, when the magnetomotive force [A] corresponding to half the exciting current is consumed in some magnetic resistance components through which the magnetic flux φasses. In the motor of the present invention shown in FIG. 14, it is assumed that a small portion of the magnetic circuit of the soft magnetic member near the air gap portion exceeds a magnetic flux density of 2.0 [T] and becomes magnetically saturated. Such magnetic energy is not converted into heat but is regenerated as electrical energy.

FIG. 20 shows a simplified example of a portion of the torque-generating part of the motor shown in FIG. 14. FIG. 20 is an enlarged view with the surrounding structure omitted. A reference number 201 in FIG. 20 shows a stator S magnetic pole 15L shown in (b) of FIG. 19. Part 202 in FIG. 20 shows a rotor N magnetic pole 7N shown in (b) of FIG. 19. In particular, the air gap portion is shown in FIG. 20 with large magnification for explanatory purposes. FIGS. 20, 203 and 204 indicates the A-phase windings 15P shown in FIG. 19(b). Permanent magnets 15H, 15S, 77, 10A, and their outer peripheries are omitted. The distribution of magnetic flux other than the airgap portion is simplified and shown in principle.

Reference numbers 207, 208, and 209 indicate magnetic fluxes, where a reference number 205 indicates the radial direction magnetic flux density component Brad [T] from equation (19), and a reference number 206 indicates the circumferential magnetic flux density component Bcir [T]. The direction of torque T is indicated by an arrow. As shown in equation (19) and FIG. 20, the motor torque is represented by the magnetic flux distribution in the airgap portion, and it can be confirmed that torque proportional to the magnitude of the magnetic flux density is obtained.

The value from the equation (19) can be calculated by using a finite element method (FEM) analysis on a computer to determine the magnetic flux density distribution in the air gap. However, this calculation is computationally intensive and difficult to perform by hand on the desk. Furthermore, the torque T calculated using (7) for the entire circumference of the motor and the torque T calculated using (19) are nearly identical. Hence, from the aforementioned equation (19), it can be inferred that increasing the magnetic flux density in the air gap portion can lead to an increase in torque T [T]. This can be considered an effective torque evaluation method.

Furthermore, the force F [N], known as the Lorentz force or Fleming's left-hand rule, is given by the following equation.

This force F [N] is expressed by the following equation, which is based on windings placed in a region whose magnetic flux density B [T] is uniform and configured to have a length Lr [m] and the number of wound turns Nw, and the current I [A]. The torque T is obtained by multiplying by the rotor radius Rr.

$$F = B \times ( Nw \times I ) \times Lr \qquad ( 20 )$$

$$T = F \times Rr$$

$$= B \times ( Nw \times I ) \times Lr \times Rr \qquad ( 21 )$$

Furthermore, Δφ in equation (7) is expressed by equation (22) and substituted into equation (7).

$$Δφ = B \times Δθ \times Rr \times Lr \qquad ( 22 )$$

$$T = Nw \times I \times ( Δφ / Δθ )$$

$$= Nw \times I \times ( B \times Δ θ \times Rr \times Lr ) / Δθ \qquad ( 23 )$$

$$= B \times ( Nw \times I ) \times Lr \times Rr \qquad ( 24 )$$

In the foregoing formulation, equation (24), which is a transformation of equations (21), and equation (7) are the same in their expressions. That is, the torque generated by a current with a uniform magnetic flux density B [T] is the same as the torque generated by the attractive force between the salient poles shown in FIG. 20. From the perspective of the rate of changes in interlinkage magnetic flux, both conditions can be said to be common. Additionally, the torque calculated from the force density (Fmaxwell) in equation (19) also becomes the same as that from equation (21) when being transformed. These are expressions that describe the same physical phenomenon from different perspectives, thus making them useful for understanding and evaluating the state.

From the perspectives of torque T and magnetic flux density B, the motor of the present invention shown in FIG. 14 is compared with the conventional switch reluctance motor shown in FIG. 63 Assuming that the soft magnetic member has the magnetic characteristics shown in FIG. 6, the motor of the present invention shown in FIG. 14 is able to increase the magnetic flux density Bgap in the air gap portion to 4.0 [T], as shown in equations (11) and (13). In this case, the maximum torque of the motor of the present invention shown in FIG. 14 is four times that of the conventional switch reluctance motor shown in FIG. 63.

In addition, the explanations from FIG. 16 to FIG. 19 have dealt with the amount of magnetic fluxes inversely biased by permanent magnets in the soft magnetic member magnetic path. This amount has been set by assuming that the maximum value of magnetic flux density in both the tooth area of the stator S magnetic pole 15L in FIG. 16(a) and the area enclosed by the square line of the rotor N magnetic pole 7N is −2.0 [T]. This is consistent with the assumed soft magnetic member magnetic characteristics shown in FIG. 6. Equations (9) to (15) have been explained based on this assumption.

It is also possible to increase the amount of magnetic fluxes in the permanent magnets of the stator and rotor shown in FIG. 14, so that the magnetic fluxes overflows to the air gap side as shown in FIG. 10 and FIG. 11, indicated by the reference numbers 106, 107, 108, and 109. In this case, as shown in FIG. 15 and (b) of FIG. 17, a large current is applied to the excitation winding 15P of the phase-A stator S magnetic pole 15L and to the excitation winding 15Q of the A/-phase. This allows utilization of the stator magnetic poles 15J and 155 on both sides of the stator S magnetic pole 15L. The airgap portion magnetic flux density Bgap [T] is 6.0 [T] by a simple calculation in principle. In this case, the maximum torque of the motor shown in FIG. 14 is 9 times higher than that of the conventional switched reluctance motor shown in FIG. 63, which can be derived from formula (19). The motor size and cost are often designed based on the most severe drive conditions, not on motor efficiency at light loads. Thus, for example, in the case of a motor for the main engine of an electric vehicle, a large torque range is required at low speeds because of the severe hill climbing operation of steep hills. There are many such applications, and the maximum torque, power factor in such cases, torque constant, copper loss, and other losses and efficiencies are important for downsizing, weight reduction, and cost reduction of motors. The motor shown in FIG. 14 has an advantage in maximum torque, as described above.

As shown in FIG. 14, FIG. 15, and (b) of FIG. 17, when two stator magnetic poles of one phase are excited, each magnetic pole uses two teeth on both sides, for a total of six teeth to pass the magnetic flux and generate torque. FIG. 17(b) shows a distribution of magnetic fluxes at the position of rotor rotation where the magnetic flux is maximum. In this distribution, the maximum torque of the motor refers to the maximum value of the average torque when the rotor revolves one rotation, not the maximum torque at a specific angle of a part of the rotor rotation angle θr as in the example in FIG. 64. To increase the maximum torque, i.e., the average torque per revolution, the magnetic circuit of the motor, excluding the area around the airgap portion, must be configured to prevent magnetic saturation by effectively utilizing the magnetic circuit of the motor, as shown in (b) of FIG. 17. In addition, IPMSM synchronous motors with built-in magnets, which are often used conventionally, have the problem of a phase difference between the voltage phase and current phase in each winding due to the effect of armature reaction in the operating range of maximum torque or in the operating range of high-speed rotation where weak field control is performed for constant output control, thereby resulting in a lower power factor. As a result, the motor copper loss increases and the current capacity of the driving circuit transistor increases, thereby leading to a larger size and higher production cost of the motor. Any conventional motos has been confronted with such limitations and restrictions on maximum torque.

In addition, when the required motor torque is small, the current value is naturally small. Furthermore, the magnetic flux density at the tip of the stator magnetic pole and the tip of the rotor magnetic poles near the air gap is given without exceeding 2.0 [T], the saturation magnetic flux density. When a large torque is required, the current is increased and the magnetic flux density in the region 19B, indicated by the dashed circle in (b) of FIG. 19, is made to increases As mentioned above, if the permanent magnets for the inversely biased drive have sufficient performance, the magnetic flux density in the circled region 19B can be as high as 4.0 [T] to 6.0 [T]. That is, until the circled region 19B reaches 6.0 [T], the magnetic flux density of the other soft magnetic members except for the circled region 19B is equal to or less than 2.0 [T]. Therefore, in the case of the magnetic characteristics assumed in FIG. 6, the specific permeability is large, and the magnetic flux can pass through without difficulty.

The possibility of generating a large torque by increasing the magnetic flux density of the airgap portion has been described above. However, magnetic circuits that exceed the saturation magnetic flux density of the soft magnetic member have problems such as leakage magnetic flux, demagnetization of the permanent magnets, magnetic energy (B·H/2) in the area where the magnetic flux density is large, and other problems. For example, in the case of a motor for the main engine of an electric vehicle, since the motor is mainly used for forward torque, a structure that can effectively generate forward torque can be used. Various types of permanent magnets can be used. Amorphous steel sheets with low iron loss can be used, and permendur steel sheets with high magnetic flux density can be partially used. Power devices such as power MOSFETs, SiC, and GaN can be used to increase the rotation speed of a motor.

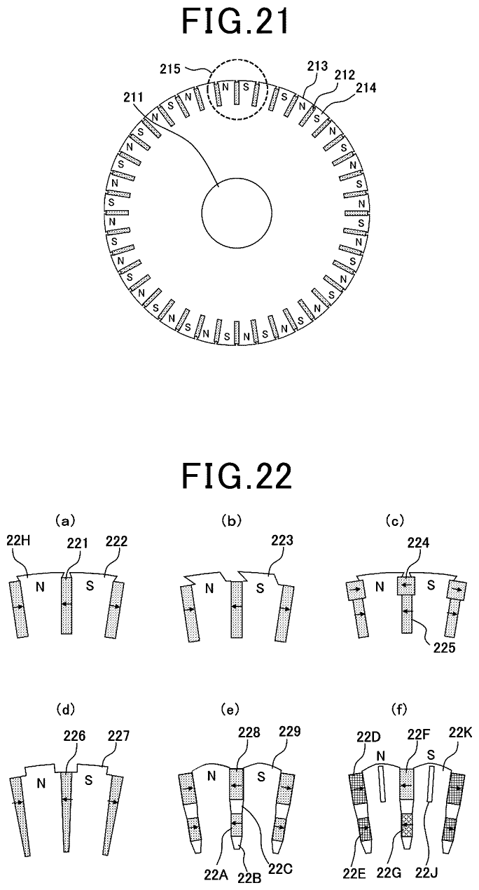

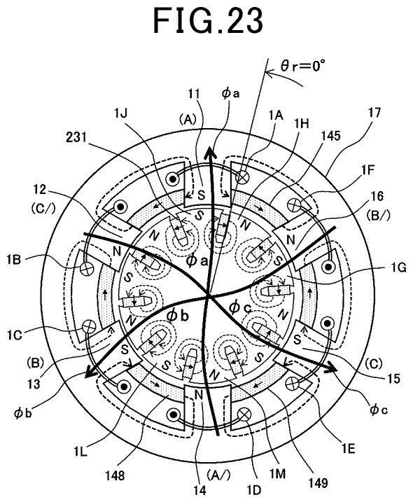

Next, examples of the shape of the permanent magnets of the rotor and their vicinity are shown in FIG. 21 and FIG. 22. The motor in FIG. 14 has a 6S10R configuration with 6 stator magnetic poles and 10 rotor magnetic poles. For motor designs with a motor diameter exceeding 200 mm, the number of stator magnetic pole pairs can be increased for downsizing. However, as the number of rotor magnetic pole pairs increases, there is a limit to high-speed rotation due to increased iron loss and the frequency limit of current control necessary in the driving circuit. In this configuration, assuming a 24S40R motor with 4-pole pairs as shown in FIG. 14, an example of a rotor shape with 40 rotor magnetic poles is shown in FIG. 21. In this motor configuration, a reference number 211 denotes a rotor shaft, a reference number 212 denotes a permanent magnet, a reference number 213 denotes an N magnetic pole, and a reference number 214 denotes the S magnetic pole. The direction of the magnetic poles of each permanent magnet is oriented in the direction of the polarity of each rotor magnetic poles.

Various examples of rotor magnetic poles are then shown in FIGS. 22(a) to (f). These figures are partially enlarged from the dashed circle 215 shown in FIG. 21. In (a) of FIG. 22, a reference number 221 denotes a permanent magnet. The direction of the magnetic flux of each permanent magnet is indicated by the direction of an arrow drawn on the magnet. A reference number 222 denotes an S magnetic pole and a reference number 22H denotes an N magnetic pole. The shape of an S magnetic pole 223 shown in (b) of FIG. 22 is not symmetrical in front and behind the circumferential, and the characteristics of CCW torque and CW torque are different. For motors used in applications where torque in one direction is mainly important, it is possible to emphasize torque in one direction and sacrifice some torque characteristics in the opposite direction.

The permanent magnet 224 has a shape shown in (c) of FIG. 22 has a larger circumferential thickness than the permanent magnet 225. In the motor shown in FIG. 14, a large amount of current is applied to generate a large torque, so that a large magnetomotive force H [A/m] acts on the permanent magnets, especially near the air gap. The demagnetization resistance can be improved by increasing the thickness of the circumferential, as in the shape of permanent magnet 224. The shape of a permanent magnet 226 shown in (d) of FIG. 22 has a larger circumferential thickness on the air gap side and a smaller circumferential thickness on the inner diameter side. Similarly to the above-mentioned permanent magnets 224, the air gap side of a permanent magnet 226 is hard to demagnetize. The shapes of the permanent magnets 226 can be varied, such as a shape provided between the aforementioned permanent magnets 224 and 225.

FIG. 22(d) shows an example where the shape of an S magnetic pole 227 is convex, and can be made into a rectangular or trapezoidal shape. The shape of an S magnetic pole 229 in (e) of FIG. 22 is a circular arc. The magnetic pole shape of the rotor can be deformed. Permanent magnets of 228 and 22A shown in (e) of FIG. 22 have different circumferential thicknesses and are separated in the radial direction. Reference numbers 22B and 22C indicate spaces, which can be non-magnetic materials such as resin. Reference numbers 22D, 22E, 22F, and 22G in (f) of FIG. 22 show magnets of different types and characteristics. A part of these magnets can be a space or a nonmagnetic material such as resin. A reference numbers 22K shows an S magnetic pole provided with a slit which is an elongated space 22J. By changing the magnetic flux distribution inside an S magnetic pole 22K, the torque characteristics can be changed. The direction of the slits 22J can be changed, and they can be placed at an angle to change the CCW and CW torque characteristics. The number and shapes of slits 22J can be changed. The slits 22J can be replaced with permanent magnets.

In the motor according to the present invention, the space on the rotor side may be relatively insufficient. From this perspective, the design freedom of the rotor can be improved by using the so-called outer rotor structure, in which the rotor is placed on the outer diameter side and the stator is placed on the inner diameter side. In this configuration, a slot cross-sectional area, or winding space, can be secured even if the stator is placed on the inner diameter side because the motor structure has a relatively wide slot cross-sectional area of the stator. In the so-called axial gap type motor structure, in which the stator and rotor are arranged to be opposed to each other in the rotor axial direction, the stator side and the rotor side can be arranged magnetically equivalent.

As described, there have been shown that the magnetic flux density of the airgap portion can be increased up to 4.0 [T] and that a large torque can be generated for the inventive motor shown in FIG. 14. Furthermore, from the magnetic flux limit of the magnetic circuit that goes around, the possibility of 6.0 [T] was shown by a simple calculation in principle. Although FIG. 14 shows an example of a concentrated windings winding, different features can be achieved using full-pitch windings, and the technique will be explained later. The number of phases is shown as 3 phase, but other phases such as 5, 7, 9, 11, or 13 phases are also possible, and in such cases, a specific number of rotor magnetic poles will give particularly excellent characteristics. When the number of phases is a prime number and large, the harmonic components of the generated force have a canceling effect and noise is easily reduced.

An example according to claim 3 will now be described.

Claim 3 explains a motor with a so-called concentrated winding configuration, which is wound around the teeth of stator magnetic poles 11 and 12 in FIG. 1 and FIG. 14. One of the features of FIG. 1 and FIG. 14 is that the torque can be increased by reducing the magnetic resistance of the rotor magnetic poles because the magnetic fluxes through the rotor magnetic poles can be increased as described above. Also, as shown in FIG. 13, there are more degrees of freedom in the current waveform during motor rotation, such as trapezoidal current waveforms, than in the conventional motor shown in FIG. 63. In addition, compared to the full-pitch windings, in which the winding pitch of concentrated windings spans multiple stator magnetic poles, it is easier to fabricate windings and to improve the area ratio of the windings, which leads to smaller motors. Also, compared to the full-pitch windings, the length of the coil end protruding in the axial direction can be reduced. This is superior in terms of size miniaturization because the motor length can be reduced. On the other hand, there are some problems that need to be solved, which will be explained in the following.

Next, to explain the operations of the motor in FIG. 14, FIG. 23 shows a rotational position of the rotor as θr=0° and the A-phase magnetic flux component φa, B-phase magnetic flux component φb, and C-phase magnetic flux component qc, which are superimposed on each other in terms of expression in the figure. The starting point of the rotor, the rotational position θr=0°, is the position where the lower right corner of a phase-A stator S magnetic pole 11 faces the upper left corner of a rotor N magnetic pole 1H through the air gap, as shown in FIG. 23. This rotor rotation position θr shows the rotation position θr where the A-phase stator N magnetic pole 11 starts to generate torque.

As described above, the concentrated winding 1A of the A-phase A and the concentrated winding 1D of the A/-phase shown in FIG. 23 are connected in series. In this case, the A-phase voltage Va is given by the sum of those voltages induced by the A-phase and A/-phase windings. For example, the interlinkage magnetic flux of the concentrated winding 1A in the A-phase is given by “φa−φbiasa”. The magnetic flux of the concentrated winding 1D in the A/-phase is given by “φa−φbiasa/”. The passing magnetic flux in the area where the S magnetic pole 11 of the stator is opposed to the rotor S magnetic pole 1J is as explained in FIG. 18. In other words, since they are the same S magnetic poles, the passing magnetic flux is small. In this section, it is assumed, for a simplified explanation, that there is no passing magnetic flux.

$$V a = Nw / 2 \times d ( φ a - φ biasa ) / dt + Nw / 2 \times d ( ( φ a - ( φ biasa / ) / dt \qquad ( 31 )$$

Similarly, the B-phase and C-phase voltages Vb and Vc are as follows.

$$V b = Nw / 2 \times d ( ( φ b - φ biasb ) / dt + Nw / 2 \times d ( ( φ b - φ biasb / ) / dt \qquad ( 32 )$$

$$V a = Nw / 2 \times d ( ( φ c - φ biasb ) / dt + Nw / 2 \times d ( ( φ c - φ biasc / ) / dt \qquad ( 33 )$$

In this case, the number of turns of the concentrated windings is Nw/2 [turns]. A symbol φbiasa indicates a bias magnetic flux on the teeth of the A-phase stator S magnetic pole 11 by the permanent magnets 145 and 146 placed on the sides of the A-phase stator S magnetic pole 11. A symbol φbiasa/indicates a bias magnetic flux of the teeth of the A/-phase stator N magnetic pole 14 by the permanent magnets 148, 149 that are placed on the sides of the A/-phase stator S magnetic pole 14. Similarly, a symbol φbiasb indicates a tooth bias magnetic flux of the B-phase stator S magnetic pole 13. A symbol φbiasb/indicates a tooth bias magnetic flux of B-phase stator N magnetic pole 16. Similarly, a symbol φbiasc indicates a tooth bias magnetic flux of the C-phase stator S magnetic pole 15. A symbol φbiasc/indicates a bias magnetic flux of the teeth of the C-phase stator N magnetic pole 12.

Now assuming that the aforementioned bias magnetic fluxes @biasa, φbiasa/, φbiasb, φbiasb/, φbiasc, and φbiasc/are unchanged and constant, equations (31), (32) and (33) can be simplified using assumed values Vak, Vbk and Vck. Specifically, the following equations are obtained.

$$V ak = Nw \times d φ a / dt \qquad ( 34 )$$

$$V bk = Nw \times d φ b / dt \qquad ( 35 )$$

$$V ck = Nw \times d φ c / dt \qquad ( 36 )$$

As mentioned above, the interlinkage magnetic flux of the A-phase concentrated winding 1A is expressed by φa−φbiasa. The interlinkage magnetic flux of the B-phase concentrated winding 1C is expressed by φc−φbiasc. Furthermore, the interlinkage magnetic flux of the C-phase concentrated winding 1E is expressed by φc−φbiasc.

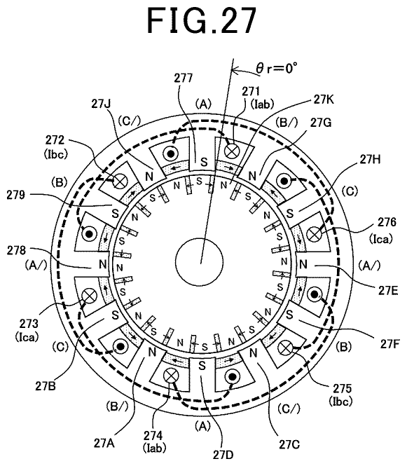

However, in this specification, equations (34), (35), and (36) are used in consideration of the relationships with the voltages generated by full-pitch windings, which will be detailed later. In other words, the relationship between FIG. 23, which shows the concentrated winding, and FIGS. 26 and 27, which show the full-pitch winding, is considered. In the case of the concentrated-winding structured motor shown in FIG. 1, the stator is not equipped with permanent magnets for inversely biased. Therefore, there is no bias magnetic flux and equations (34), (35), and (36) are valid.

FIG. 23 shows the A-phase magnetic flux φa [Wb] when the rotor rotation angle θr rotates counterclockwise from 0° to 30°, the current flowing through the A-phase winding 1A and the A/-phase winding 1D is a constant value Io, and the magnetic flux density in the air gap portion is a constant value Bo. Therefore, the following equation is obtained for the rotor rotation angle θr in the range from 0° to 30°.

$$φ a = Bo \cdot θ r \cdot Rr \cdot Lr \qquad ( 37 )$$

In FIG. 23, the rotor magnetic poles indicated by reference symbols such as 1H have a circumferential angle width of 30°. The permanent magnets indicated by reference symbols such as 231 have a circumferential width of 6°. Let the total number of turns of the two windings 1A and 1D be Nw. When the two windings are connected in series, the voltage Vak [V] at both ends is given by the following equation derived from Equation (34).

In the equation, ω is the angular velocity [rad/sec].

$$V ak = Nw \times d φ a / dt \qquad ( 38 )$$

$$= Nw \times d ( Bo \cdot θ r \cdot Rr \cdot Lr ) / dt \qquad ( 39 )$$

$$= Nw \times d ( Bo \cdot θ r \cdot Rr \cdot Lr ) / d θ r \cdot d θ r / dt$$

$$= Nw \times ( Bo \cdot Rr \cdot Lr ) \cdot ω \qquad ( 40 )$$

In this way, considering the 74 oregoing drive conditions, the A-phase voltage Vak in equation (40) becomes a voltage proportional to the magnetic flux density Bo [T] and the rotational angular velocity ω [rad/sec].

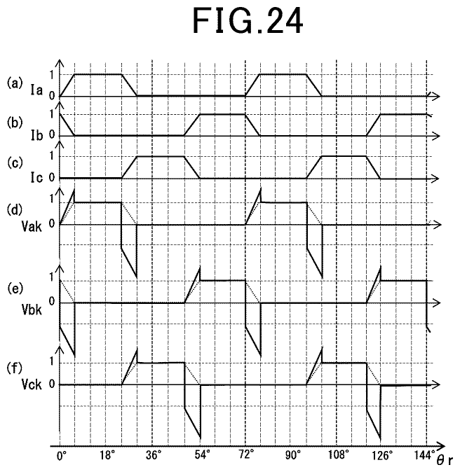

For this confutation, examples of currents and voltages obtained when the currents Ia, Ib, and Ic of each phase are set to the values indicated by the dashed lines in FIGS. 13(a), (b), and (c) are shown in FIG. 24. The magnetic flux density Bo in equation (40) is assumed to be 2.0 [T] or less, and the soft magnetic member is assumed not to be magnetically saturated in the characteristics shown in FIG. 6. FIG. 24(a) shows the A-phase current Ia, which is the current that flows in synchronization with the counterclockwise rotation from the state shown in FIG. 23, with an current amplitude normalized to 1.0. The A-phase current Ia increases as the rotor rotation angle θr increases in a range of from 0° to 6°, remains constant at 1.0 from in a range of 6° to 24°, decreases to 0 in a range of from 24° to 30°, and remains constant at 0 in a ranged of from 36° to 72°, thus repeating these values at a 72° cycle. The B-phase current Ib in FIG. 24(b) has the same current waveform as that of the A-phase current, but with a phase lag of 48°. The C-phase current Ic in FIG. 24(c) has the same current waveform as that of the A-phase current, but with a phase lag of 24°.

FIG. 24(d) shows an A-phase voltage Vak, corresponding to the values in equations (34) and (40). The A-phase voltage Vak rotates at a constant rotational speed from the state shown in FIG. 23 in the counterclockwise direction, and the voltage waveform synchronizes with the rotation. As the rotor rotation angle θr increases from 0° to 6°, the area where the stator S magnetic pole 11 and the rotor N magnetic pole 1H, which are opposed to each other, also increases. Concurrently, the A-phase current Ia in FIG. 24(a) also increases linearly. Thus, the A-phase magnetic fluxes pa interlinking both the A-phase concentrated winding 1A shown in FIG. 23 and the A-phase concentrated winding 1D increase quadratically. The A-phase voltage Vak becomes a linear function from equation (34) and increases linearly. When the rotor rotation angle θr is positioned between 6° and 24°, the A-phase current Ia remains constant, so that the voltage can be obtained on equation (40). When the rotor rotation angle θr is positioned between 24° and 30°, the area where the stator S magnetic pole 11 and the rotor N magnetic pole 1H which are opposed to each other increases, and simultaneously, the A-phase current Ia in FIG. 24(a) decreases linearly, resulting in that a large negative voltage is generated and a waveform shape shown in the figure is provided. This phenomenon occurs when torque generation and the regeneration of magnetic energy to the power source overlap with each other. Hence, in a range of from 36° to 72°, the value remains constant at 0, and these values repeat at a 72° cycle. The B-phase voltage Vbk in FIG. 24(e) has the same voltage waveform as that of the A-phase voltage Vak, but is phase lag by 48°. The C-PHASE voltage Vck in FIG. 24(f) has the same voltage waveform as that of the A-phase voltage Vak, but with a phase lag of 24°.

In row (d), (e), and (f) of FIG. 24, when the negative regenerative voltage increases, a problem occurs in which current control is restricted. If this negative voltage exceeds the power supply voltage of the driving circuit, the power supply voltage becomes a constraint, thus resulting in a longer regeneration time. In this case, negative torque may also occur, resulting in a decrease in the average torque. Alternatively, if the timing of current reduction is advanced, the positive torque generation time is shortened, thereby resulting in a decrease in average torque. Additionally, as the magnetic fluxes in each phase increase, the regenerative voltage increases. In FIG. 24, shortening the current reduction time increases the regenerative voltage. As the rotor speed increases, the regenerative voltage increases. One method to reduce this regenerative voltage issue is to constantly excite the previous stator magnetic pole, which will be explained in detail later. Additionally, the negative regenerative voltage in FIG. 24 occurs in the windings of other phases when the full-pitch windings are adopted, thus leading to a more significant issue. This phenomenon and its solution will be explained later.

In addition, in FIG. 24, an A-phase torque Ta [Nm] generated, in a range of 0° to 30° of the rotor rotation angle θr, in the A-phase and A/phase, is expressed by the following equation using equations (1) and (4).

$$Ta = V ak \cdot Io / ω \qquad ( 41 )$$

$$= Nw \times ( Bo \cdot Rr \cdot Lr ) \cdot ω \cdot Io / ω$$

$$= Nw \times ( Bo \cdot Rr \cdot Lr ) \cdot Io \qquad ( 42 )$$

As shown above, under the aforementioned drive conditions, it can be confirmed that the A-phase torque Ta [Nm] in equation (42) is proportional to the magnetic flux density Bo [T]. In particular, in the motor according to the present invention, a large magnetic flux density such as 4.0 [T] can be used in the vicinity of the maximum torque of the motor.

Additionally, the magnetic flux density Bo in equation (42) is also related to the current Io, i.e., the A-phase current Ia. In the region where the magnetic flux density shown in FIG. 6 is proportional to the current, the torque value in equation (42) is proportional to the square of the current value. As the magnetic flux density increases so as to approach 2.0 [T], the magnetic flux density near the air gap becomes larger. As a result, the magnetic resistance changes significantly, thus leading to a nonlinear torque characteristic with respect to the current Io. That is, since the relationship between the phase currents Ia, Ib, Ic and the magnetic flux density in each phase is nonlinear, it cannot be expressed by a simple equation. In any case, the torque T follows the value of equation (19) directed to the air gap portion.

Incidentally, the equations (1), (4), and (42) described above are assumed equations that ignore not only iron loss and copper loss but also the magnetic energy within the motor. Although these are assumed equations, clarifying the general qualitative relationships enables the resolution of the issue. As mentioned earlier, particularly in the motor according to the present invention, there is an issue regarding how magnetic energy is transferred between the inverter side and the motor side, which will be explained later in detail regarding magnetic energy and its transfer methods. The B-phase magnetic flux @b and B-phase torque Tb have the same relationships as those shown with FIG. 24, with a phase lag of 48° relative to the A-phase. The C-phase magnetic flux φc and C-phase torque Tc also have the same relationships as those shown with FIG. 24, with a phase lag of 24° relative to the A-phase.

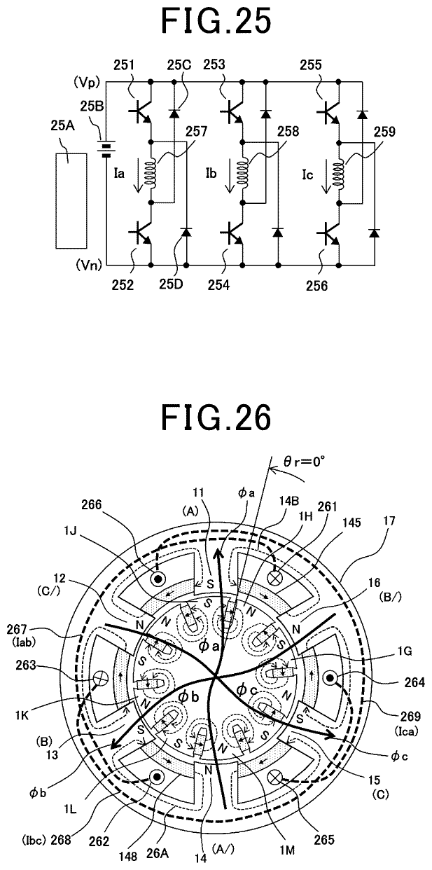

An example of a driving circuit that supplies each current to each winding shown in FIG. 23 will now be explained with FIG. 25. A reference number 25A indicates a motor control circuit. A reference number 25B indicates a DC power source that outputs a positive voltage Vp and a negative voltage Vn. A reference number 257 indicates a winding that connects the A-phase concentrated windings 1A and the A/-phase concentrated windings 1D in series. A reference number 251 indicates a transistor, with its collector connected to the positive voltage Vp and its emitter connected to one end of the winding 257. A regenerative diode is connected between the emitter of transistor 251 and the negative voltage Vn. A reference number 252 indicates a transistor whose collector is connected to the other end of winding 257 and whose emitter is connected to the negative voltage Vn. A regenerative diode is connected between the collector of transistor 252 and the positive voltage Vp. A reference number 258 indicates a winding that connects the B-phase concentrated windings 1C and the B/-phase concentrated windings 1F in series.

A reference number 253 indicates a transistor, with the collector connected to the positive voltage Vp and the emitter connected to one end of winding 258. A regenerative diode is connected between the emitter of transistor 253 and the negative voltage Vn. A reference number 254 indicates a transistor, with its collector connected to the other end of the aforementioned winding 258 and its emitter connected to the negative voltage Vn. A regenerative diode is connected between the collector of transistor 254 and the positive voltage Vp. A reference number 259 indicates a winding that connects the C-phase concentrated windings 1E and the C/-phase concentrated windings 1B in series. A reference number 255 indicates a transistor, with the collector connected to the positive voltage Vp and the emitter connected to one end of winding 259. A regenerative diode is connected between the emitter of transistor 255 and the negative voltage Vn. A reference number 256 indicates a transistor whose collector is connected to the other end of winding 259 and whose emitter is connected to the negative voltage Vn. A regenerative diode is connected between the collector of transistor 256 and the positive voltage Vp.

For example, the A-phase current Ia shown in (a) of FIG. 24 is controlled by a control including PWM control for the transistors 251 and 252, and is energized. For example, the trapezoidal B-PHASE current Ib shown in FIG. 24(b) is controlled by a control including PWM control of the transistors 253 and 254, and is energized. For example, the trapezoidal C-PHASE current Ic shown in FIG. 24(c) is controlled by a control including PWM control of the transistors 255 and 256, and is energized. As a general procedure for motor control, for example, a torque command Tc is obtained from a speed error obtained in speed control, a current amplitude Io corresponding to the torque command Tc is obtained, and then the phase currents Ia, Ib, and Ic, which are shown in FIG. 13 in accordance with the current amplitude Io, are energized in a controlled manner.

How magnetic energy is generated inside the motor shown in FIG. 23 will now be described. Generally, the density of magnetic energy Em in space [J/m³] is expressed by the following equation when a magnetic flux density is denoted as B [T] and a magnetic field strength is denoted as H [A/m].

$$Em = B \cdot H / 2 \qquad ( 43 )$$

For example, even with the same magnetic flux density, if a relative permeability of the soft magnetic member is large, a required magnetic field strength H [A/m] is small, and a magnetic energy Em in that portion is small. In areas such as the air gap portion where the relative permeability is approximately 1, which is small, the magnetic energy Em is large. In the motor according to the present invention, the air gap portion and its vicinity have a relatively higher magnetic flux density, thus resulting in the accumulation of large magnetic energy Em, which is repeatedly transferred between the motor and the inverter. As described above, as the rotation speed increases, issues related to magnetic energy regeneration arise. Additionally, when an attractive force generated between the stator and rotor changes abruptly, vibration and noise issues may arise. Examples of solutions will be explained later.

The utilization rate of the concentrated windings shown in figures such as FIG. 1, FIG. 14, FIG. 23 will now be described.

As shown in FIG. 24, an A-phase current Ia is applied to the concentrated winding 1A of the A-phase and the concentrated winding 1D of the A/-phase to drive the windings, and then similarly, currents are supplied to the windings of the B-phase and C-phase are to drive thereof, thus thereby rotating the rotor. In this drive, the period during which current is applied to each winding is approximately ⅓ of the total period, so that the utilization rate of the concentrated windings can be referred to be approximately ⅓. Due to the limited winding space in the motor, the thickness and number of turns of the windings are restricted. Furthermore, when the winding utilization rate is low, such as ⅓, the current which is three times larger must be applied compared to the case where the winding utilization rate is 3/3. Copper loss is 3²/3=3, resulting in a value three times larger. As such, improving the winding utilization rate is crucial for reducing copper loss, enhancing efficiency, and achieving motor miniaturization, lightweight design, and cost reduction. Methods for improving winding utilization rate will be explained later.

When the winding utilization rate is low, the utilization rate of the driving transistors also decreases. Furthermore, as the current value increases as described above, it is necessary to increase the current capacity of the transistors, which leads to problems such as the inverter becoming larger and increased costs. An example of a solution to this problem will be explained later. This includes issues about the number of stator and rotor magnetic poles of the motor configuration, the driving circuit configuration, and the current supply method.

10)

An embodiment of claim 4 is shown in FIG. 26. A motor shown in FIG. 26 is provided by replace the concentrated windings of each phase shown in FIG. 14 with full-pitch windings. The other motor configurations are the same. Reference numbers 261 and 262 show AB-phase windings. The AB-phase windings 261 and 262 are full-pitch windings with an electrical angle of 180°, which is half of the electrical angle of 360° of the stator single pole pair, and their coil ends are indicated by the thick dashed lines 267. An AB-phase current Iab is applied to the AB-phase windings.

In FIG. 14, the positive side winding portion of the concentrated winding of the A-phase winding 1A and the positive side winding portion of the concentrated winding of the B/-phase winding 1F are arranged in the same slot. The positive side winding portion 261 of the full-pitch winding of the AB-phase winding shown in FIG. 26 integrates the two windings. Also in FIG. 14, the negative side winding portion of the concentrated winding of the A/-phase winding 1D and the negative side winding portion of the concentrated winding of the B-phase winding 1C are arranged in the same slot. The negative side winding portion 262 of the full-pitch winding of the AB-phase winding in FIG. 26 integrates the two windings.

The AB-phase windings 261 and 262 shown in FIG. 26 each occupy a single slot, allowing the winding cross-sectional area to be doubled, thereby reducing the slot winding resistance to half that of the concentrated windings shown in FIG. 14. It is noted that the function of the AB-phase windings 261, 267, and 262 will be explained later. These windings are involved in both the operations of the A-phase stator S magnetic pole 11 and the A/-phase stator N magnetic pole 14, as well as the operations of the B-phase stator S magnetic pole 13 and the B/-phase stator N magnetic pole 16. In this way, such windings are referred to as AB-phase windings because the windings are involved in the electromagnetic operations of both the A-phase and B-phase.

Similarly, reference numbers 263 and 264 indicate BC-phase windings, with a winding pitch of 180° electrical angle, which is half of the electrical angle of 360° of the stator 1 pole pair, thus forming a full-pitch winding. The coil ends are indicated by thick dashed lines 268. BC-phase windings carry a BC-PHASE current Ibc. In FIG. 14, the positive side winding portions of the concentrated windings of the B-phase winding 1C and the C/-phase winding 1B are arranged in the same slot. The positive side winding portion of the full-pitch winding of the AB-phase winding 263 shown in FIG. 26 integrates the foregoing two windings. In FIG. 14, the negative side winding portion of the concentrated windings of the B/-phase winding 1F and the negative side winding portion of the concentrated windings of the C-phase winding 1E are arranged in the same slot. The positive side winding portion 264 of the full-pitch winding of the BC-phase winding shown in FIG. 26 integrates the foregoing two windings. The winding resistances of the BC-phase windings 263 and 264 shown in FIG. 26 are reduced to half of those of the concentrated windings shown in FIG. 14. It is noted that the BC-phase windings 263, 268, and 264 are involved in both the B-phase and C-phase electromagnetic operations, so that such full-pitch windings are referred to as the BC-phase windings.

Similarly, reference numbers 265 and 266 indicate CA-phase windings, with a winding pitch of 180° electrical angle, which is half of the electrical angle of 360° of the stator 1 pole pair, thus forming a full-pitch winding. The coil ends of these windings are indicated by thick dashed lines 269. CA-phase current Ica is applied to the CA-phase windings.

In FIG. 14, The positive side winding portion of the concentrated winding of the C-phase winding 1E and the positive side winding portion of the concentrated winding of the A/-phase winding 1D are arranged in the same slot. The positive side winding portion of the full-pitch winding of the CA-phase winding 265 shown in FIG. 26 integrates the foregoing two windings. In FIG. 14, the negative side winding portion of the C/-phase winding 1B and the negative side winding portion of the A-phase winding 1A are arranged in the same slot.

The positive side winding portion 266 of the full-pitch winding of the BC-phase winding shown in FIG. 26 integrates the foregoing two windings. The CA-phase windings 265 and 266 shown in FIG. 26 reduce the winding resistance to half that of the concentrated windings shown in FIG. 14. It is noted that the BC-phase windings 265, 269, and 266 are involved in the electromagnetic operations of both the C-phase and A-phase, so that the full-pitch windings are referred to as the CA-phase windings.

Relationships between the currents Iab, Ibc, and Ica supplied to the full-pitch windings of the motor in FIG. 26 and the currents Ia, Ib, and Ic supplied to the concentrated windings in FIG. 14 will now be described.

$$Iab = Ia + Ib \qquad ( 44 )$$

$$Ibc = Ib + Ic \qquad ( 45 )$$

$$Ica = Ic + Ia \qquad ( 46 )$$

Based on these relationships, when each phase current is applied, the same magnetomotive force acts on each part of the stator and rotor in the motor with full-pitch windings shown in FIG. 26 and the motor with concentrated windings shown in FIG. 23, resulting in the same torque generated on the rotor. The path and location where the magnetomotive force acts can be determined based on Ampère's circuit law for each current. Specifically, the magnetomotive force of each current acts on the portion of its path with the highest magnetic resistance, and a force is generated in the direction where the magnetic resistance decreases.

A relationship between voltage and magnetic flux caused in the full-pitch windings shown in FIG. 26. The number of turns in the full-pitch winding 261, which is exemplified for explanation, is set to the same Nw/2 [turn] as that of each of the A-phase concentrated windings shown in FIG. 23, such that the same conditions are true of the number of turns. As shown in FIG. 26, there are magnetic flux components from the permanent magnets, and each full-pitch winding wire is subject to interlinkage of magnetic fluxes φa, φb, and φc caused in each phase. As a result, the voltage becomes complex. The voltage Vab across the AB-phase windings 261, 267, and 262 is given by the following equation based on Faraday's law of electromagnetic induction.

$$V ab = Nw / 2 \times d ( φ a - φ biasb - φ biasb / + φ b - φ c ) / dt \qquad ( 47 )$$

In this equation, φbiasab is a magnetic flux component 14B that interlinks with the portion of winding 261 shown in FIG. 26 and is the magnetic flux component generated by permanent magnets 145. φbiasab/is a magnetic flux component 26A that interlinks with the portion of winding 262 shown in FIG. 26 and is the magnetic flux component generated by permanent magnets 148. It is now assumed that the values of the bias magnetic flux φbiasab and φbiasab/remain constant and unchanged, equation (47) can be simplified using the assumed value Vabk, similarly to the case where equation (34) is treated, resulting in the following equation.

$$V abk = Nw / 2 \times d ( φ a + φ b - φ c ) / dt \qquad ( 48 )$$

Similarly, the simplified voltage Vbck of the BC-phase windings 263, 268, and 264, and the simplified assumed voltage Vcak of the CA phase windings 265, 269, and 266 are given by the following equations.

$$V bck = Nw / 2 \times d ( - φ a + φ b + φ c ) / dt \qquad ( 49 )$$

$$V cak = Nw / 2 \times d ( φ a - φ b + φ c ) / dt \qquad ( 50 )$$

Furthermore, when expressed using Vak in (34), Vbk in (35), and Vck in (36), the following equation is obtained. The voltages of these full-pitch windings are complicated, which include the phase voltages Vak, Vbk, and Vck caused in the case of concentrated windings.

$$Vabk = ( Vak + Vbk - V ck ) / 2 \qquad ( 51 )$$

$$Vbck = ( - Vak + Vbk + V ck ) / 2 \qquad ( 52 )$$

$$Vcak = ( Vak - Vbk + V ck ) / 2 \qquad ( 53 )$$

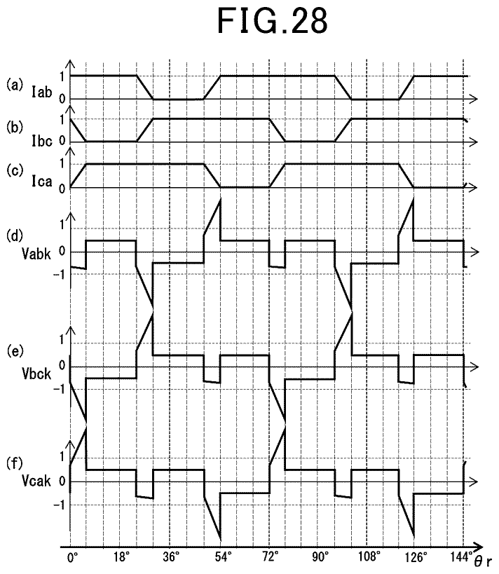

Examples of the current and voltage which drive the driving circuit shown in FIG. 25 by using Iab in equation (44), Ibc in equation (45), and Ica in equation (46) are explained with FIG. 28, including explanation of the issues thereof. When driving the motor shown in FIG. 26 using the driving circuit shown in FIG. 25, a winding 257 is regarded as being set as A-phase full-pitch windings 261, 267, and 262 shown in FIG. 26. Similarly, a winding 258 is regarded as being set as a B-phase full-pitch winding 263, and a winding 259 is regarded as being set as a C-phase full-pitch winding 265. Now, the same currents Ia, Ib, and Ic as those shown in FIG. 24 are applied to the full-pitch windings 261, 263, and 265 as Iab, Ibc, and Ica, respectively, according to the relationships provided by equations (44), (45), and (46). In this case, the same current [A turn] is applied to each slot of the motor equipped with the concentrated windings shown in FIG. 23 and the full-pitch winding motor shown in FIG. 26. Therefore, the stopping torque when the rotor is not rotating is the same.

FIG. 28 shows the currents Iab, Ibc, and Ica of the full-pitch winding in FIG. 26, which are related by equations (44), (45), and (46). This is a specific example of current supply, which can be created from FIGS. 24(a), (b), and (c). Additionally, the voltages Vabk, Vbck, and Vcak of the full-pitch windings shown in FIG. 26 are related by equations (51), (52), and (53), respectively. Therefore, for this example, the voltages can be plotted using FIGS. 24(d), (e), and (f), resulting in FIGS. 28(d), (e), and (f). As described above, with each full-pitch winding, the magnetic fluxes of all phases are interlinked, and voltages related to the magnetic fluxes of other phases are also generated. Conversely, the current in each full-pitch winding applies a magnetomotive force [A] to the magnetic circuit of all stator magnetic poles. Conventional three-phase sinusoidal AC full-pitch winding motors are often characterized by relatively simple equations based on linear theory using the three-phase AC theory. However, motors like those shown in FIG. 23 and FIG. 26 have stator magnetic poles arranged circumferentially in a discrete manner and are driven sequentially at each drive step. Therefore, it is necessary to consider the generated voltages and the magnetomotive forces acting on each individual operation.

It Is considered that the AB-phase voltage Vabk in FIG. 28(d), where the rotor rotation angle θr is 48° to 54°, corresponding to the current increase portion of the AB-phase current Iab in FIG. 28(a). In this region, a large voltage occurs in the AB-phase voltage Vabk shown in FIG. 28(d), making it difficult to increase the AB-phase current Iab. This increasing current component is a B-phase current Ib component within the AB-phase current Iab, as can be seen from FIG. 24(b). On the other hand, as shown in FIG. 24(f), this is the timing when the C-phase current Ic decreases, and also the magnetic energy accumulated in the C-phase magnetic circuit is regenerated back to the power source. This C-phase voltage component is superimposed on the AB-phase voltage Vabk in FIG. 28(d). This corresponds to the third term in the right-hand side of equation (51). The voltages of the other phases in FIG. 28 behave in a similar manner.

Here, there is an issue. When driving the full-pitch winding motor shown in FIG. 26 which uses the driving circuit shown in FIG. 25 in the manner illustrated in FIG. 28, there is a problem that it becomes difficult to increase the current once certain current values and rotational speeds are exceeded. This issue is related to the magnitude of the power supply voltage and arises when the voltage shown in FIG. 28 cannot be generated and supplied. For example, when the CA-phase current Ica in (c) of FIG. 28 supplies the current specified in equation (46) and the rotor rotation angle θr is in the range from 48° to 54°, the C-phase current Ic decreases. In this state, if the regenerative voltage reaches the power supply voltage Vsour, the Vck component of the CA-phase voltage Vcak in equation (53) becomes −Vsour, and simultaneously, the −Vck component of the AB-phase voltage Vabk in equation (51) becomes Vsour. As a result, the AB-phase winding induces a voltage equal to the power supply voltage Vsour, so that form the point where θr is 48°, the B-phase current component of the AB-phase current Iab in equation (44) can no longer increase. Additionally, at this time, the BC-phase current Ibc in equation (45) is flowing, causing the current balance in equations (44), (45), and (46) to be disrupted. As a result, the full-pitch windings shown in FIG. 26 becomes difficult to drive using the driving circuit shown in FIG. 25, thus leading to the state shown in FIG. 28.

It is now noted that there are several factors contributing to the high voltage and overvoltage shown in FIG. 28. One factor is that the voltage of the full-pitch winding is related to the magnetic flux changes in other phases, as shown in equations (51), (52), and (53). The second factor is that motors like those shown in FIG. 23 and FIG. 26 utilize the attractive force caused by the reluctance torque, thus causing repeated supply and regeneration of magnetic energy between the power source and the motor. The third factor is that in the motor shown in FIG. 26, the timing when the torque generation of the C-phase current ends coincides with the timing when other phases begin torque generation, thereby resulting in timing overlap. The motors shown in FIG. 23 and FIG. 26 are three-phase motors with the characteristics shown in FIG. 28. However, in multi-phase motors such as five-phase or seven-phase motors, behaviors of the foregoing magnetic flux changes, voltage, and supply and regeneration of magnetic energy become even more complicated.

The interlinkage magnetic flux and voltage with and across the full-pitch windings in FIG. 26 will now be considered. The following equations can be derived from equations (51), (52), and (53).

$$Vcak + Vabk = Vak \qquad ( 54 )$$

$$Vabk + Vbck = Vbk \qquad ( 55 )$$

$$Vbck + Vcak = Vck \qquad ( 56 )$$

The AB-phase windings 261 and BC-phase winding 265 shown in FIG. 26 both interlink with the A-phase magnetic flux φa, but they exhibit different interlinkages with respect to the B-phase magnetic flux φb and the C-phase magnetic flux φc. In other words, when the AB-phase winding 261 and the CA-phase winding 265 are connected in series in mutual reverse directions, only the A-phase magnetic flux component φa remains. The voltage changes caused by the magnetic flux variations of B-phase magnetic flux φb and C-phase magnetic flux pc are induced in the respective windings of AB-phase winding 261 and CA-phase winding 265, but these voltages are cancelled out. The sum of equations (51) and (53) equals equation (54). It is also the sum of equations (48) and (50). The same applies to other phases. The fact that the voltage of the complex and large full-pitch windings shown in FIG. 28 can be simplified to the single-phase voltages Vak, Vbk, and Vck by connecting two windings in series is a very important relationship. This demonstrates that the simplification of voltages results in the characteristics which are unaffected by the magnetic fluxes of other phases.

In addition, the current component flowing in series through the AB-phase winding 261 and the CA-phase winding 265 is the A-phase current component Ia, as derived from equations (44) and (46). When this A-phase current component Ia is applied in series to the AB-phase winding 261 and the CA-phase winding 265, it does not affect the B-phase magnetic flux φb and the C-phase magnetic flux qc. That is, as can be visually confirmed in FIG. 26, a magnetomotive force caused by the A-phase current component Ia does not act on the B-phase magnetic poles 13 and 16, as well as the C-phase magnetic poles 15 and 12, due to Ampère's circuit law. As a result, the series connection of the two full-pitch windings is not affected by the magnetic fluxes of other phases, and the series current component does not generate a magnetomotive force in other phases. FIG. 26 explains the case of three phases, but the same relationship applies to multi-phase systems such as five-phase, seven-phase, nine-phase, and eleven-phase motors, thus making this method effective. In particular, in multi-phase motors, where the voltage of the full-pitch windings becomes complicated for analysis, this method is still effective for accurately controlling the magnetic flux components for each phase.

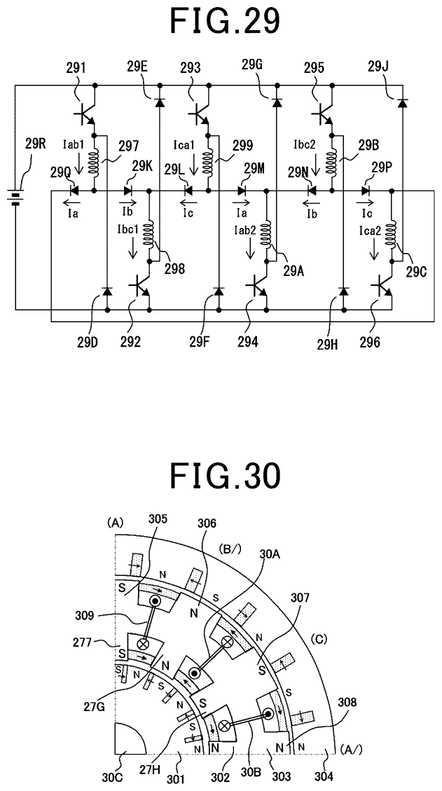

An example of a driving circuit that is not affected by changes in magnetic fluxes caused in other phases is shown in FIG. 29. The driving circuit in FIG. 29 can be controlled while maintaining the relationships explained by equations (44), (45), and (46) and equations (54), (55), and (56), and is a driving circuit with high drive efficiency and utilization. Furthermore, the driving circuit in FIG. 29 is configured by arranging two full-pitch windings of the same phase so as to keep the symmetry of the circuit configuration. FIG. 27 shows an example of configuring the motor in FIG. 26, which is provided with a stator with two magnetic pole pairs to obtain two full-pitch windings of the same phase. Reference numberers 271 and 274 indicate AB-phase windings, reference numberers 272 and 275 indicate BC-phase windings, and reference numberers 273 and 276 indicate CA-phase windings. The thick dashed lines indicate the coil ends of each winding and show the connection relationships and winding directions. Reference numberers 277 and 27D show A-phase stator S magnetic poles, and reference numberers 278 and 27E show A-phase stator N magnetic poles. Additionally, reference numberers 279 and 27F denote B-phase stator S magnetic poles, reference numberers 27A and 27G denote B-phase stator N magnetic poles, reference numberers 27B and 27H denote C-phase stator S magnetic poles, and reference numberers 27C and 27J denote C-phase stator N magnetic poles. Between the respective stator magnetic poles, a permanent magnet is arranged in accordance with their respective polarities. A reference number 27K indicates a rotor N magnetic pole, and, as the same way as FIG. 26, the rotor N magnetic pole positions at the starting point θr=0 among the rotor rotation angles. For clarity, the phase names and current names are shown in parentheses.

In FIG. 29, a reference number 29R indicates a DC voltage source. A reference number 291 indicates a transistor that drives an AB-phase current Iab1 to the AB-phase winding 297. A reference number 294 indicates a transistor that drives an AB-phase current Iab2 to the AB-phase winding 29A. The AB-phase windings 297 and 29A are the AB-phase windings 271 or 274 in FIG. 27. A reference number 292 indicates a transistor that drives a BC-phase current Ibc1 to the BC-phase winding 298. A reference number 295 indicates a transistor that drives a BC-phase current Ibc2 to the BC-phase winding 29B. The BC-phase windings 298 and 29B are BC-phase windings 272 or 275 in FIG. 27. A reference number 293 indicates a transistor that drives a CA-phase current Ica1 to the CA-phase winding 299. A reference number 296 indicates a transistor that drives a CA-phase current Ica2 to the CA-phase winding 29C. The CA-phase windings 299 and 29C are the CA-phase windings 273 or 276 shown in FIG. 27. Reference numbers 29D, 29E, 29F, 29G, 29H, and 29J indicate diodes that regenerate the energy in each winding to be regenerated to the DC voltage source 29R. Reference numbers 29K, 29L, 29M, 29N, 29P, and 29Q indicate diodes that reduce interference between voltages and currents in the left-right direction in the drawing paper of FIG. 29. Additionally, arrows indicating the directions of current flows and current names are added to clarify the circuit operations of FIG. 29.

The circuit operations in FIG. 29 are such that currents are supplied to respective phases as shown in FIGS. 28(a), (b), and (c), and the breakdown is given by the relationships in equations (44), (45), and (46). Therefore, the components Ia, Ib, and Ic shown in FIGS. 24 (a), (b), and (c) are supplied. The AB-phase current Iab1 passing through the AB-phase winding 297 is the sum of the A-phase current Ia and the B-phase current Ib, as shown in equation (44). Of these, the B-phase current Ib flows through the diode 29K to the BC-phase winding 298. Similarly, the AB-phase current Iab2 passing through the AB-phase winding 29A is the sum of the A-phase current Ia and the B-phase current Ib, as shown in equation (44). Of these, the B-phase current Ib is supplied to the BC-phase winding 29B through the diode 29N.

Furthermore, the BC-phase current Ibc1 passing through the BC-phase winding 298 is, as shown in equation (45), the sum of the B-phase current Ib and the C-phase current Ic. Of these, the C-phase current Ic flows through the diode 29L and is energized from the CA-phase winding 299. Similarly, the BC-phase current Ibc2 passing through the BC-phase winding 29B is the sum of the B-phase current Ib and the C-phase current Ic, as shown in equation (45). Of these, the C-phase current Ic flows through the diode 29P to the CA-phase winding 29C. Furthermore, the CA-phase current Ica1 passing through the CA-phase winding 299 is the sum of the C-phase current Ic and the A-phase current Ia, as shown in equation (46). Of these, the A-phase current Ia flows through diode 29M to the AB-phase winding 29A. Similarly, the CA-phase current Ica2 passing through the CA-phase winding 29C is the sum of the C-phase current Ic and the A-phase current Ia, as shown in equation (46). Of these, the A-phase current Ia flows through diode 29Q and into the AB-phase winding 297.

In this state, the voltage of each full-pitch winding in FIG. 29 becomes the voltage shown in (d), (e), and (f) of FIG. 28. This is in accordance with equations (51), (52), and (53), and includes the voltages shown in (d), (e), and (f) of FIG. 24, thus resulting in a large and complicated voltage. However, in the drawing paper of FIG. 29, the voltage from the upper end of the AB-phase winding 297 to the lower end of the BC-phase winding 298 becomes the B-phase voltage Vbk shown in (e) of FIG. 24, thus resulting in a relatively simple voltage. Similarly, the voltages across both ends of the other two windings connected in series become the A-phase voltage Vak and the C-phase voltage Vck.

For example, when the B-phase current Ib increases, the B-phase voltage Vbk generated during the rotor rotation angle θr between 48° and 54° is equal to the Vbk calculated by equation (35) due to the increase in the B-phase magnetic flux φb. Therefore, when the B-phase current Ib between the transistors 291 and 292 increases, for example, by turning the transistor 291 on and also turning the transistor 292 on, the B-phase current Ib can be increased within a range permitted by the power supply voltage. Additionally, when the rotor rotation angle θr is between 72° and 78°, as shown in FIG. 24(a) 30 and (b), the B-phase current Ib decreases from 1 to 0, while the A-phase current Ia increases from 0 to 1. In this case, for example, the transistor 292 is turned off to allow the B-phase current Ib to regenerate through the diode 29E to the DC voltage source 29R, and simultaneously the transistor 296 is turned on. Assuming that the 35 transistor 291 is operated in a PWM control mode where the transistor is repeatedly turned on and off, when the transistor 291 is turned on, the A-phase current Ia increases through the diode 29Q, and the B-phase current Ib is regenerated to the power supply and decreases. When the transistor 291 is tuned off, the B-phase current Ib regenerates through the diodes 29D and 29E and decreases, while the A-phase current Ia continues to increase during this operation.

In practice, since the transistors 291, 292, and 296 each perform PWM control, if the corresponding current is smaller than a command value, the on-state is increased, and if it is larger than the command value, the off-state is increased, thereby performing PWM control to achieve in a precise control. In FIG. 29, the voltages across the ends of the two full-pitch windings arranged in series are related by equations (54), (55), and (56), thus enabling control of the phase current components Ia, Ib, and Ic. The currents in FIG. 29 are DC currents, so that each transistor can control a single DC current through PWM control. If the value of the current flowing through the transistor can be detected, it can be increased or decreased to the appropriate value. DC-current PWM control is simpler in circuit configuration and easier to be implemented, compared to AC-current PWM control.

Additionally, as described above, diodes 29K, 29L, 29M, 29N, 29P, and 29Q reduce voltage and current interference between the left and right sides as shown in FIG. 29. However, each current can be PWM-controlled by the corresponding transistor, and this is not necessarily required. Furthermore, as shown in FIG. 29, in the DC current control of each full-pitch winding, the value of the corresponding current can be relatively easily controlled using PWM control of each transistor, and the direction of current flow can also be easily selected or split depending on the design of the driving circuit. These functions of the DC current driving circuit are significantly simpler compared to AC current control and constitute a major feature.

The utilization rate of each full-pitch winding will be explained provided when the motor shown in FIG. 27, which has a 6S10R full-pitch winding and two magnetic pole pairs as the stator, is driven by the driving circuit shown in FIG. 29. As described earlier, following Equations (54), (55), and (56), examples of applying current to each phase as shown in FIGS. 24(a), (b), and (c), and FIGS. 28(a), (b), and (c) are illustrated. For example, the A-phase current Ia component flows through the transistor 291, the AB-phase full-pitch winding 297, the CA-phase full-pitch winding 29C, and the transistor 296 in FIG. 29. On the other hand, the current flows through the transistor 293, the CA-phase full-pitch winding 299, the AB-phase full-pitch winding 29A, and the transistor 294 in FIG. 29. In this state, four of the six full-pitch windings of the motor in FIG. 27 are energized to generate torque. The utilization rate of these full-pitch windings is 2/3. The same applies when energizing the components of the B-phase current Ib and the C-phase current Ic. Compared to the motor with concentrated windings shown in FIG. 23, where the winding utilization rate is 1/3 when being energized as shown in FIG. 25 and FIGS. 24(a), (b), and (c), the winding utilization rate is improved to twice that in the motors with full-pitch windings shown in FIG. 27, FIG. 29, and FIG. 28. Improving the winding utilization rate by a factor of two and reducing the resistance value within the slots of the full-pitch winding to one-half are inversely related. As a result, the copper loss of the motor can be reduced by a factor of two.

The utilization rate of each transistor in the driving circuit shown in FIG. 29 will now be described. As shown in FIG. 29, transistors such as transistors 291 and 292 are connected to each full-pitch winding and control the current of each winding using PWM control. Therefore, the utilization rate of each transistor is the same as that of each winding, which is 2/3. Compared to the driving of the concentrated windings shown in FIG. 23, FIG. 25, and FIG. 24, the utilization rate of each transistor is doubled. When the utilization rate of each transistor doubles, the current capacity of the transistors can be reduced to half, thus enabling the miniaturization and cost reduction of the driving circuit. Conventional surface magnet-type synchronous motors (SPMSM) and magnet-embedded synchronous motors (IPMSM) operate using three-phase sinusoidal AC drive. The utilization rate of these transistors, calculated using the foregoing method, is one-third. Therefore, in the motors with the full-pitch windings shown in FIG. 27, FIG. 29, and FIG. 28, the utilization rate of each transistor can be improved to twice that of the driving circuits of conventional SPMSMs and IPMSMs, thereby achieving a smaller driving circuit and lower cost even compared to these conventional designs. FIG. 26 and FIG. 27 are examples of a 3-phase 6S10R and a 12S20R with two stator pole pairs, respectively. However, further improvements in winding utilization and transistor utilization can be achieved through multi-phasing. Examples of a 5-phase 10S18R and a 7-phase 14S26R will be explained later.

As shown above, the effects of the drive mechanisms illustrated in FIG. 27, FIG. 29, and FIG. 28 address the following issues: the difficulty of conducting current due to excessive voltage in other phases of the full-pitch windings, the high copper loss in the motor with concentrated windings as shown in FIG. 23, and the low utilization rate of the driving circuit in FIG. 25, which leads to increased current capacity and results in a larger and more expensive driving circuit. Specifically, this enables current flow to the full-pitch winding, reduces motor copper loss by half, and halves the current capacity of the driving circuit, leading to miniaturization and cost reduction.

On the other hand, the motors with full-pitch windings shown in FIG. 26 and FIG. 27 have longer coil ends, which increases the amount of wire material used and leads to higher copper losses and costs. Additionally, there are issues such as poor winding manufacturability, a tendency for the winding fill factor to decrease, and a tendency for the rotor shaft-direction lengths of the coil ends to increase, leading to larger motor sizes. However, these issues can be improved through production technology. One method to shorten the coil end length is to increase the number of pole pairs. Compared to FIG. 26, FIG. 27 shows that the coil end length is halved by adopting a two-pole configuration for the stator. Furthermore, further shortening is possible by adopting a three-pole or four-pole configuration.

Additionally, the motor is configured as a composite motor with two motors incorporated on the inner diameter side and outer diameter side. The full-pitch windings of each phase are wound in a toroidal shape serving as ring-shaped windings, thus enabling the length of the coil end portion to be minimized. The motor in FIG. 30 is a composite motor that adds another motor on the outer diameter side to ¼ portion of the first quadrant in FIG. 27. A reference number 301 indicates a first rotor on the inner diameter side, and a reference number 302 indicates the first stator on the inner diameter side, with the same configuration as that shown in FIG. 27. A reference number 30C indicates a rotor shaft of the first rotor 301. A reference number 303 indicates a second stator on the outer diameter side, and a reference number 304 indicates a second rotor on the outer diameter side, thus forming the outer rotor motor configuration. The first rotor 301 and the second rotor 304 are mechanically connected. A reference number 305 indicates an A-phase stator S magnetic pole, a reference number 306 indicates a B-phase stator N magnetic pole, a reference number 307 indicates a C-phase stator S magnetic pole, and a reference number 308 indicates an A/-phase stator N magnetic pole. A reference number 309 indicates an AB-phase ring-shaped winding wound in a toroidal shape. The coil end length is the shortest, and this winding can be wound in an aligned manner while tension being applied, thus enabling a high winding fill factor and good productivity. A reference number 30A indicates a BC-phase ring winding, which is a similar ring winding. A reference number 30B indicates a CA-phase ring winding, which is a similar ring winding.

FIG. 30 is a figure showing the ring-shaped windings 309, 30A, and 30B of the motor, which are described above, and it is necessary to optimize the shapes of each part, including the number of pole pairs. In addition, the combination of two motors can be configured as an axial gap type motor configuration, in which the motors shown in FIG. 30 are arranged in the rotor axis direction. In this case, the annular winding configuration can also be adopted, thus allowing the coil end length to be shortened. Furthermore, in the case of composite configuration in the rotor axis direction, the circumferential length does not change as shown in the motor of FIG. 30, making it easier to achieve a motor with balanced shape. Furthermore, in the motor configuration shown in FIG. 27, if the stack thickness of the stator core In the rotor axis direction Is smaller than the coil end length, and the motor core has a flat shape, adopting a ring-shaped winding structure results in a shorter total wire length. Conversely, in the case of a motor with a slender shape, the load on the coil end length is relatively small. Furthermore, when two annular windings located at positions corresponding to half of the electrical angle 180° of the stator electrical angle 360° electrical angle are connected in series, the interlinkage magnetic fluxes become the same as those of full-pitch windings, thereby forming electrically equivalent windings.

Additionally, in the motors with full-pitch windings shown in FIG. 26 and FIG. 27, the use of each stator magnetic pole is concentrated on 2 out of 6 stator magnetic poles. Since the current flowing through ⅔ of the windings concentrates the magnetomotive force on ⅓ of the stator magnetic poles, a large magnetomotive force can be applied to a specific area. To achieve a magnetic flux of 2.0 [T] or higher, the relative permeability of the specific area decreases to near 1, making this motor configuration advantageous for concentrating the magnetomotive force. Additionally, as explained in FIGS. 16, 17, 18, and 19, the magnetic flux φasses through the six teeth of the six stator magnetic poles, and in the air gap portion, the magnetic flux is concentrated on two stator magnetic poles to generate torque. Therefore, it can be said that the motor generates torque using most of its structure.

Additionally, an example of using the driving circuit shown in FIG. 29 with motors having various stator magnetic pole pairs is explained.

In the case of a motor with a single-pole pair full-pitch winding as shown in FIG. 26, to obtain two windings per phase, two windings per phase are arranged in each slot to form six windings, which can be driven by the driving circuit shown in FIG. 29. For a motor with a 3-pole pair full-pitch winding, the windings of one pole pair are divided into two winding groups, and each phase winding is connected to 1.5 windings, creating a total of six phase windings, which can be used with the driving circuit shown in FIG. 29. In a 4-pole pair full-pitch winding motor, since there are four windings per phase, two windings are connected in series, resulting in a total of six windings, which can be driven using the driving circuit shown in FIG. 29. Similarly, the driving circuit shown in FIG. 29 can be used even if the number of pole pairs changes. Conversely, the driving circuit in FIG. 29 can be modified according to the number of pole pairs. Examples of driving circuits for motors with full-pitch windings different from FIG. 29, such as those in FIG. 26 and FIG. 27, as well as driving circuits for multi-phase motors such as 5-phase and 7-phase motors, will be explained later. Later, motors with multi-phase configurations such as 5-phase and 7-phase are explained, where the stator magnetic poles are arranged circumferentially in at equal intervals and motors where the stator magnetic poles are arranged circumferentially at unequal intervals. Additionally, regarding magnetic energy regeneration methods, a method where the field current component is continuously supplied at high speeds to reduce the winding voltage will be explained. Furthermore, as the number of pole pairs increases, the cross-sectional length of the permanent magnets in the stator decreases circumferentially, thus approaching a parallelogram shape and becoming closer to a practical configuration. This facilitates the design, manufacturing, and secure mounting of the permanent magnets.

An embodiment according to claim 5 will now be described.

The present invention is not limited to a specific number Nps of stator magnetic poles Ps and a specific number Npr of rotor magnetic poles Pr, but provides good characteristics with such a specific configuration. Claim 5 relates to a motor in which multiple rotor magnetic poles are circumferentially arranged at equal intervals, and stator magnetic poles are also circumferentially arranged at equal intervals. When the numbers Ns and Nr are integers greater than or equal to 1, the number Nps of stator magnetic poles Ps and the number Npr of rotor magnetic poles Pr are related by the following equation.

$$Nps = 2 + 4 \times Ns \qquad ( 57 )$$

$$Npr = 2 + 4 \times N r \qquad ( 58 )$$

One example is the 6S10R motor, a three-phase motor shown in FIG. 1, FIG. 14, FIG. 26, FIG. 27, and other figures. Other excellent configurations, such as 14S26R and 10S18R, will be explained later. The number of stator magnetic pole pairs can be increased to 2, 3, or 4. All of these have a magnetically point-symmetric configuration with respect to the rotor center point. The stator windings are full-pitch windings, thus allowing for optimal utilization of each winding, transistor utilization in the driving circuit, maximum torque, and other parameters. Concentrated windings can also be configured in the similar manner as the above.

Additionally, when the number of stator magnetic pole pairs is multiple, some of the harmonic components of torque, i.e., torque ripples, can be canceled out. To achieve this, some of the stator magnetic poles can be shifted circumferentially from their previously evenly spaced configuration. Furthermore, in a motor configuration with concentrated windings, a space can be provided circumferentially around the stator magnetic poles. The total width of the circumferential spaces can be set to twice the pitch θppr of the rotor magnetic poles Pr or an integer multiple thereof. In this case, the space can be secured within the stator without significantly altering the motor basic characteristics. For example, this enables rotor position detection, rotor state monitoring, and operation control.

As an example according to claim 5, there is a motor 6S10R with full-pitch windings, as shown in FIG. 26, FIG. 27, and other figures, and also a three-phase motor. These motors satisfy the conditions required by equations (57) and (58). A relatively simple example of the motor according to the present invention has been described in detail. As previously explained, the driving circuit shown in FIG. 29 enables electrical drive in the same manner as described with FIG. 12, FIG. 13, and FIG. 28, thereby resolving the issue where the winding-induced voltage becomes excessively high and electrical drive becomes impossible. This configuration demonstrates that the utilization rate of the windings and each transistor can be reduced to approximately 2/3, but that the maximum torque can be increased.

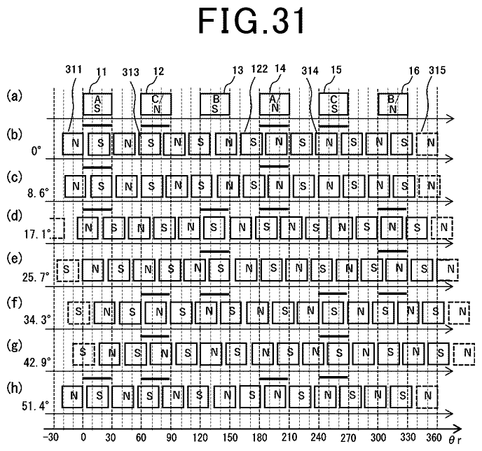

As another example, a linearly developed view showing the operation of the 6S14R motor is shown in FIG. 31. This is an example of increasing the number of magnetic poles of the rotor of type 6S10R shown in FIG. 1, FIG. 14, FIG. 26, and FIG. 27, from 10 to 14. The stator is structured in the same way as that shown in FIG. 26. Since there are 14 rotor magnetic poles, the rotor magnetic pole pitch is 25.7°, and the operating cycle is doubled to 51.4°, as shown in (a) to (h) of FIG. 31. Using the same display method as the unfolded view in the preceding FIG. 12, the shapes of the stator magnetic poles facing the air gap surface and the rotor magnetic poles are shown, thus enabling analysis of the mutual magnetic fluxes and electromagnetic interactions. Specifically, this is a linearly developed view aimed at creating a region where counterclockwise (CCW) torque is generated. The horizontal axis of FIG. 31 represents a rotor rotation angle θr, with the right direction corresponding to the CCW direction. FIG. 31 displays a rotor rotation angle from −30° to 360°. At the top of each row, the intervals where the CCW torque generation is possible are indicated by thick lines above the rotor magnetic pole shapes. The position and width of the thick lines correspond to the position and width of the corresponding stator magnetic poles.

FIG. 31(a) shows the shape of each stator magnetic pole facing the air gap surface. FIG. 31(b) shows the rotor rotation position θr=0°, which is the starting point of rotor rotation. In FIG. 31, the left side position of the A-phase stator S magnetic pole 11 coincides with the right side position of the rotor N magnetic pole 311. At this position, the A-phase stator S magnetic pole 11, the A/-phase stator N magnetic pole 14, the C/-phase stator N magnetic pole 12, and the C-phase stator S magnetic pole 15 can generate an attractive force in the counterclockwise (CCW) direction, as indicated by the thick lines at the top of FIG. 31(b). FIG. 31(c) shows a rotor rotation position θr=8.6°, where the C/-phase stator N magnetic pole 12 and the C-phase stator S magnetic pole 15 can no longer generate an attractive force in the CCW direction. FIG. 31(d) shows a rotor rotation position θr=17.1°, where the B-phase stator S magnetic pole 13 and the B/-phase stator N magnetic pole 16 begin to generate an attractive force in the CCW direction. FIG. 31(e) shows a rotor rotation position θr=25.7°, where the A-phase stator S magnetic pole 11 and the A/-phase stator N magnetic pole 14 can no longer generate an attractive force in the CCW direction. FIG. 31(f) shows that at θr=34.3°, the C/-phase stator N magnetic pole 12 and the C-phase stator S magnetic pole 15 begin to generate an attractive force in the counterclockwise (CCW) direction. FIG. 31(g) shows that at θr=42.9°, the B-phase stator S magnetic pole 13 and the B/-phase stator N magnetic pole 16 can no longer generate an attractive force in the counterclockwise (CCW) direction. FIG. 31(h) shows that at θr=51.4°, the state returns to the same state as FIG. 31(b). The motor in FIG. 31 operates at a 51.4° cycle, repeating the same operations seven times to complete one rotation of the rotor.

As such, the 6S14R motor shown in FIG. 31 can generate torque using two or more stator magnetic poles simultaneously, similar to the 6S10R motor shown in FIG. 26. The driving circuit can drive the 6S14R motor shown in FIG. 31 as a motor with two stator magnetic pole pairs, similarly to the motor shown in FIG. 27, using the driving circuit shown in FIG. 29.

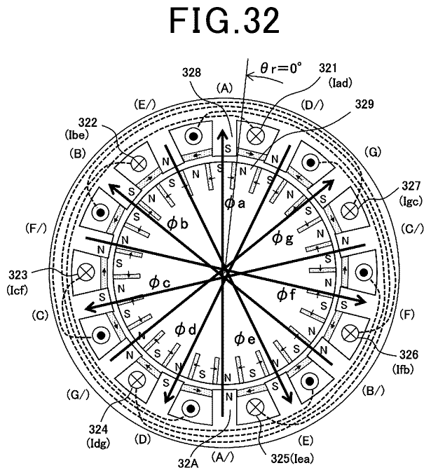

As another example, a cross-sectional view of the motor configuration with a full-pitch windings, which is 14S26R, is shown in FIG. 32. This is an example where Ns is 3 in equation (57) and Nr is 6 in equation (58). The basic electromagnetic operations described so far have been explained using three-phase motors such as FIG. 1, FIG. 14, FIG. 26, and FIG. 27. However, the motor of the present invention can be extended to multi-phase motors by applying the same technology. Claim 5 can be extended to multi-phase motors such as three-phase, five-phase, seven-phase, nine-phase, and eleven-phase motors. FIG. 32 shows a 7-phase motor with 14 stator magnetic poles and 26 rotor magnetic poles. Multiphase configurations such as 7-phase can improve efficiency, thus enabling miniaturization of the motor, and enhance quality, and these possibilities will be explained in detail below.

In FIG. 32, a reference number 328 indicates an A-phase stator S magnetic pole, and a reference number 32A indicates an A/phase stator N magnetic pole. The A-phase magnetic flux φa shown in the figure passes from the A/phase stator N magnetic pole 32A through the rotor to the A-phase stator S magnetic pole 328. Similarly to the relationships between the A phase, A/phase, and A-phase magnetic flux φa, the stator magnetic poles for each phase are arranged in the counterclockwise direction. The phase of each stator magnetic pole is indicated by brackets on the outer periphery of the stator, and the magnetic flux component of that phase is shown. There are also shown relationships of the B-phase, B/-phase, and B-phase magnetic flux φb; C-phase, C/-phase, and C-phase magnetic flux φφc; D-phase, D/-phase, and D-phase magnetic flux φd; E-phase, E/-phase, and E-phase magnetic flux φe; F-phase, F/-phase, and F-phase magnetic flux φf; and G-phase, G/-phase, and G-phase magnetic flux φg.

FIG. 32 shows that a winding 321 is an AD-phase winding with full-pitch windings wound around slots separated by 180°, and an AD-phase current Iad is applied thereto.

The slots are connected at the coil ends, and the connection is indicated by dashed lines shown in FIG. 32. Similarly, a winding 322 is a BE-phase winding with a BE-phase current Ibe applied, a winding 323 is a CF-phase winding with a CF-phase current Icf applied, a winding 324 is a DG-phase winding with a DG-phase current Idg applied, a winding 325 is a EA-phase winding with an EA-phase current Iea applied, a winding 326 is an FB-phase winding with an FB-phase current Ifb applied, and a winding 327 is a GC-phase winding with a GC-phase current Igc applied.

The currents Iad, Iea, Ibe, Ifb, Icf, Igc, and Idg of the 7-phase full-pitch windings are the A-phase current Ia, B-phase current Ib, C-phase current Ic, D-phase current Id, E-phase current Ie, F-phase current If, and G-phase current Ig, and are defined by the following equations.

$$Iad = I a + Id \qquad ( 59 )$$

$$Ibe = Ib + Ie \qquad ( 60 )$$

$$Icf = Ic + If \qquad ( 61 )$$

$$Idg = Id + Ig \qquad ( 62 )$$

$$Iea = Ie + Ia \qquad ( 63 )$$

$$Ifb = If + Ib \qquad ( 64 )$$

$$Igc = Ig + Ic \qquad ( 65 )$$

All currents are direct currents with positive values. The phase currents can be calculated from the full-pitch winding currents. Conversely, the phase currents can also be calculated from the full-pitch winding currents. The values on both sides can be converted to each other.

For example, a component of the A-phase current Ia is energized as an AD-phase current Iab in equation (59) for the AD-phase winding 321, which is the full-pitch winding in FIG. 32. At the same time, a component of the A-phase current Ia is energized as an EA-phase current Iea in equation (63) for EA-phase winding 325. This excitation is applied to the A-phase magnetic flux φa in FIG. 32. This excitation is the same as the configuration illustrated in FIG. 32 for a motor with full-pitch winding, with the following modifications. In other words, the full-pitch winding motor shown in FIG. 32 is changed to a motor with concentrated windings. In addition, the concentrated windings are wound as A-phase stator magnetic pole 328 and A/-phase stator magnetic pole 32A. In addition, the A-phase current Ia is energized in these concentrated windings. This winding configuration can also be magnetically excited with the same magnetic flux as the A-phase magnetic flux φa in the full-pitch winding shown in FIG. 32. The same is true for the other phases.

Also, although this is a bit redundant, for example, when the AD phase current Iab is applied to the AD phase winding 321 in FIG. 32, the law of the circumferential integration of amperes comes into play. Due to a magnetomotive force generated by this law, the current Iab due to the magnetomotive force is applied to all stator magnetic poles and all rotors in FIG. 32. Each phase current mutually affects the entire motor. As described above, a component of the A-phase current Ia is energized as the AD-phase current Iab, and at the same time, a component of the A-phase current Ia is energized as the EA-phase current Iea. This cancels the magnetomotive force on the magnetic flux components from the other phases, with the result that the magnetic flux components of the other phases other than the A-phase magnetic flux φa are not affected. Therefore, to control the magnetic flux for each phase shown in FIG. 32, it is necessary to energize each full-pitch winding with the currents based on Equations (59) to (65).

On the other hand, the magnetic flux components φa, φb, φc, φd, φe, φf, and φg of all phases shown in FIG. 32 interlink all full-pitch windings, respectively. Therefore, according to Faraday's law of electromagnetic induction, each voltage is induced in each full-pitch winding, and the relationships are as follows. The number of full-pitch winding turns is Nw/2, and the expressions are the same as those in equations (48), (49), and (50) above for the three phases.

$$( 66 )$$

$$\begin{matrix}Vadk & = Nw / 2 \times d ( φ a + φ b + φ c + φ d − φ e − φ f − φ g ) / dt =\end{matrix} Vak + Vbk + Vck + Vdk − V e k − Vfk − Vgk$$

$$( 67 )$$

$$Vbek = Nw / 2 \times d ( − φ a + φ b + φ c + φ d + φ e − φ f − φ g ) / dt = − Vak + Vbk + Vck + Vdk + Vek − Vfk − Vgk$$

$$( 68 )$$

$$Vcfk = Nw / 2 \times d ( − φ a − φ b + φ c + φ d + φ e + φ f − φ g ) / dt = − Vak − V b k + Vck + Vdk + V e k + Vfk − Vgk$$

$$( 69 )$$

$$Vdgk = Nw / 2 \times d ( − φ a − φ b − φ c + φ d + φ e + φ f + φ g ) / dt = − Vak − V b k − V c k + V d k + V e k + V f k + V g k$$

$$( 70 )$$

$$Veak = Nw / 2 \times d ( φ a − φ b − φ c − φ d + φ e + φ f + φg ) / dt = Vak − Vbk − Vck − Vdk + Vek + Vfk + Vgk$$

$$( 71 )$$

$$Vfbk = Nw / 2 \times d ( φ a + φ b − φ c − φ d − φ e + φ f + φ g ) / dt = Vak − Vbk − Vck − Vdk + Vek + Vfk + Vgk$$

$$( 72 )$$

$$Vgck = Nw / 2 \times d ( φ a + φ b + φ c − φ d − φ e − φ f + φ g ) / dt = Vak + V b k + Vck − Vdk − V e k − Vfk + Vgk$$

Each of the full-pitch windings is thus a complex voltage affected by the multiphase magnetic flux. However, the voltage relationships for the full-pitch windings can be simplified by using the following equation.

$$Vadk + Veak = Nw / 2 \times d ( 2 \times φ a ) = Vak \qquad ( 73 )$$

$$Veak + Vbek = Nw / 2 \times d ( 2 \times φ e ) = Vek \qquad ( 74 )$$

$$Vbek + Vfbk = Nw / 2 \times d ( 2 \times φ b ) = Vbk \qquad ( 75 )$$

$$Vfbk + Vcfk = Nw / 2 \times d ( 2 \times φ f ) = Vfk \qquad ( 76 )$$

$$Vcfk + Vgck = Nw / 2 \times d ( 2 \times φ c ) = Vck \qquad ( 77 )$$

$$Vgck + Vdgk = Nw / 2 \times d ( 2 \times φ g ) = Vgk \qquad ( 78 )$$

$$Vdgk + Vadk = Nw / 2 \times d ( 2 \times φ d ) = Vdk \qquad ( 79 )$$

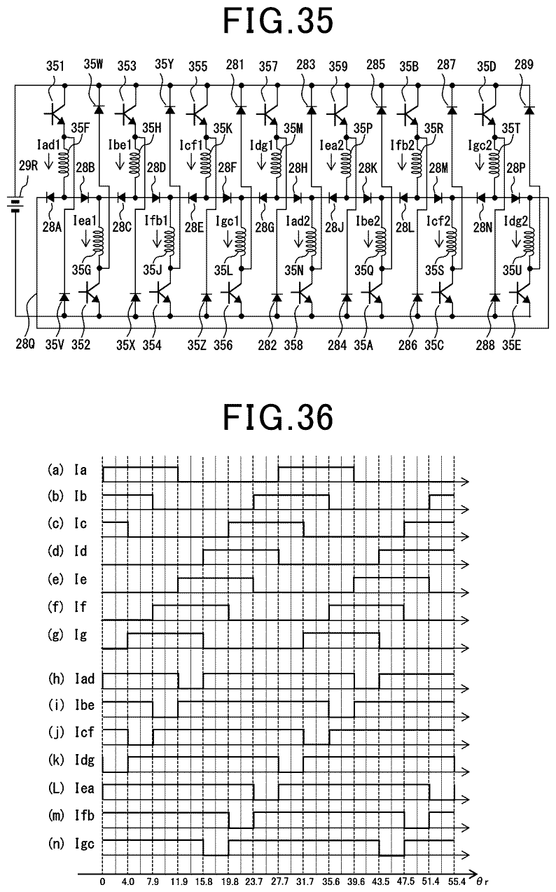

As described above, according to Ampere's law of circular integration, a component of A-phase current Ia is energized as the AD-phase current Iab in equation (59) of the AD-phase winding 321 in FIG. 32. At the same time, a component of A-phase current Ia is energized as EA-phase current Iea in equation (63) of EA-phase winding 325. As a result, the A-phase magnetic flux φa in FIG. 32 is excited, while the components of the A-phase current Ia of both windings does not affect the magnetic flux components of the other phases. Equation (73) is the inverse of this, and according to Faraday's law of electromagnetic induction, the sum of the AD-phase voltage Vadk and the EA-phase voltage Veak is related only to the A-phase magnetic flux φa and the A-phase voltage Vak, and is not affected by the magnetic flux from the other phase. Equations (74) through (79) are similarly related. These relationships are also related to the motor configuration that is point symmetrical with respect to the rotor center. There are also control methods that apply these simplified voltage methods and are less affected by the voltages of many other phases, which will be explained later with reference to FIG. 35 and other figures.

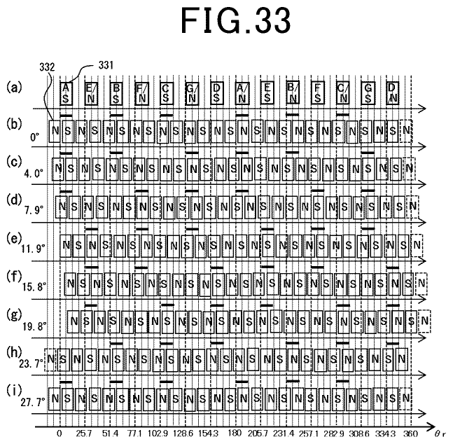

FIG. 33 shows a linearly developed view of the 14S26R motor in FIG. 32, which shows the operation of the motor generating torque in the CCW direction. The shape of the stator magnetic pole facing the air gap and the shape of the rotor magnetic poles are shown, so that the mutual passing magnetic fluxes and electromagnetic actions can be analyzed. The rotor rotation angle is θr=0°, and the CCW direction of the motor is the right direction in FIG. 33. In each row in FIG. 33, a section where a CCW torque generation is possible is indicated by a bold line on the upper side of the rotor magnetic poles geometry. In this case, the position and width of the bold line is the position and width of the corresponding stator magnetic pole. In FIG. 33, the width of the stator magnetic pole is φsg=360°/28=12.857°. The width of the rotor magnetic pole, θrg, can be less than 360°/26=13.846°, but θrg=θsg=12.857° is realized. The stator magnetic pole width θsg and the rotor magnetic poles width θrg can be increased or decreased to suit the motor requirements, and the pole shape can also be changed.

A row (a) in FIG. 33 shows the shape of each stator magnetic pole facing the air gap plane. A reference number 331 corresponds to the A-phase stator S magnetic pole 328 shown in FIG. 32. Each stator magnetic pole in the CCW direction, which is shown in FIG. 32, is placed in the order in the right direction in (a) of FIG. 33. The horizontal axis Or in FIG. 33 shows, though a little confusing, the electrical angle position, which is 360° of the electrical angle of one stator magnetic pole pair, and is also the electrical angle position in the direction of rotation of each stator part. The rotational position of the rotor is shown on the left side of each row in FIG. 33. In the drawing paper of FIG. 33, (b), (c), (d), and (e) thereof, each part of the rotor is moved to the right. The row (b) in FIG. 33 shows the starting point of the rotor rotation, which is at the rotor rotation position θr=0°. A reference number 332 in (b) of FIG. 33 shows a rotor N magnetic pole, corresponding to the rotor N magnetic pole 329 in FIG. 32.

On the paper in FIG. 33, the left side position of the A-phase stator S magnetic pole 328 coincides with the right side position of the rotor N magnetic pole 329. At this rotation position, a total of six stator pole magnetic poles function, which is composed of the A-phase stator S magnetic pole 328, the A/-phase stator N magnetic pole 32A, the B-phase stator S magnetic pole, the B/-phase stator N magnetic pole, the C-phase stator S magnetic pole, and C/-phase stator N magnetic pole. In other words, a total of six stator poles can generate attractive forces in the CCW direction, which are shown by bold lines at six locations in the upper part of (b) in FIG. 33. The A-phase magnetic flux φa, B-phase magnetic flux φb, and C-phase magnetic flux φc shown in FIG. 32 are used to generate torque in the CCW direction. In part (c) of FIG. 33, at the rotor rotation position θr=4.0°, the C-phase stator S magnetic pole and C/-phase stator N magnetic pole cannot generate attraction in the CCW direction. The G-phase stator S magnetic pole and G/-phase stator N magnetic pole start to generate attractive force in the CCW direction. In part (d) of FIG. 33, θr=7.9°, the B-phase stator S magnetic pole and the B/-phase stator N magnetic pole can no longer generate any attractive force in the CCW direction. The F-phase stator S magnetic pole and F/-phase stator N magnetic pole begin to generate an attractive force in the CCW direction. In part (e) of FIG. 33, at θr=11.9°, the phase-A stator S magnetic pole 328 and the phase-A/-phase stator N magnetic pole 32A can no longer generate any attraction force in the CCW direction.

Furthermore, the E-phase stator S magnetic pole and the E/-phase stator N magnetic pole start to generate attractive force in the CCW direction. In part (f) of FIG. 33, where θr=15.8°, the G-phase stator S magnetic pole and the G/-phase stator N magnetic pole can no longer generate any attraction in the CCW direction. The D-phase stator S magnetic pole and the D/-phase stator N magnetic pole start to generate an attractive force in the CCW direction. In part (g) of FIG. 33, where θr=19.8°, the F-phase stator S magnetic pole and F/-phase stator N magnetic pole can no longer generate an attractive force in the CCW direction. The C-phase stator S magnetic pole and the C/-phase stator N magnetic pole start to generate an attractive force in the CCW direction. In part (h) of FIG. 33, where θr=23.7°, the E-phase stator S magnetic pole and E/-phase stator N magnetic pole can no longer generate any attractive force in the CCW direction. The B-phase stator S magnetic pole and B/-phase stator N magnetic pole start to generate an attractive force in the CCW direction. In part (i) in FIG. 33, where θr=27.7°, and this state returns to the same state as the part (b) in FIG. 33. The motor in FIG. 32 and FIG. 33 then repeats the same actions as the above 13 times at a 27.7° cycle, and the rotor makes one rotation.

As shown in FIG. 33, the motor of 14S26R can generate torque using six stator magnetic poles while changing the stator magnetic poles that operate with the rotor rotation.

In FIG. 33(c), the C-phase stator S magnetic poles and C/-phase stator N magnetic poles can theoretically generate a CCW torque, during a remaining range of approximately 1°, but this is negligible and confusing, so that thick lines marking the upper side of the rotor magnetic poles have been omitted. The same applies to each row after row (d) in FIG. 33(d). Additionally, the circumferential width θsg of the stator magnetic pole and the circumferential width θrg of the rotor magnetic poles can be modified to improve torque characteristics. Furthermore, the air gap surface shapes of the stator magnetic pole and rotor magnetic poles can be deformed into convex or arc shapes. Additionally, one or both of the stator magnetic poles and rotor magnetic poles can be skewed, or a step skew can be applied. Skewing has the effect of widening the torque generation range. Furthermore, by skewing, it is possible to smoothen changes in circumferential and radial attractive forces that occur during rotation, thereby reducing vibration and noise.

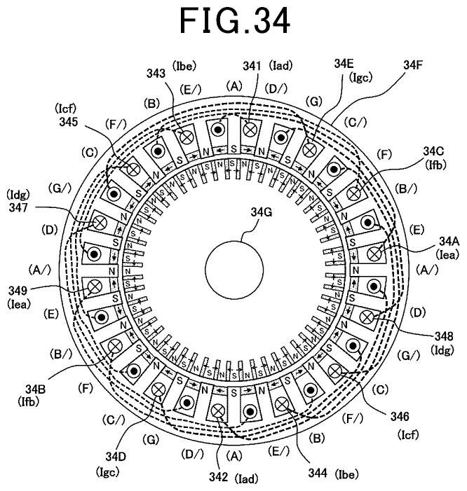

FIG. 34 shows a cross-sectional view of the motor configuration with the number of stator magnetic pole pairs set to 2 for the 14S26R motor shown in FIG. 32. This motor is a 7-phase motor, and the phases of each stator magnetic pole are illustrated in brackets on the outer side of the stator 34F. The configuration consists of 7 stator magnetic poles, which are A-phase, A/-phase, B-phase, B/-phase, C-phase, C/-phase, D-phase, D/-phase, E-phase, E/-phase, F-phase, F/-phase, and G-phase. FIG. 34 shows that the number of stator (14S26R) magnetic pole pairs is 2, resulting in 28 stator magnetic poles and 14 full-pitch windings. The stator magnetic pole pitch θpps is 12.9°, and the circumferential width θsg of the stator magnetic pole Ps is set to 6.4° in this example.

As shown in the figure, the polarities of each stator magnetic pole Ps are stator N magnetic pole Psn and stator S magnetic pole Pss, and they are arranged alternately circumferentially. Stator permanent magnets PMsbi are arranged between the respective stator magnetic poles in the same direction as the polarity of each of the stator magnetic poles. Direct current is applied to each full-pitch winding in the direction indicated by the current symbol, where a reference number 34G indicates the rotor shaft. FIG. 34 shows that there are 52 rotor magnetic poles Pr because the number of stator magnetic pole pairs is 2. The rotor N magnetic poles Prn and rotor S magnetic poles Prs are arranged circumferentially in an alternating pattern. Rotor permanent magnets PMrbi are arranged between each rotor magnetic pole in the same direction as the polarity of the rotor magnetic poles Pr. Each stator winding is a full-pitch winding, and direct current flows in the direction indicated by the current symbol. The winding pitch is 180° in electrical angle (equal to half of the electrical angle of 360° for one stator magnetic pole pair) and 90° in mechanical angle, with the coil end sections indicated by thick dashed lines.

One of the effects of the motor shown in FIG. 34 is that the number of full-pitch winding wires is set to an even number of 14, thus enabling the driving circuit shown in FIG. 35 to have a symmetrical structure with minimal waste. Additionally, increasing the number of magnetic pole pairs in the stator allows the thickness of the back yoke to be reduced, contributing to miniaturization.

In FIG. 34, there are AD phase windings 341 and 342 which carry AD phase currents Iad. Slots separated apart by an electrical angle of 180° and mutually wound by wirings are indicated by the dashed coil ends. Similarly, reference numbers 343 and 344 indicate BE phase windings and carry BE phase currents Ibe. Reference numbers 345 and 346 indicate CF-phase windings and carry CF-phase currents Icf. Reference numbers 347 and 348 indicate DG-phase windings and carry DG-phase currents Idg. Reference numbers 349 and 34A indicate EA-phase windings and carry EA-phase currents Iea. Reference numbers 34B and 34C indicate FB-phase windings and carry the FB-phase currents Ifb. Reference numbers 34D and 34E indicate GC-PHASE windings and carry the GC-phase currents Igc.

FIG. 34 shows a configuration with two stator magnetic pole pairs, so that there are two sets of windings for the same phase. There are two slots for the positive current and two slots for the negative current for the same phase, and there are two possible ways to wire the full-pitch winding from one slot to another. Since the same two options are available for other phases, there are a total of 2⁷ options, or 128 options, of possible connection methods and winding configurations. Under the assumption that the current for each winding is precisely controlled, the electromagnetic effects are essentially the same, except for the leakage magnetic fluxes near the coil ends. FIG. 34 shows one example of this connection method. Therefore, the driving circuit shown in FIG. 35 does not specify how the coils should be connected at the coil ends in FIG. 34. In electromagnetic field analysis using the finite element method (FEM), leakage magnetic fluxes at the coil ends are typically ignored, as it is relatively small compared to the magnetic flux in the core. Additionally, other winding methods, such as using toroidal-shaped ring windings, are also available.

Then, FIG. 35 shows an example of a driving circuit that supplies voltage and current to each full-pitch winding of the seven-phases stator shown in FIG. 34, and this is explained below. The driving circuit shown in FIG. 35, for example, supplies current to a circuit portion indicated by the thick lines depicted in FIG. 33 in synchronization with counterclockwise rotation to generate a counterclockwise torque, thereby exciting the magnetic flux components in the corresponding phases shown in FIG. 32 to generate the counterclockwise torque. Each full-pitch winding is supplied with the current shown in equations (59) to (65), and the relationship between the magnetic flux and voltage for each phase is given by equations (66) to (72). Furthermore, each full-pitch winding on the driving circuit in FIG. 35 is configured such that two windings are connected in series to enable energization under the conditions of equations (59) to (65) for the full-pitch windings shown in FIG. 34. This configuration is also arranged in the order of equations (73) to (79), and the voltages across the two series-connected windings can be simplified as shown on the right-hand side of equations (73) to (79). Furthermore, the control paths for each phase current, such as Ia component and Ib component, are clearly defined, thus enabling easy individual control of the magnetic flux of each phase, such as φa and φb shown in FIG. 32.

In FIG. 35, reference numbers 35F and 35N indicate AD phase windings that carry AD phase currents Iad1 and Iad2 according to equation (59). The currents Iad1 and Iad2 are theoretically equal to each other in value. Similarly, reference numbers 35G and 35P indicate EA phase windings that carry EA phase currents Iea1 and Iea2 according to equation (63). Reference numbers 35H and 35Q indicate BE-phase windings carrying BE-phase currents Ibe1 and Ibe2 according to equation (60). Reference numbers 35J and 35R indicate FB-phase windings carrying FB-phase currents Ifb1 and Ifb2 according to equation (64). Reference numbers 35K and 35S indicate CF-phase windings carrying CF-phase currents Icf1 and Icf2 according to equation (61). Reference numbers 35L and 35T indicate GC-phase windings and carry the GC-phase currents Igc1 and Igc2 according to equation (65). Reference numbers 35M and 35U indicate DG-phase windings and carry the DG-phase currents Idg1 and Idg2 according to equation (62).

In FIG. 35, a reference number 29R indicates a DC power source.

In addition, reference numbers 351, 352, 353, 354, 355, 356, 357, 358, 359, 35A, 35B, 35C, 35D, and 35E show transistors for driving the current of each phase to the respective phase windings. Reference numbers 35V, 35W, 35X, 35Y, 35Z, 281, 282, 283, 284, 285, 286, 287, 288, and 289 show diodes that regenerate the magnetic energy of the respective phase windings to the DC power source 29R. These diodes switch the conduction states of the respective transistors connected in series, from the on state to the off state to perform the above regeneration. Additionally, the diodes 28A, 28B, 28C, 28D, 28E, 28F, 28G, 28H, 28J, 28K, 28L, 28M, and 28N have the effect of suppressing and blocking the influence and interference of voltages and currents from other phases. Additionally, since each transistor has the ability to control the current passing therethrough, these diodes are not necessarily required, and some or all of them may be omitted.

The configuration and operations of FIG. 35 enable the current Iad, Ibe, Icf, Idg, Iea, Ifb, and Igc for each phase, as shown in equations (59) to (65), to flow through the circuits based on the simplified voltage relationship shown in equations (73) to (79). Concurrently, the voltage of each full-pitch winding is a complex voltage as shown in equations (66) to (72). However, by supplying power to the two series-connected windings arranged vertically in the drawing paper of FIG. 35, the current can be supplied under the simplified voltage relationships shown in Equations (73) to (79).

In particular, while any phase winding regenerates magnetic energy to voltage Vsour of the DC power source 29R, the voltage Vsour is induced as an induced voltage in the other windings. Therefore, it is necessary to drive the other phases by canceling out the induced voltage components of the other phases as shown in equations (59) to (65). The voltage across both ends of the two full-pitch windings connected in series in the upper and lower parts of FIG. 35 exhibit any of the values on the right-hand side of equations (73) to (79). The order of winding arrangement of the driving circuit in FIG. 35 is the same as that of the motor explained with FIG. 34, except for the coil end connections. In FIG. 34, if the coil ends of the left half of the windings from the AD phase winding 341 are connected to the right half of the windings, the winding arrangement order in FIG. 35 is obtained. However, this arrangement is undesirable because the coil ends are concentrated at the top and bottom in the drawing paper of FIG. 34. In the case of toroidal-shaped ring windings, the winding arrangement on the motor can be aligned with the winding arrangement in the driving circuit of FIG. 35 without any issues.

In the driving circuit shown in FIG. 35, each of the phase currents Ia, Ib, Ic, Id, Ie, If, and Ig shown on the right-hand side of equations (59) to (65) is the current passing between the two windings at the position where the modulation and diodes are located. A-phase currents Ia are the currents passing through the diodes 28B and 28J, and the two components of the two A-phase current Ia excite the A-phase magnetic flux φa. E-phase currents Ie are the currents passing through the diodes 28C and 28K, and the two components of the two E-phase currents Ie excite E-phase magnetic flux φe. B-phase currents Ib are the currents passing through the diodes 28D and 28L, and the two components of the two B-phase currents Ib excite B-PHASE magnetic flux φb. F-phase currents If are the currents passing through the diodes 28E and 28M, and the two components of the two F-phase currents If excite the F-phase magnetic flux φf. C-phase currents Ic are the currents passing through the diodes 28F and 28N, and the two components of the two C-phase currents Ic excite C-phase magnetic flux φc. G-phase currents Ig are the currents passing through the diodes 28G and 28P, and excite two components of the two G-phase current Ig excite the G-phase magnetic flux φg. D-phase currents Id are the currents passing through the diodes 28H and 28A, and the two components of the D-phase currents Id excite the phase D magnetic flux φd. In this way, the magnetic fluxes φa, φe, ρφb, σφf, φc, φg, and φd in each phase can be controlled individually.

Another method is to set the number of stator magnetic pole pairs as 1 in FIG. 32, and to set the number of windings as 14, with each winding replaced by a parallel winding.

Another method is to reduce the number of transistors in the driving circuit. In this case, the number of windings can be driven with only 7 windings. This will be explained later.

FIG. 36 shows an example of the waveforms of the currents supplied in each phase to energize each full-pitch winding of the 7 phases shown in FIG. 34 by the driving circuit in FIG. 35, which is an example of generating CCW torque. The full-pitch winding currents Iad, Ibe, Icf, Idg, Iea, Ifb, and Igc are shown from row (h) to (n) in FIG. 36. These currents are related by equations (59) to (65), and the current components Ia, Ib, Ic, Id, Ie, If, and Ig on the right side of such equations are shown in FIGS. 36(a) to (g). The horizontal axis is shown as rotor rotation angle θr. In the case of rotation at a constant speed, the current waveform can also be shaped with a horizontal axis extended over time. As mentioned above, the motors in FIGS. 32 and 34 energize each phase current at an electric angle of 27.692° per cycle, so that FIG. 36 shows the current waveforms in the range of 55.4° for two cycles. This electrical angle also assumes an electrical angle of 360° for the stator 1-pole pair. Naturally, the magnitude of the current is controlled by changing the magnitude of the current according to the size of the motor load, so that the current amplitudes in row (f) through (j) in FIG. 36 are controlled by increasing or decreasing the current amplitude.

For a negative torque, i.e., a CW torque, the phase to be energized is changed.

Each current illustrated in FIG. 36 shows good characteristics. Each full-pitch winding current energizing each of full-pitch winding wire is energized in a range of 6/7, each contributing to the torque generation, and the utilization ratio of the windings is as large as 6/7. In addition, the two current components on the right side of equations (59) through (65) of each full-pitch windings current are not energized at the same time, so that the copper loss does not increase by a square. These are indicators of copper loss reduction and high efficiency of the motor. The utilization ratio of the driving transistor is 6/7, and the current capacitance of the driving circuit can be reduced because the two current components are not energized at the same time. These effects will be explained later. The current waveforms provided in FIG. 36 are shown as rectangular shapes, but as shown in the dashed lines in FIG. 13, the current increase/decrease may be sloped and the increase/decrease time may be set.

Examples of a motor with full-pitch windings shown in FIG. 32 and FIG. 34 in good operating conditions will then be explained. A linearly developed view of the operations in FIG. 33, the driving circuit in FIG. 35, and the waveform of each phase current in FIG. 36 are shown. The relationship between the low loss and high efficiency of the motor and the maximum torque increase in a short period of time, which are the objectives of the present invention, is also explained. The relationship with the reduction of the current capacity of the driving circuit transistor is also explained. These are reflected in smaller size, lighter weight, and lower cost.

As explained in FIG. 33 and FIG. 36, the full-pitch winding motor shown in FIG. 32 always has 6 stator magnetic poles positions acting to generate a CCW torque. The motor in FIG. 34 has two stator magnetic pole pairs, so that the number of stator magnetic poles is doubled, but the operations are basically the same as those in FIG. 32 with a stator one-pole pair configuration. For this reason, each current component and each magnetic flux component of each winding is explained in FIG. 32. At the rotor rotation angle θr=0° shown in (b) of FIG. 33, the CCW torque can be generated by the six stator magnetic poles, as shown by the bold lines in the figure, composed of A-phase and A-/phase, B-phase and B/-phase, C-phase and C/-phase. The current waveform is shown in FIG. 36 in a range where Or is from 0° to 4°. In the motor shown in FIG. 32, an A-phase stator magnetic pole 328 and an A/-phase stator magnetic pole 32A are related to an AD-phase current Iad=Ia+Id for the AD-phase winding 321 and an EA-phase current Iea=Ie+Ia for the EA-phase winding 325, which windings 321 and 325 are located before and after circumferentially. Of these currents, supplying the components of the two A-phase currents Ia enable a magnetomotive force to excite the A-phase magnetic flux ca. This causes a magnetic attractive force to act on the rotor magnetic poles, the generating torque in the CCW direction.

The torque generation interval depends on the circumferential width θsg of the stator magnetic pole and the circumferential width θrg of the rotor magnetic poles in the air gap plane. In FIG. 33, the stator magnetic pole width is θsg=360°/28=12.857°. The rotor magnetic poles width θrg is assumed to be θrg=θsg=12.857°, although values which are less than 360°/26=13.846° are possible. Thus, the magnetic poles of A- and A/-phases can theoretically produce a CCW torque as long as θr is between 0° and 12.857°. Similarly for the other phases, the interval where torque can be generated can be determined from the geometric configuration. The torque generation width can be changed by modifying the circumferential width θrg of the rotor magnetic poles. The torque generation width can also be changed by employing methods such as skewing the stator and rotor or changing the magnetic pole shape of the air gap surface from a parallelogram to a concave-convex irregular shape.

And at the rotor rotation angle θr=0° in (b) of FIG. 33, the B-phase stator magnetic pole and the B/-phase stator magnetic pole are subjected to magnetic excitation on components of the B phase magnetic flux φb, by being supplied with a magnetomotive force with two components of the B-phase current Ib, in the same manner as that explained about the A-phase. The two components of the B-phase current Ib are provided by two current components among a BE-phase current Ibe=Ib+Ie in the BE-phase winding 322 and an FB-phase current Ifb=If+Ib in the FB-phase winding 326, which windings 322 and 326 are located before and after circumferentially. This magnetic excitation acts a magnetic attractive force on the rotor magnetic poles to generate torque in the CCW direction.

Further, the C-phase stator magnetic pole and the C/-phase stator magnetic pole are subjected to magnetic excitation on components of the C-phase magnetic flux φc, by being supplied with a magnetomotive force with two components of the C-phase current Ic. The two components of the C-phase current Ic are provided by two current components among a CF-phase current Icf=Ic+If in the CF-phase winding 323 and a GC-phase current Igc=Ig+Ic in the GC-phase winding 327, which windings 323 and 327 are located before and after circumferentially. This magnetic excitation acts a magnetic attractive force on the rotor magnetic poles to generate torque in the CCW direction.

Hence, during the rotor rotation angle from θr=0° to θr=4° shown in (b) of FIG. 33, components of the A-phase current Ia are energized in the AD-phase winding 321 and EA phase winding 325, components of the B-phase current Ib are energized in the BE-phase winding 322 and FB-phase winding 326, and components of the C-phase current Ic are energized in the CF-phase winding 323 and GC-phase winding 327, thereby generating the CCW torque. In this energization, only 3 of the 7 magnetic fluxes (φa, φb, and φc) are utilized, while 6 of the 7 full-pitch windings are utilized to generate the CCW torque. The utilization ratio of the windings is as large as 6/7, and it can be said that most of the windings are utilized to generate effective torque. Furthermore, the current in each winding is 30 energized in such a way that the two components do not overlap in the currents as shown with equations (59) to (65), thus minimizing the copper loss in the motor. The conditions for the two current components in equations (59) to (65), which currents components are not to overlap, are derived from that the stator magnetic poles used for torque generation are at least two circumferentially separated.

Compared to the conventional 3-phase switched reluctance motor shown in FIG. 63, where the winding utilization ratio is 1/3, the present motor can improve the winding utilization ratio by a factor of (6/7)/(1/3)=2.57.

From the viewpoint of utilizing the magnetic circuit of the soft magnetic member in the stator, it is also preferable to generate a CCW torque by utilizing stator magnetic poles which is one or more stator magnetic poles which are located circumferentially away from each other. As shown in FIG. 17, the teeth on both sides of a stator magnetic pole that is in charge of generating torque can be utilized to pass the magnetic fluxes therethrough. The structure is to effectively generate a larger torque by reducing the magnetic resistance of the magnetic circuit in the stator. In particular, the use of both adjacent teeth is effective to obtain a large magnetic flux density of 2.0 [T] or more in the vicinity of the airgap portion of the stator magnetic pole that generates the torque, and to generate a large torque. In order to utilize the teeth of both circumferential neighbors, it is necessary to use the permanent magnets PMsbi for bypass as mentioned.

Additionally, it is important that a stator magnetic pole used for torque generation is spaced circumferentially by one or more poles from neighboring stator magnetic poles on both sides in the circumferential direction, and that two full-pitch windings are utilized to generate a large magnetomotive force near the air gap portion. Of the seven magnetic flux components, six full-pitch windings can be used to concentrate the magnetomotive force near the air gap of three magnetic flux components. Similarly, achieving a magnetic flux density of 2.0 [T] or higher near the air gap portion of the stator magnetic pole that generates torque is an effective method for producing large torque. Additionally, even in the low-load operating region where the magnetic flux density is relatively small, it is expected that the excitation load of the magnetic fluxes will be reduced.

Additionally, the rotor magnetic poles directly involved in torque generation, as shown in the motor cross-sectional view in FIG. 32 and the linearly developed view of FIG. 33, generate torque using four or more rotor magnetic poles circumferentially spaced apart.

As shown in FIGS. 8, 9, 10, 11, 16, 17, 18, and 19, due to the unique magnetic actions of the present invention for generating torque, it is undesirable to simultaneously activate both rotor magnetic poles located mutually adjacently in the circumferential direction. In that case, it may also be necessary to impose restrictions on the current control of each phase.

Similarly to the magnetic fluxes of the stator, the magnetic fluxes of the rotor magnetic poles are passed through the soft magnetic member magnetic paths of the adjacent circumferential rotor magnetic poles to generate torque. For this reason, as shown in FIG. 33, it is preferable that the stator magnetic poles used for torque generation are arranged such that they are separated by two or more tooth positions in the circumferential direction. Furthermore, the circumferential width θsg of each of the stator magnetic poles in the present invention motor can be reduced or expanded, and the circumferential width θrg of each of the rotor magnetic poles can also be reduced or expanded. To more smoothly adjust the increase or decrease in the magnetic fluxes passing therethrough, the circumferential widths θsg and θrg can be reduced or expanded, and skewing and shaping magnetic pole can also be optimized. However, even in such cases, if the two rotor magnetic poles used for torque generation are circumferentially close, magnetic interference May occur. It is necessary to configure or control the motor so that two adjacent rotor magnetic poles are not used simultaneously.

As described above, as an example, the operations of the motor with a stator having one magnetic pole pair shown in FIG. 32 and the motor with a stator having two magnetic pole pairs shown in FIG. 34 have been explained. Specifically, the explanation has been given the state where the rotor rotation angle θr in FIG. 33(b) is between 0° and 4°, and the A phase, B-PHASE, and C-PHASE are generating torque. Similarly, in FIGS. 33(c), (d), (e), (f), (g), and (h), the three stator magnetic poles operate in parallel to generate torque, and the three stator magnetic poles are circumferentially separated by two or more pole positions. In FIG. 33(c), the A phase, B-phase, and G phase operate between er of 4° and 7.9°, in FIG. 33(d), the A phase, F phase, and G phase operate between θr of 7.9° and 11.9°, and further, in FIG. 33(e), E phase, F phase, and G phase operate between 11.9° and 15.8° of Or. At the same time, in FIG. 33(f), E phase, F phase, and D phase operate between θr of 15.8° and 19.8°, in FIG. 33(g), the E phase, C-PHASE, and D phase operate between θr of 19.8° and 23.7°, and further, in FIG. 33(h), the B-phase, C-phase, and D phase operate between θr of 23.7° and 27.7°. The electrical angle completes one cycle at 27.7°, and in the case of the motor with one stator pole pair shown in FIG. 32, this operation is repeated 13 times to complete one rotation of the rotor. This electrical angle is also based on the stator having one pole pair with an electrical angle of 360°. In each of these states, the stator magnetic poles generating torque are separated by two or more circumferential pole positions. For example, according to the conventional technique, if the A phase and E phase generate torque simultaneously, the circumferentially adjacent stator magnetic poles would operate simultaneously; however, such a state does not occur in any of the operations shown in FIG. 33. The configuration of the stator magnetic poles, which is produced as 14S26R, and rotor magnetic poles in FIG. 32 and FIG. 34 are an excellent combination.

The operations and effects described above are reflected in the current waveforms of respective full-pitch windings shown in FIG. 36. By applying current to most of the sections in the 6/7 configuration, all of the current provides a magnetomotive force to generate torque, thereby effectively producing torque. Since the two current components on the right-hand side of equations (59) to (65) are not applied simultaneously, the current capacity of the transistors can also be kept low. As can be seen from the current waveforms shown in FIG. 36 and the driving circuit shown in FIG. 35, out of the 14 transistors shown in FIG. 35, 12 transistors are used to apply current to the 12 full-pitch windings, supply power, and generate torque. The utilization rate of the respective transistors in the driving circuit of FIG. 35, i.e., 6/7, is a large value, enabling a reduction in the total current capacity of the driving circuit, thereby allowing for the miniaturization and cost reduction of the driving circuit. For example, three-phase AC surface magnet synchronous motors (SPMSM) or magnet-embedded synchronous motors (IPMSM) are widely used, but the utilization rate of their driving circuits and transistors is 1/3. On average, 2 of the 6 transistors are used to supply power to the motor, resulting in a utilization rate of 1/3. When driving the motors shown in FIG. 32 and FIG. 34 using the driving circuit shown in FIG. 35, the utilization rate for SPMSM is 2.57 times higher than that of IPMSM driven by a conventional three-phase driving circuit, which is calculated as (6/7)/10) (1/3)=2.57. Therefore, although the number of components in the driving circuit of FIG. 35 is higher, the total current capacity of the driving circuit is significantly reduced, enabling miniaturization and cost reduction. In driving circuits for motors exceeding 10 KW, IGBTs are often used in parallel, so the actual number of power components May not increase significantly.

Additionally, as mentioned earlier, the full-pitch winding shown in FIG. 32 and FIG. 34 has a significant issue where voltage components overlap from other phases, as shown in equation (66). However, by using the driving circuit shown in FIG. 35, which employs equations (73) to (79), a configuration is provided where voltage components from other phases are not induced at the ends of the two windings due to a cancellation effect. Furthermore, there is another method to reduce the voltage load on the driving circuit by continuously supplying a current component equivalent to the field current, i.e., the current that increases the magnetic flux density of each phase. This method will be explained later. Additionally, one of the factors enabling the driving circuit in FIG. 35 is that the driving current is a direct current. In the case of direct current, it is relatively easy to combine two or more current components and branch them. In an alternating current 30 driving circuit, the driving circuit becomes more complex to supply positive and negative currents.

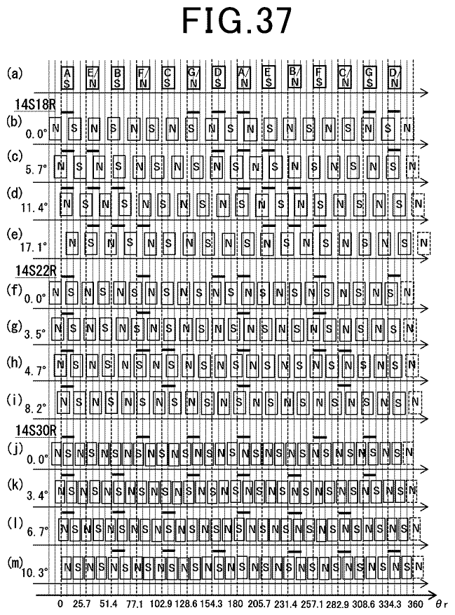

Another embodiment according to Claim 5 will now be desired with FIGS. 37(a), (b), (c), (d), and (e).

This is a linearly developed view showing the operations of a motor with a full-pitch winding of 14S18R. This is an example where Ns is 3 in equation (57) and Nr is 4 in equation (58), representing a type of 7-phase motor. A cross-sectional view of the 14S18R motor is not shown, but its stator is the same as that of the 14S26R stator shown in FIG. 32, and the rotor has the same structure but with 18 rotor magnetic poles. FIG. 37(a) shows the shape of each stator magnetic pole facing the air gap, and the circumferential stator magnetic pole width is θsg=360°/28=12.857°. FIG. 37 uses the same representation method as that adopted by the linearly developed view of the 14S26R shown in FIG. 33. FIG. 37(b) shows a shape of each rotor magnetic pole facing the air gap at a rotor rotation angle θr=0°. The pitch θppr of the rotor magnetic poles is 360/18=20°, and the width θrg of the rotor magnetic poles is the same as the width θsg of the stator magnetic poles, i.e., 12.857°. The distance between rotor magnetic poles is relatively large at 7.143°. Furthermore, as mentioned earlier, these motors have a point-symmetric structure with respect to the rotor center point, including the full-pitch windings. For example, the A-phase stator magnetic pole and the A/-phase stator operate in the same manner. However, since the motor is driven by direct current, the direction of the current and the direction of the magnetic fluxes are not symmetrical but opposite to each other.

When θr=0°, as shown by the thick line in FIG. 37(b), it is possible to generate a CCW torque by the stator magnetic poles of phases A, D, and G. Similarly, when θr=5.7° in FIG. 37(c), it is possible to generate a CCW torque by phases A, D, and E. At θr=11.4° in FIG. 37(d), a counterclockwise torque can be generated at the A-phase, B-phase, and E-phase. At θr=17.1° in FIG. 37(e), a counterclockwise torque can be generated at the B-phase, E-phase, and F-phase. This operation is repeated, and the stator magnetic pole generating the CCW torque shifts with the rotor rotation angle θr. In other words, the torque generation pattern completes one cycle at 40°, and the rotor completes one revolution at 9 cycles (360°). At any rotor rotation angle θr, the CCW torque can be generated by six stator magnetic poles.

However, as shown in the figure, in either case, three stator magnetic poles arranged circumferentially in a continuous manner generate the CCW torque, resulting in an undesirable condition. One issue is that the full-pitch winding positioned between the three stator magnetic poles must simultaneously carry the two current components from the right-hand side of equations (59) to (65). Since copper loss is proportional to the square of the current value, this results in a doubling of copper loss. Additionally, when the stator magnetic pole width θsg and rotor magnetic pole width θrg are made larger, the timing when two adjacent stator magnetic poles excite the same rotor magnetic poles occurs, thus causing magnetic connection through the soft magnetic member portion at the tips of the rotor magnetic poles, thus allowing magnetic flux to pass through. Furthermore, the permanent magnets PMsbi used for bypassing between adjacent stator magnetic poles experience twice the reverse direction magnetomotive force. Additionally, the leakage magnetic flux between the two stator magnetic poles increases. From these considerations, when using a motor with full-pitch windings such as the 14S18R, effective control can be achieved by taking measures such as paying attention to increased copper loss and optimizing current control for each phase. On the other hand, the full-pitch winding motor 14S18R, as shown in FIG. 37(b) for a rotor magnetic pole width θrg=12.857°, allows the rotor magnetic pole width θrg to be expanded up to a maximum of 20°, thus providing high flexibility. On top of that advantage, the torque characteristics can be improved.

Another embodiment according to Claim 5 will now be desired with FIGS. 37(f), (g), (h), and (i). This is a linearly developed view showing the operations of a motor with full-pitch windings, which is defined as 14S22R. In this example, Ns is 3 according to equation (57) and Nr is 5 according to equation (58), and it is a type of 7-phase motor. A cross-sectional view of the 14S22R motor is not shown, but its stator is the same as that of the 14S26R stator shown in FIG. 32, and the rotor has the same structure but with 22 rotor magnetic poles. FIG. 37(f) shows the shape of each rotor magnetic pole facing the air gap at a rotor rotation angle θr=0°. The pitch of the rotor magnetic poles, θppr, is 360/22=16.364°, and the width of the rotor magnetic poles, θrg, is the same as the width of the stator magnetic poles, θsg, at 12.857°.

When θr=0°, as shown by the thick line in FIG. 37(f), it is possible to generate a CCW torque by the stator magnetic poles of the A-, D-, and F-phases. Similarly, when θr=3.5° in FIG. 37(g), it is possible to generate a CCW torque by the A- and F-phases. At θr=4.7° in FIG. 37(h), a counterclockwise torque can be generated in the A-phase, C-phase, and F phase. At θr=8.2° in FIG. 37(i), a counterclockwise torque can be generated in the A-phase and C-phase. By repeating this operation, the stator magnetic pole that generates a CCW torque shifts with the rotor rotation angle θr, and the torque generation pattern completes one cycle at 32.7°, thereby completing 360° by 11 cycles, causing the rotor to rotate once. As the rotor rotates, the CCW torque can be generated by approximately four stator magnetic poles. Compared to the 14S26R motor shown in the previous FIG. 32, the torque generation is reduced to two-thirds. The winding utilization rate and transistor utilization rate are reduced to two-thirds of those of the 14S26R type.

Another embodiment according to Claim 5 will now be desired with FIGS. 37(j), (k), (l), and (m). This is a linearly developed view showing the operations of a motor with a full-pitch winding of 14S30R type. This is an example where Ns is 3 in equation (57) and Nr is 7 in equation (58), which is a type of 7-phase motor. A cross-sectional view of the 14S30R motor is not shown, but its stator is the same as that of the 14S26R stator shown in FIG. 32, and the rotor has the same structure but with 30 rotor magnetic poles. FIG. 37(j) shows a shape of each rotor magnetic pole facing the air gap at a rotor rotation angle θr=0°. The pitch of the rotor magnetic poles is θppr=360/30=12°, and the width of the rotor magnetic poles is θrg=12.0°.

When θr=0°, as shown by the thick line in FIG. 37(j), it is possible to generate a CCW torque by the stator magnetic poles of the A-phase, G-phase, and F-phase.

Similarly, at θr=3.4° as shown in (k) of FIG. 37, a CCW torque can be generated in the A-phase, B-phase, and G-phase. At θr=6.7° as shown in (l) of FIG. 37, a CCW torque can be generated in the A-phase, B-phase, and C-phase. In FIG. 37 (m) which shows θr=10.3°, a counterclockwise torque can be generated by the B-phase, C-phase, and D-phase. By repeating this operation, the stator magnetic poles generating a counterclockwise torque shift in response to advancement in the rotor rotation angle θr, completing one cycle of the torque generation pattern every angle of 24°, and completing 15 cycles (360°) to rotate the rotor once. As the rotor rotates, the six stator magnetic poles can generate a CCW torque. The same six stator magnetic poles act as those in the motor 14S26R of FIG. 32, and in this respect, the operations are the same. The winding utilization rate and transistor utilization rate are also equivalent. However, since the number of rotor magnetic poles is 30, it is necessary to devise the arrangement of the bypass permanent magnets PMrbi for the rotor and the magnetic path of the soft magnetic member for the rotor magnetic poles. For example, by adopting an outer rotor structure where the rotor is positioned on the outer periphery, the space for the rotor magnetic poles becomes wider, increasing design flexibility.

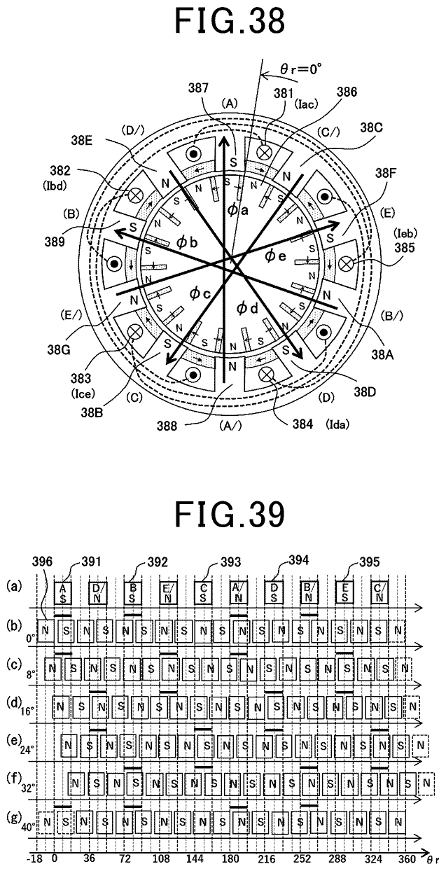

Another embodiment according to Claim 5 will now be desired with FIGS. 38, 39 and 40, which exemplifies a motor defined as 10S18R in terms of its stator and rotor configuration.

FIG. 38 shows an example of a cross-section of a motor with a full-pitch winding of 10S18R configuration. This is an example where Ns in equation (57) is 2 and Nr in equation (58) is 4, and it is a type of 5-phase motor. A reference number 387 indicates an A-phase stator S magnetic pole, and a reference number 388 indicates an A/-phase stator N magnetic pole, through which the A-phase magnetic fluxes ca shown in the figure pass. The configuration is point-symmetric with respect to the rotor center. Similarly, reference numbers 389 and 38A indicate a B-phase stator S magnetic pole and a B/-phase stator N magnetic pole, through which the B-phase magnetic fluxes φb shown in the figure pass. Reference numbers 38B and 38C indicate a C-phase stator S magnetic poles and a C/-phase stator N magnetic poles, respectively, and pass through the component of the C-phase magnetic fluxes φc shown in the figure. Reference numbers Reference numbers 38D and 38E indicate a D-phase stator S magnetic poles and a D/-phase stator N magnetic poles, respectively, and pass through the component of the D-phase magnetic fluxes od shown in the figure. Reference numbers 38F and 38G indicate an E-phase stator S magnetic pole and an E/-phase stator N magnetic pole, respectively, and pass through the component of the E-phase magnetic fluxes pe shown in the figure. The phase of each stator magnetic pole is indicated by brackets around the outer periphery of the stator.

A reference number 381 indicates an AC-phase full-pitch winding, with the coil ends connected to slots separated by 180° at an electrical angle, which is equal to half of the electrical angle of 360° for one pole pair of the stator, as indicated by dashed lines, and is wound to allow AC-phase current Iac to flow therethrough. Similarly, a reference number 382 indicates a BD-phase full-pitch winding, through which a BD-phase current Ibd flows. A reference number 383 indicate a CE-phase full-pitch winding, through which a CEBD-phase current Ice flows. A reference number 384 indicates a DA-phase full-pitch winding, through which a DA-phase current Ida flows. A reference number 385 indicates an EB-phase full-pitch winding, through which an EB-phase current Ieb flows. These currents are related to the five-phase currents in the following equation, similar to the currents in equations (59) to (65) of the seven-phase motor shown in FIG. 32.

$$I a c = I a + Ic \qquad ( 80 )$$

$$Ibd = Ib + Id \qquad ( 81 )$$

$$Ice = Ic + Ie \qquad ( 82 )$$

$$Ida = I d + I a \qquad ( 83 )$$

$$Ieb = I e + I b \qquad ( 84 )$$

Additionally, as shown in FIG. 38, the magnetic flux components φa, φb, φc, φd, and we of all the five phases are interlinked with all the full-pitch windings and, in accordance with Faraday's law of electromagnetic induction, induce voltages in each of the full-pitch windings, resulting in the following relationship. Note that the number of turns of the full-pitch winding is denoted as Nw/2. Furthermore, while the absolute values of the interlinkage magnetic flux of each winding include the magnetic flux components of the magnets, assuming that the magnetic fluxes of the magnets are constant and does not vary with time, the expressions for the five phases are derived in the same manner as the equations (48), (49), and (50) for the three-phase case, resulting in the following equations.

$$Vack = Nw / 2 \times d ( φ a + φ b + φ c + φ d + φ e ) / dt = Vak + Vbk + Vck + Vdk + Vek \qquad ( 85 )$$

$$Vbdk = Nw / 2 \times d ( − φ a + φ b + φ c + φ d + φ e ) / dt = − Vak + Vbk + Vck + Vdk + Vek \qquad ( 86 )$$

$$Vcek = Nw / 2 \times d ( − φ a + φ b + φ c + φ d + φ e ) / dt = − Vak + Vbk + Vck + Vdk + Vek \qquad ( 87 )$$

$$Vdak = Nw / 2 \times d ( φ a + φ b + φ c + φ d + φ e ) / dt = Vak + Vbk + Vck + Vdk + Vek \qquad ( 88 )$$

$$Vebk = Nw / 2 \times d ( φ a + φ b + φ c + φ d + φ e ) / dt = Vak + Vbk + Vck + Vdk + Vek \qquad ( 89 )$$

The complex voltages of each full-pitch winding line in these five phases can be simplified in the same way as in equations (73) to (79) for seven phases, resulting in the following five-phase voltage relationship.

$$Vack + Vdak = Nw / 2 \times d ( 2 \times φ a ) = Vak \qquad ( 90 )$$

$$Vdak + Vbdk = Nw / 2 \times d ( 2 \times φ d ) = Vdk \qquad ( 91 )$$

$$Vbdk + Vebk = Nw / 2 \times d ( 2 \times φ b ) = Vbk \qquad ( 92 )$$

$$Vebk + Vcek = Nw / 2 \times d ( 2 \times φ e ) = Vek \qquad ( 93 )$$

$$Vcek + Vack = Nw / 2 \times d ( 2 \times φ c ) = V c k \qquad ( 94 )$$

As with the 7-phase motor described above, following Ampere's law of the integral of current around a loop, the A-phase current Ia is applied to the AC-phase winding 381 shown in FIG. 38 as the A-phase current Iac according to equation (80), and simultaneously, the A-phase current Ia is applied to the DA-phase winding 384 as the DA-phase current Ida according to equation (83). As a result, the A-phase magnetic flux φa in FIG. 38 is excited, and simultaneously, the components of the A-phase current Ia in both windings do not affect the magnetic flux components of the other phases. Equation (90) is the inverse relationship of this, and according to Faraday's law of electromagnetic induction, the sum of the AC-phase voltage Vack and the DA-phase voltage Vdak is related only to the A-phase magnetic flux pa and the A-phase voltage Vak, and is not affected by the magnetic flux of other phases. Equations (91) to (94) also have the same relationship. These relationships are also related to motor configurations that are point-symmetric with respect to the rotor center. Additionally, by applying the simplification method for these voltages, there are control methods that are less affected by the voltages of other phases, which will be explained later.

FIG. 39 shows a linearly developed view illustrating the operations of the 10S18R motor shown in FIG. 38 that generates a CCW torque. This is a development figure similar to those in FIGS. 12 and 33. The rotor rotation angle in FIG. 38 is θr=0°, and the CCW direction of the motor is the right direction in FIG. 39. In each row of FIG. 39, the intervals where the CCW torque generation is possible are indicated by thick lines above the rotor magnetic pole shapes. In FIG. 39, the stator magnetic pole width is set to θsg=360°/20=18°. The rotor magnetic pole width θrg can be any value less than or equal to 360°/18=20°, but in FIG. 33, θrg is set to 18°. The stator magnetic pole width θsg and rotor magnetic pole width θrg can be increased or decreased, and optimized according to motor requirements, and the magnetic pole shape can also be changed.

FIG. 39(a) shows a shape of each stator magnetic pole facing the air gap surface.

A reference number indicates a magnetic pole 391 which corresponds to the A-phase stator S magnetic pole 387 shown in FIG. 38. Similarly, reference numbers 392, 393, 394, and 395 in FIG. 39 indicate magnetic poles which correspond to those 389, 38B, 38D, and 38F shown in FIG. 38. The horizontal axis Or in FIG. 39 is somewhat confusing, but it indicates the electrical angle position with 1 magnetic pole pair of the stator which is set at an electrical angle of 360°, and it also represents the electrical angle position of the rotation direction of each part of the stator. The rotor rotational position is shown on the left side of each row in FIG. 39. In FIG. 39, the rotor various parts are moved to the right side in (b), (c), (d), and (e). In FIG. 39, the row (b) represents the rotor rotation position θr=0°, which is the starting point of rotor rotation. A magnetic pole 396 in (b) of FIG. 39 corresponds to the rotor N magnetic pole 386 in FIG. 38. In FIG. 39, the left-side position of the A-phase stator S magnetic pole 391 aligns with the right-side position of the rotor N magnetic pole 396. At this position, the four stator pole magnets, which are the A-phase stator S magnetic pole 391, the A-phase stator N magnetic pole, the B-phase stator S magnetic pole 392, and the B-phase stator N magnetic pole, can generate an attractive force in the counterclockwise (CCW) direction, as indicated by the thick lines at the four upper positions in FIG. 39(b). Using the A-phase magnetic flux φa and B-phase magnetic flux φb shown in FIG. 38, torque in the counterclockwise (CCW) direction is generated.

FIG. 39(c) shows that when the rotor rotation position θr=8°, the B-phase stator S magnetic pole and the B/-phase stator N magnetic pole can no longer generate an attractive force in the CCW direction. The E-phase stator S magnetic pole 395 and the E/-phase stator N magnetic pole begin to generate an attractive force in the CCW direction. FIG. 39(d) shows that at θr=16°, the A-phase stator S magnetic pole and the A/-phase stator N magnetic pole can no longer generate an attractive force in the CCW direction. The D-phase stator S magnetic pole 394 and the D/-phase stator N magnetic pole begin to generate an attractive force in the CCW direction. FIG. 39(e) shows that at θr=24°, the E-phase stator S magnetic pole 395 and the E/-phase stator N magnetic pole can no longer generate an attractive force in the counterclockwise direction. The C-phase stator S magnetic pole 393 and the C/-phase stator N magnetic pole begin to generate an attractive force in the counterclockwise direction. FIG. 39(f) shows a 30 rotation positon of θr=32°, where the D-phase stator S magnetic pole and the D/-phase stator N magnetic pole can no longer generate an attractive force in the counterclockwise direction. The B-phase stator S magnetic pole 392 and the/B-phase stator N magnetic pole begin to generate an attractive force in the counterclockwise direction. FIG. 39(g) shows the state which is at the rotation angle of θr=40°, which returns to the same state as that shown in FIG. 39(b). The motor shown in FIG. 38 and FIG. 39 operates at a 40° cycle, repeating the same motion nine times to complete one rotation of the rotor.

Then an example of driving the 10S18R motor is explained. As shown in FIG. 34, the 7-phase motor with 7-phase stators and 2 magnetic pole pairs can be driven by applying power to the driving circuit in FIG. 35. Similarly, the 5-phase 10S18R motor can be driven in the same manner. Although not shown, the motor shown in FIG. 38 can be modified into a stator with two magnetic pole pairs and configured as a motor with 10 full-pitch windings. The driving circuit can be obtained by removing the two-phase driving circuit (transistors 35B, 35C, 35D, and 35F) from the seven-phase driving circuit shown in FIG. 35, resulting in a five-phase driving circuit. The 7-phase AD-phase, EA-phase, BE-phase, FB-phase, and CF-phase are replaced with the AC-phase, BD-phase, CE-phase, DA-phase, and EB-phase in the 5-phase configuration, respectively, and the currents are controlled according to equations (80) to (84). In this state, in the 5-phase driving circuit obtained by modifying the driving circuit of FIG. 35, the voltages corresponding to the two ends of the two windings arranged vertically in the drawing paper of FIG. 35 become the voltages given by equations (90) to (94), so that the voltages are not affected by the magnetic flux or voltages of other phases. As a result, the currents in equations (80) to (84) can be more easily controlled.

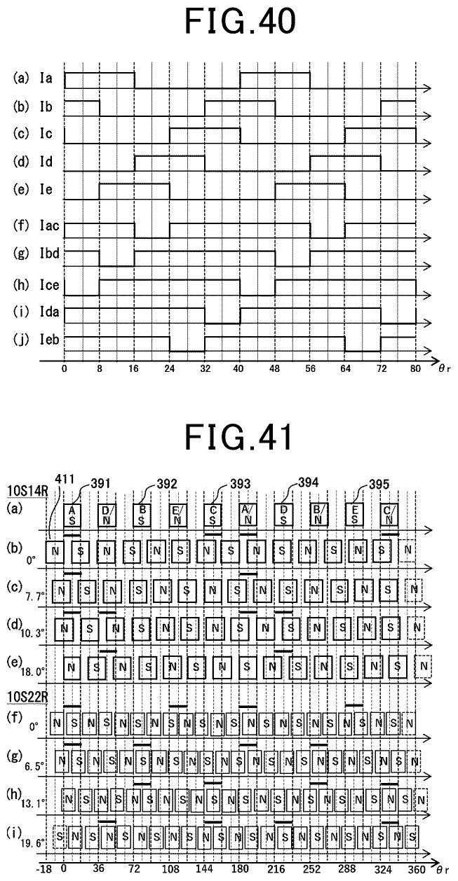

Moreover, FIG. 40 shows an example of current waveforms when the motor with the configuration shown in FIG. 38 is converted to a two-pole motor and energized in the operating sequence shown in FIG. 39 using the foregoing five-phase driving circuit to generate torque in the counterclockwise (CCW) direction. In FIG. 39, the magnetic flux components in each phase which are φa, φb, φc, φd, and pe shown in FIG. 38 are excited by the current components Ia, Ib, Ic, Id, and Ie shown in FIGS. 40(a), (b), (c), (d), and €, respectively. The currents flowing through the respective full-pitch windings shown in FIG. 38 are Iac, Ibd, Ice, Ida, and Ieb shown in FIG. 40(f) to (j), and can be calculated from the current relationships defined by equations (80) to (84) as the current components Ia, Ib, Ic, Id, and Ie presented in FIG. 40(a) to €. The operations in FIG. 39 are repeated at a 40° cycle, and FIG. 40 shows a range of 80° corresponding to two cycles.

The full-pitch winding currents Iac, Ibd, Ice, Ida, and Ieb from (f) to (j) of FIG. 40 exhibit good characteristics. Each current flows in the 4/5 interval and contributes to torque generation. The winding utilization rate is 4/5=0.8, which is high, though slightly lower than the 7-phase winding utilization rate of 6/7=0.857 shown in FIG. 36. However, the difference is minimal. Additionally, the two current components in the right-hand side of equations (80) to (84) for each full-pitch winding current are not energized simultaneously, so that copper loss does not increase quadratically. These factors serve as indicators for reducing copper loss and achieving high efficiency in the motor. Furthermore, the utilization rate of the drive transistors is also 4/5, and since the two current components are not energized simultaneously, the current capacity of the driving circuit can be reduced. The current waveforms shown in FIG. 40 are examples of rectangular shapes, but of course, various increasing and decreasing waveforms, such as trapezoidal waveforms with slopes during current increases and decreases, can be used. As will be explained later, it is also possible to continuously apply a current sufficient to excite the magnetic fluxes. It is also possible to install field windings on the rotor and apply current to them.

Additionally, as shown in FIGS. 38, 39, and 40, the 5-phase full-pitch winding motor of the 10S18R type utilizes one or more stator magnetic poles circumferentially separated to generate a counterclockwise (CCW) torque. Therefore, as shown in FIG. 17, the teeth circumferentially adjacent to the stator magnetic pole generating the torque can be utilized to allow the magnetic fluxes of that stator magnetic pole to pass through. This has the effect of reducing the magnetic resistance of the magnetic circuit within the stator and effectively generating a larger torque. In particular, to achieve a magnetic flux density of 2.0 [T] or higher near the air gap portion of the stator magnetic pole generating torque and thereby generate large torque, thus utilizing the adjacent teeth is effective. To utilize the circumferentially adjacent teeth, the bypass permanent magnets PMsbi mentioned earlier are required.

In addition, since the stator magnetic poles that generate the torque are separated by one or more circumferential distances defined by teeth or slots, the rotor magnetic poles that generate the torque are also separated by such circumferential distances, thereby resulting in minimal magnetic interference between or among the rotor magnetic poles. Furthermore, in the motor with a stator configuration of two magnetic pole pairs as shown in FIG. 38, the utilization rate of each transistor in the driving circuit is 4/5=0.8, which is a higher value. This also provides the advantage of simplifying the DC current drive. By reducing the total current capacity for the driving circuit, miniaturization and cost reduction are possible. Furthermore, the 5-phase full-pitch winding motor shown in FIG. 38 with a 10S18R configuration exhibits excellent torque continuity in terms of torque ripples. The circumferential width θsg of the stator magnetic poles and the circumferential width θrg of the rotor magnetic poles can be adjusted to optimize performance.

Another embodiment of Claim 5 will now be described with reference to FIGS. 41(a), (b), (c), (d) and (e). This is a linearly developed view showing the operations of a motor with a full-pitch winding of type 10S14R. This is an example where Ns is 2 in equation (57) and Nr is 3 in equation (58), and it is a type of 5-phase motor. A cross-sectional view of the 10S14R motor is not shown, but its stator is the same as that of the 10S18R stator in FIG. 38, and the rotor has the same structure but with 14 rotor magnetic poles. FIG. 41(a) is the same in configuration as that shown in FIG. 39, with the stator magnetic pole width θsg=360°/20=18°. In FIG. 41(b), a reference number 396 represents a rotor N magnetic pole, and the shape of each rotor magnetic pole facing the air gap at the rotor rotation angle θr=0° is shown. The pitch of the rotor magnetic poles is θppr=360/14=25.714°, and the width of the rotor magnetic poles, θrg, is the same as the stator magnetic pole width, θsg, at 18°. The distance between rotor magnetic poles is relatively large at 7.714°. Furthermore, as described above, these motors have a point-symmetric structure with respect to the rotor center point, including the full-pitch windings. For example, the A-phase stator magnetic pole and the A/-phase stator operate in the same manner. However, the directions of the current and the magnetic fluxes in the A-phase and A/-phase are not symmetrical because they are driven by direct current, and they are opposite to each other with respect to the rotor center point.

When θr=0°, as shown by the thick lines in FIG. 41(b), the A-phase and four C-phase stator magnetic poles generate a CCW torque. Similarly, when θr=7.7° in FIG. 41(c), the A phase generates a CCW torque. At θr=10.3° in FIG. 41(d), a CCW torque can be generated by the A-phase and D-phase. At θr=18.0° in FIG. 41(e), a CCW torque can be generated by the D-phase. By repeating this operation, the torque generation pattern completes one cycle at 51.43°, and when repeating seven cycles (360°), the rotor completes one revolution. With these characteristics, the torque can only be generated continuously using the two stator magnetic poles. However, the rotor magnetic pole width θrg of the 10S14R type can be expanded from 18° in FIG. 41 to a maximum of 25.714°, and the stator magnetic pole width θsg can also be expanded, thus enabling torque generation using four stator magnetic poles. However, since two stator magnetic poles are arranged circumferentially, one of the three full-pitch windings that are energized will experience increased copper loss. The current capacity of the transistors used also doubles. However, as long as the maximum current value is not exceeded, there is no issue with the transistor current capacity. When the motor outputs the maximum torque, there is an issue about the current capacity of the transistors.

Another embodiment of Claim 5 will now be described with reference to FIGS. 41(f), (g), (h), and (i). This is a linearly developed view showing the operations of a motor with full-pitch windings of 10S22R type. In this example, Ns is 2 according to equation (57) and Nr is 5 according to equation (58), and it is a type of 5-phase motor. The stator is the same as that of the 10S18R stator shown in FIG. 38, and the number of rotor magnetic poles is 22. The pitch θppr of the rotor magnetic poles shown in FIG. 41(f) is set to 360/22=16.364°. At θr=0°, as shown by the thick lines in FIG. 41(f), the four stator magnetic poles of the A-phase and E-phase generate a counterclockwise (CCW) torque. Similarly, at θr=6.5° in FIG. 41(g), the A-phase and B-phase generate a CCW torque. At θr=13.1° in FIG. 41(h), a counterclockwise torque can be generated by the B-phase and C-phase. At θr=19.6° in FIG. 41(i), a counterclockwise torque can be generated by the C-phase and D-phase. By repeating this operation, the torque generation pattern completes one cycle at 32.73°, and when performing 11 cycles, the rotor completes one revolution of 360°. With these characteristics, the torque can be generated continuously using four stator magnetic poles. Furthermore, since the stator magnetic poles generating the torque are separated by two or more circumferential positions, i.e., slot pitches, the two currents shown on the right-hand side of equations (80) to (84) do not overlap therewith, thereby reducing copper loss and lowering the current capacity of each transistor during the operation. Additionally, the winding utilization rate is 4/5, and the transistor utilization rate is also 4/5.

As described, Claim 5 describes the various examples of three-phase, seven-phase, and five-phase configurations. Furthermore, other phase configurations such as nine-phase, eleven-phase, and thirteen-phase configurations can be realized. As the number of phases increases, the configuration becomes more complex, but in principle, the motor does not become larger; rather, the load on motor components such as permanent magnets is reduced. The driving circuit also becomes more complex, but in principle, the total current capacity of the driving circuit does not increase. Furthermore, as the number of phases increases, control becomes more complex; however, due to recent advancements in microprocessors, such as increased speed, higher integration, and lower costs, the computational load on the control device has decreased. Additionally, the motor of Claim 5 can be partially deleted or added. Various modifications are also possible. For example, the number of stator magnetic pole pairs can be configured as 4, and stator magnetic poles corresponding to 2 pole pairs can be removed. The space created by the removal can be used to add stators from other types of motors. In other words, partial combinations of motor configurations are possible.

An embodiment of Claim 6 will now be described.

A cross-sectional view of a motor according to the embodiment of claim 6 is shown in FIG. 42. The motor configuration shown in FIG. 42 is a two-phase 4S10R configuration, with four stator magnetic poles and ten rotor magnetic poles. Claim 5, which is based on equations (57) and (58), the stator and rotor are configured such that their magnetic poles are evenly distributed circumferentially. In contrast, the circumferential arrangement of the stator magnetic poles in FIG. 42 is not evenly distributed. It is an uneven arrangement. Additionally, achieving continuous rotational torque with a two-phase DC current excitation stator magnetic pole is not straightforward. This motor is designed to operate in a single direction, with the stator magnetic poles having non-uniform magnetic characteristics, thereby enabling continuous torque in one direction. It is an asymmetric motor with non-symmetrical CCW and CW rotations.

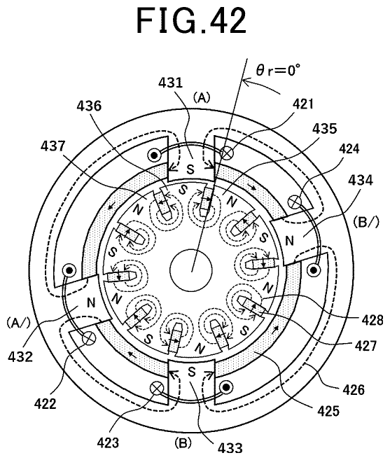

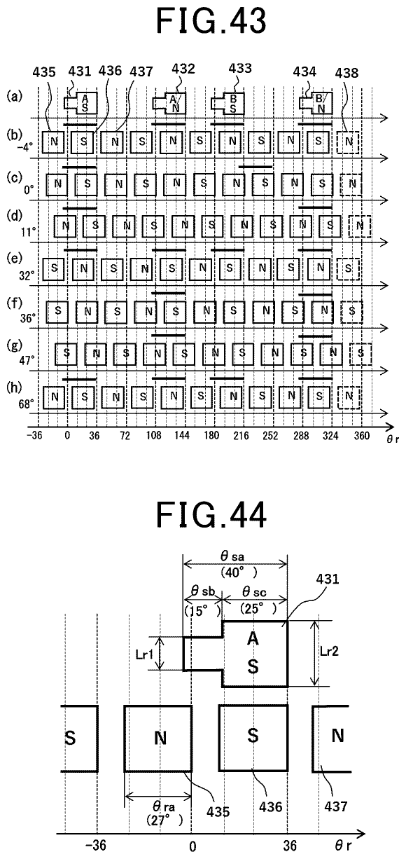

The shape of the air gap surface of the motor in FIG. 42 is developed linearly and shown in FIG. 43. FIG. 43 shows the circumferential positional relationship between the stator magnetic poles and the rotor magnetic poles, and is a linearly developed view showing the torque generation operations. In FIGS. 42 and 43, identical elements are denoted by the same symbols. FIG. 43(a) shows the air gap surface shape of the stator magnetic poles, while FIG. 43(b) shows the air gap surface shape of the rotor magnetic poles at a rotor rotation angle θr=−4°. In FIG. 42 and FIGS. 43(a) and (b), a reference number 431 indicates an A-phase stator S magnetic pole, a reference number 421 indicates an A-phase winding, a reference number 432 indicates an A/phase stator N magnetic pole, and a reference number 422 indicates an A/phase winding. A reference number 433 indicates a B-phase stator S magnetic pole, a reference number 423 indicates a B-phase winding, a reference number 434 indicates a B-phase stator N magnetic pole, and a reference number 424 indicates a B-phase winding. Each winding is composed of a concentrated winding. The respective stator magnetic poles are arranged circumferentially with the S magnetic poles and N magnetic poles alternately. Between the stator magnetic poles, each permanent magnet such as shown by a reference number 425, which indicates the polarities with arrows in the direction of the magnetic poles, are arranged. A reference number 426 indicates bias magnetic fluxes of the permanent magnets when no current is flowing through the stator.

FIG. 42 shows an example with one pair of stator magnetic poles to illustrate the basic shape. The shape of permanent magnets such as permanent magnets 425 is unusually long and arc-shaped. However, in actual motor designs, configurations with 3 pole pairs, 4 pole pairs, or even more pole pairs are considered. Therefore, the shape of the permanent magnets on the stator can also be designed as short, flat plates arranged circumferentially. Additionally, when the number of pole pairs is 2 or more, the imbalance in the attractive forces toward the center direction of the A phase and B phase can also be eliminated.

The number of magnetic poles shown in the rotor of FIG. 42 is 10 pieces, which is the same as those shown in FIG. 1, FIG. 14, and other figures. The rotor rotation position illustrated in FIG. 42 is θr=0°, which corresponds to a position (c) in the linearly developed view of FIG. 43. Reference numbers 435 and 437 indicate rotor N magnetic poles, and a reference number 436 indicates a rotor S magnetic pole. A reference number 427 indicates that permanent magnets such as 427, which indicate the polarities with arrows in the direction of the magnetic poles, are arranged between the rotor magnetic poles. A reference number 426 indicates bias magnetic fluxes of the permanent magnets when no current is flowing through the stator.

As described above, FIG. 43(a) shows an air gap surface shape of the stator magnetic poles as shown in FIG. 42. FIG. 43, (a) to (h) thereof, shows the air gap surface shapes of respective rotor magnetic poles at the respective rotor rotation positions. To illustrate the shapes and operations of each part of the motor shown in FIG. 42, partial enlargements of FIG. 43, (a) and (c) thereof, is shown in FIG. 44. In FIG. 44, a reference number 431 indicates an A-phase stator S magnetic pole, reference numbers 435 and 437 show rotor N magnetic poles, and a reference number 436 show an rotor S magnetic pole. These reference numbers are the same as those adopted in FIG. 42 and FIG. 43. The length of the rotor shaft in the CW direction at the leading end of the stator magnetic pole 431 is Lr1, which is small, and the length in the CCW direction is Lr2. Additionally, Lr1 is shown as an example of ½ of Lr2. The circumferential length of the portion Lr1 is θsb, and the circumferential length of the portion Lr2 is θsc.

The magnetic pole pitch θppr of the rotor is 36°, and in order to obtain continuous torque by driving the two phases composed of A-phase and B-phase alternately, the circumferential length θsa of the stator magnetic pole must be greater than the magnetic pole pitch θppr of the rotor, as shown in the following equation.

$$θ sa > θ ppr \qquad ( 95 )$$

The rotor rotates in the CCW direction, and the rotor shaft length Ora is greater than the aforementioned θsb in order to continue torque generation in the Lr1 portion. The following equation is a necessary condition.

$$θ ra > θ sb \qquad ( 96 )$$

Furthermore, in order for the rotor to rotate in the CCW direction and move a total distance greater than the rotor magnetic pole pitch θppr, the sum of θra and θsb must be greater than θppr, as shown in the following equation.

$$θ ra + θ sb > θ ppr \qquad ( 97 )$$

When the rotor rotates counterclockwise (CCW) and first generates torque, the following condition must be satisfied to prevent interference between the torques generated by the rotor magnetic poles 435 and 437: the sum of the circumferential lengths θra and θsa of the rotor magnetic poles must be less than twice the value of θppr.

$$θ ra + θ sa < 2 \times θ ppr \qquad ( 98 )$$

FIG. 43 and FIG. 44 show examples where θppr=36°, θsa=40°, θsb=15°, θs=25°, and θra=27°. In FIG. 44, the shape of a stator magnetic pole 431 is shown as a two-stage shape; however, other shapes, such as a trapezoidal shape, are acceptable as long as the axial length on the right side is greater than that on the left side when compared to the left side of the stator magnetic pole 431 in FIG. 44. Furthermore, in motors with two or more stator magnetic pole pairs, if the average value of multiple A-phase stator S magnetic poles has a magnetic resistance distribution similar to that of stator magnetic pole 431, and the magnetic resistance is smaller on the right side of the paper, a counterclockwise (CCW) torque can be generated. In addition, these magnetic resistance distributions may be formed not only on the air gap surface of the stator magnetic pole but also internally within the stator magnetic pole, provided that they exhibit the same magnetic resistance distribution as described above. In fact, creating an equivalent magnetic resistance distribution which is like a magnetic resistance distribution 431 by incorporating holes or slits in the electromagnetic steel plate within the stator magnetic poles is simpler than modifying the internal shape of the electromagnetic steel plate, thus making the manufacturing process easier and improving motor production efficiency.

FIG. 43, which is a diagram showing the operations of the motor in FIG. 42, will now be described. In FIG. 43(b), when the rotor rotates counterclockwise at a rotor rotation angle θr=−4°, a rotor N magnetic pole 435 approaches an A-phase stator S magnetic pole 431, and the rotor rotation angle θr at which a CCW torque can be generated is determined.

At the same time, an A/-phase stator N magnetic pole 432 approaches a rotor S magnetic pole, enabling the generation of a CCW torque. Additionally, at this rotation angle, a B-phase stator S magnetic pole 433 and a B-phase stator N magnetic pole 434 can also generate CCW torque. FIG. 43(c) shows the position where the rotor rotation angle θr=0°, where the B-phase stator S magnetic pole 433 and the B-phase stator N magnetic pole 434 can no longer generate the CCW torque. FIG. 43(d) shows the position where the rotor rotation angle θr=11°, where the rotor N magnetic pole 435 aligns with the right side of the stator S magnetic pole 431 in the drawing plane of the stator, at the portion where the rotor shaft length in the rotor axis direction is Lr2.

FIG. 43(e) shows a rotor rotation angle position θr=−32°, where the rotor is rotating counterclockwise (CCW), and the rotor N magnetic pole aligns with the B-phase stator S magnetic pole 433, thus enabling the generation of a CCW torque. At this time, the B-phase stator N magnetic pole 434 also aligns with the rotor S magnetic pole, thus enabling the generation of a CCW torque. The rotor rotates forward by a rotor magnetic pole pitch θppr=36° from the rotor rotation angle shown in FIG. 43(b) to reach a new rotor rotation angle θr. This new rotation position is also a position where the rotor N magnetic pole and the rotor S magnetic pole are swapped, compared to that shown in FIG. 43(b). FIG. 43(f) shows a position where the rotor rotation angle θr=36°, and the A-phase stator S magnetic pole 431 and the A/-phase stator N magnetic pole 432 can no longer generate a CCW torque. FIG. 43(g) shows a position where the rotor rotation angle θr=47°, and the rotor N magnetic pole aligns with the right side of the stator S magnetic pole 433 at a portion whose rotor axis-direction length is Lr2. FIG. 43(h) shows a position where the rotor rotation angle θr=68°, which is in the same state as that shown in FIG. 43(b), with the rotor having rotated 72° in the counterclockwise direction, which is twice the rotor magnetic pole pitch θppr. These operations are repeated five times, resulting in a rotor rotation angle θr of 360°, completing one full rotation of the rotor.

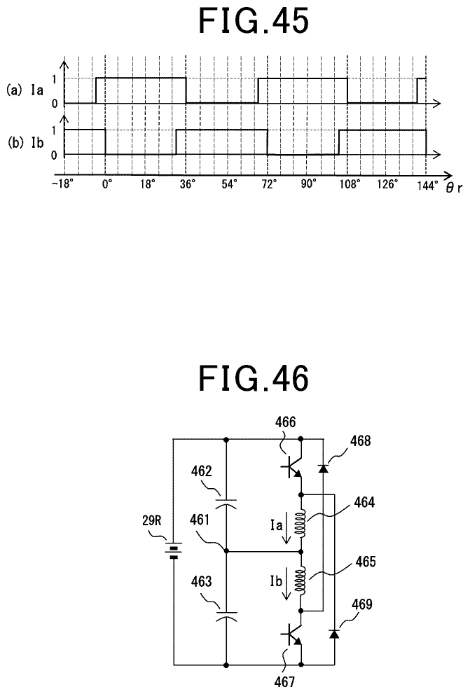

Next, examples of current waveforms driving the motors shown in FIGS. 42, 43, and 44 are shown in FIG. 45. The horizontal axis of FIG. 45 represents the rotor rotation angle θr. When the rotor rotates at a constant speed, the waveform is the same as that shown in FIG. 45 on the time axis. FIG. 45(a) shows the A-phase current Ia, which is applied in a range θr=−4° to θr=36° of the rotor rotation, and then again in a range of θr=68° to θr=108° of the rotor rotating angle. FIG. 45(b) represents a B-phase current Ib, which is a current phase-shifted by 36° relative to the A-phase current Ia, and has the same current waveform. The two currents, which are A-phase current Ia and B-phase current Ib, can continuously generate a torque in one direction only.

The driving circuits for the A-phase current Ia and B-phase current Ib can be energized using the two circuits shown in FIG. 25. In this case, a reference number 257 indicates a winding that connects the A-phase winding 421 and the A/phase winding 422 in series. A reference number 258 indicates a winding that connects the B-phase winding 423 and the B-phase winding 424 in series. The circuit can be driven simply using four transistors. Additionally, the circuit can be energized using the driving circuit shown in FIG. 46. Since it can be driven using two transistors, this is a simpler driving circuit. Reference numbers 462 and 463 indicate capacitors, and the point 461 is the neutral point of the circuit. A reference number 464 indicates a winding that connects the A-phase winding 421 and the A/phase winding 422 in series, and a transistor 466 supplies the A-phase current Ia. A reference number 465 indicates a winding that connects the B-phase winding 423 and the B-phase winding 424 in series, and a transistor 467 supplies the B-phase current Ib. Reference numbers 468 and 469 indicate diodes for the circuit. Additionally, the capacitors 462 and 463 can be replaced with two DC power sources, which are a power source whose output voltage is positive and a further power source whose output voltage is negative. In this way, unidirectional rotation can be achieved with the simple configurations shown in FIG. 42, FIG. 43, FIG. 44, FIG. 45, and FIG. 46. Unidirectional rotation has many applications, and there is a demand for simpler configurations and lower costs in many cases.

In the two-phase motor 4S10R shown in FIG. 42, the number of phases of the stator magnetic poles (Ps) is Nph=2. A phase difference between the two stator magnetic poles and the rotor magnetic poles is set to half the sum of the pitch angles θppr of the N magnetic pole rotor magnetic poles and the S magnetic pole rotor magnetic poles. That is, (2×θppr)/Nph=θppr. In the two-phase motor 4S10R shown in FIG. 42, the number of rotor magnetic poles can be increased, and other motor components can be present on the circumference of the stator magnetic poles. In a three-phase motor, the number of phases is Nph=3, and a relative phase difference between the three-phase stator magnetic poles and the rotor magnetic poles should be arranged such that (2×θppr)/Nph=⅔×θppr. In a four-phase motor, the number of phases is Nph=4, and a relative phase difference between the four-phase stator magnetic poles and the rotor magnetic poles should be arranged such that (2×θppr)/Nph=¼×θppr. That is, a relative phase difference between the rotor magnetic poles should be set to 0, ¼×φppr, 2/4×φppr, and ¾×φppr.

Furthermore, when the number of stator magnetic poles Nps is set to Nps=2+4×Ns according to equation (57), and the number of rotor magnetic poles Npr is set to Npr=2+4×Nr according to equation (58), and each is uniformly arranged circumferentially, as shown in FIG. 26, FIG. 32, and FIG. 38, the full-pitch windings can be evenly distributed. However, the electromagnetic characteristics of the motor of the present invention arise from the relative relationship between multiple stator magnetic poles and multiple rotor magnetic poles that are oppositely arranged through an air gap. Therefore, there are cases where a different number of rotor magnetic poles from that given by equation (58) is effective for multiple stator magnetic poles. For example, when the number of stator magnetic poles Nps=14 with Ns=3 in equation (57), the number of rotor magnetic poles Npr=24 may not follow equation (58). This motor has a configuration with two fewer rotor magnetic poles, compared to the configuration in FIG. 32. In this case, the polarities of the rotor magnetic poles on the opposite side of the rotor by 180° becomes the same, which causes issues with driving in full-pitch windings. As an example of a solution to this problem, the 14 stator magnetic poles arranged circumferentially are divided into two groups of seven, and a space equivalent to one rotor magnetic pole is provided at two locations between the two groups. Additionally, the number of rotor magnetic poles is increased by two, resulting in Npr=24+2=26.

As a result, 7 stator magnetic poles in one group are opposed to 12 rotor magnetic poles through an air gap, and the 7 stator magnetic poles in the other group are opposed to the 12 rotor magnetic poles through the air gap. Furthermore, the polarity of the rotor magnetic poles facing the A/-phase stator magnetic pole is opposite to the polarity of the rotor magnetic poles facing the A/-phase stator magnetic pole. The same is applied to the stator magnetic poles of the other phases. Thus, a full-pitch winding drive is possible. The electromagnetic characteristics and torque characteristics of the configuration where 12 rotor magnetic poles are opposed to 7 stator magnetic poles through the air gap are obtained. Additionally, the ratio of the rotor magnetic pole width to the stator magnetic pole width is related to the shape and characteristics of the permanent magnets PMrbi arranged on the rotor.

An embodiment according to claim 7 will now be explained.

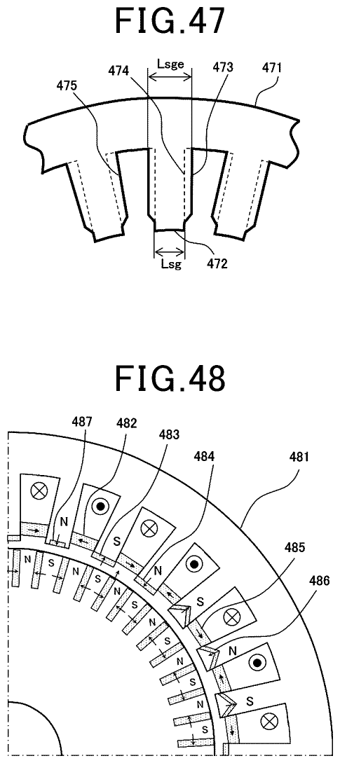

In FIG. 47 of the embodiment, a reference number 471 indicates a portion of the stator shown in FIG. 3, in which the circumferential width of the teeth is enlarged. Left and right portions in FIG. 47 are omitted as indicated by the wavy lines, and the winding, rotor, etc. are also omitted. The teeth of the three stator magnetic poles shown in FIG. 34 are illustrated by broken lines 474 in FIG. 47. A reference symbol Lsg indicates a circumferential width of the air gap surface of the stator magnetic pole. The lines 474 show the shape obtained by enlarging the circumferential width of the teeth on the outer diameter side of the stator magnetic pole Ps. The circumferential width of the tooth is enlarged from Lsg to Lsge. Furthermore, as shown by lines 475, the shape of the tooth can be varied, such as being tapered.

In the figures such as FIG. 1, FIG. 9, and FIG. 11(b) of the present invention, in a motor configuration where permanent magnets are not arranged on the stator, the magnetic paths for passing the magnetic fluxes on the rotor side is sufficiently ensured. However, the circumferential tooth width of each stator magnetic pole is narrow, resulting in low magnetic flux passage capacity. As shown by the line 473 in FIG. 47, the circumferential length Lsg of the magnetic pole facing the air gap portion of the stator magnetic pole Ps is set to a value that is 20% or larger than the circumferential width of the tooth of the stator magnetic pole Ps. For example, by expanding the tooth width by 20%, the magnetic flux density in the air gap portion of the stator magnetic pole can be increased by 20%. In this case, according to equation (19), the force increases as the square of the magnetic flux density, potentially increasing the torque 1.44 times, i.e., an increase of 44%.

An embodiment according to claim 8 will now be described with reference to FIG. 48.

FIG. 48 shows an enlarged view of the upper right portion of the motor 14S26R shown in FIG. 34, corresponding to the first quadrant. Various shapes of permanent magnets are shown at the tips of each tooth. The motors of the present invention, such as those shown in FIG. 1, FIG. 14, and FIG. 34, are constructed with stator magnetic poles and rotor magnetic poles made of soft magnetic members. Therefore, in principle, magnetic fluxes must be excited to generate torque. The driving circuit must supply magnetic energy to the motor during a time span of torque generation and subsequently recover and regenerate that magnetic energy. Since this burden is significant and poses a problem. To reduce this magnetic energy burden, permanent magnets such as indicated by reference numbers 483 and 484 can be mounted near the air gap surface of the stator magnetic poles on the stator 481 shown in FIG. 48. The orientation of permanent magnets 483 and 484 corresponds to the polarity direction of each stator magnetic pole, as indicated by the arrows in FIG. 48. By using permanent magnets 483 and 484, the excitation load on the motor and driving circuit can be reduced, thereby enabling miniaturization of the stator. Additionally, reducing the excitation load leads to shorter magnetic excitation times, which improves the motor control performance.

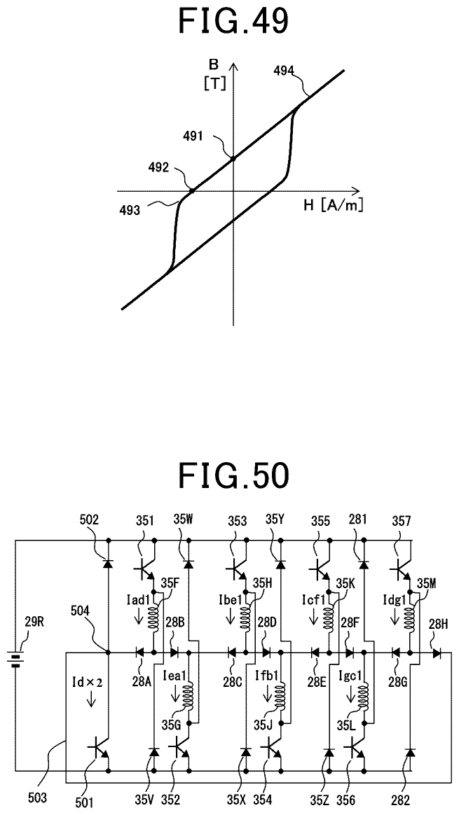

Permanent magnets such as 483 and 484 can be made thin in shape, and their thickness can be limited to the extent necessary to assist the magnetic excitation of each stator magnetic pole. For example, in the case of the magnetic characteristics of permanent magnets shown in FIG. 49, assuming that a horizontal axis represents the magnetic field strength H [A/m], a vertical axis represents the magnetic flux density B [T], and the residual magnetic flux density 491 is 1.5 [T], the following conditions can be considered. In this state, even if the magnetic flux density 494 in the region with a high magnetic flux density exhibits a small value close to 1, the motor can be used by applying a large exciting current to excite this region. In particular, in the motor according to the present invention, a large magnetic flux density exceeding 2.0 [T] near the air gap of each stator magnetic pole is also assumed. Furthermore, depending on the motor control conditions, even if the permanent magnets demagnetize while operating at the point of the coercive force 492 or in the region 493, the motor can be easily re-magnetized by the motor current and continue to operate. Additionally, the shape of the permanent magnets 483 and 484 can be reduced as part of the stator magnetic pole end, as shown by a reference number 487. The shape can also be designed to increase the magnetic flux, as shown by a reference number 486. Furthermore, the permanent magnets 482 and 485 between the stator magnetic poles and the foregoing permanent magnets 483, 484, 486, and 487 can be integrated and manufactured as a single unit. Furthermore, the configuration and function of the permanent magnets 483, 484, 486, and 487 can also be applied to the rotor magnetic poles on the rotor side.

Claim 9 according to the present invention will now be described.

Claim 9 relates to a driving circuit for driving a full-pitch winding motor. Specific examples of the driving circuit have already been shown and explained in FIG. 29 for a three-phase driving circuit and in FIG. 35 for a seven-phase driving circuit. In the three-phase motor, as shown with equations (48), (49), and (50), the magnetic fluxes of all phases are interlinked with the full-pitch windings, which require to analyze voltages in a complicated manner. In particular, during regeneration, the voltages of the full-pitch windings for the phases become negative relative to the power supply voltage, inducing the same voltages in the full-pitch windings being driven, which prevents currents increase and causes an overvoltage problem. In the three-phase driving circuit shown in FIG. 29, equations (54), (55), and (56) are used to connect two windings in series, thereby resolving the overvoltage issue and demonstrating the method for applying current to each full-pitch winding of each phase of the three-phase motor as shown in FIG. 27.

For a 7-phase motor, similarly, as shown in equations (66) to (72), the magnetic fluxes of all phases interlink with the full-pitch windings, resulting in a complex voltage analysis. In the 7-phase driving circuit shown in FIG. 35, equations (73) to (79) are used to connect two windings in series, thereby resolving the issue of overvoltage, and the method for supplying current to each full-pitch winding of each phase of the 7-phase motor is shown in FIG. 36. For a 5-phase motor, since it is equivalent to removing two phases compared to a 7-phase motor, the current can similarly be supplied to each full-pitch winding of each phase.

FIG. 35 shows an example of driving a 28S52R type of motor (FIG. 34) with two stator magnetic pole pairs (FIG. 32) for a 7-phase driving circuit. In this case, the 28S52R motor (FIG. 34) has many rotor magnetic poles, which is advantageous for high-speed rotation. Additionally, the 7-phase driving circuit shown in FIG. 35 has a large number of transistors and the number of currents to be controlled. The reason for the large number of transistors is that the number of full-pitch windings, which are related to 3-phase, 5-phase, and 7-phase configurations, becomes an odd number (3, 5, or 7) when the number of stator magnetic pole pairs is 1. That is, as shown in FIG. 35, when two windings are arranged in series vertically in the drawing paper and aligned from left to right, both the leftmost and rightmost windings end up on the upper side, thus making it impossible to connect the leftmost 30 and rightmost windings, as shown by a line 28Q in FIG. 35. If the number of stator magnetic pole pairs is set to 2, the number of windings becomes even (6, 10, or 14). As shown in the three-phase driving circuit shown in FIG. 29 and the seven-phase driving circuit shown in FIG. 35, the entire circuit can be configured with a symmetrical structure. Although the number of components in the driving circuit increases, each phase can be controlled in a balanced manner.

A method for reducing the number of components in the 7-phase driving circuit shown in FIG. 35 will now be described with use of the driving circuit is shown in FIG. 50. This circuit can drive a 7-phase motor such as the one shown in FIG. 32 with one stator magnetic pole pair. Alternatively, for motors with two or more stator magnetic pole pairs, the windings of the same phase can be connected in series for driving. The 7-phase driving circuit shown in FIG. 50 is obtained by removing the right half of the driving circuit shown in FIG. 35. Other components are shown with the same symbols.

The cathode of a diode 28H is connected to a position 504, i.e., connected to the position 504 via the connection of a line 503. In FIG. 50, a transistor 501 and a diode 502 are added to supply the (Id×2) current, which is the sum of the D-phase current component Id of the (Ia+Id) current supplied to the AD-phase winding 35F and the D-phase current component Id of the (Id+Ig) current supplied to the DG-phase winding 35M.

In FIG. 50, the foregoing problem of odd numbers about the seven phases is solved by passing the two D-phase current components Id through the transistor 501. The voltage of the AD-phase winding 35F associated with the D-phase current component Id is the value given by equation (66), and the voltage of the DG-phase winding 35M is the value given by equation (69), thus resulting in a large voltage caused in both windings. However, since the transistor 501 is directly driven by the DC power source 29R, there is a voltage margin of twice the required value, allowing the D-phase current component Id to be conducted. Since the D-phase current component Id has different conditions from the current components of other phases, so that care must be taken in control thereof. Additionally, the diodes 28A, 28B, 28C, 28D, 28E, 28F, 28G, and 28H provided in FIG. 35 and FIG. 50 can be partially or completely removed depending on circuit conditions.

Furthermore, when comparing the driving circuits in FIG. 35 and FIG. 50, the seven transistors 351 to 357 in FIG. 50 require twice the current, compared to the 14 transistors 351 to 35E in FIG. 35, on condition that the same motor power is required. When considering the total current capacity, the two circuits have the same current capacity.

However, in the driving circuit shown in FIG. 50, the transistor 501 and diode 502 have been added. As a result, the driving circuit becomes more complex in this regard. That is, while the number of components in the driving circuit shown in FIG. 50 is reduced, when considering the total current capacity of transistors alone, FIG. 50 has a larger current capacity compared to that in FIG. 35. Both have their own characteristics and can be used appropriately.

FIG. 51 shows an example of a driving circuit with fewer components, created using the same method as FIG. 50, for the three-phase driving circuit in FIG. 29. The three-phase driving circuit shown in FIG. 51 is obtained by removing the right half of the driving circuit in FIG. 29. The remaining components are denoted by the same symbols. Additionally, the cathode of diode 29M is connected to a position 414, i.e., to the position 514 via a connection 513. In FIG. 51, the transistor 511 and diode 512 are added, and the (Ia+Ib) A-phase current component Ia of the current flowing through the AB-phase winding 297 and the (Ia+Ic) A-phase current component Ia of the current flowing through the CA-phase winding 299 are supplied with a current equal to (Ia×2). Diodes 29Q, 29K, 29M, and 29L may be partially or completely removed depending on the circuit conditions.

Additionally, the driving circuits shown in FIG. 29 and FIG. 51 can be compared with each other in terms of the following point. The six transistors 291 to 296 in FIG. 29 require twice the current, compared to the three transistors 291 to 293 in FIG. 51, when considering the same motor power. The total current capacity of the six transistors in FIG. 29 and the three transistors in FIG. 51 is the same. However, in the driving circuit shown in FIG. 51, the transistor 511 and diode 512 have been added, so that the total current capacity is increased compared to that of FIG. 29. In other words, although the driving circuit in FIG. 51 has fewer components, when considering the total current capacity of transistors alone, it is larger than that in FIG. 29. Both have their own characteristics and can be used. Additionally, similar configurations can be applied to driving circuits with other phases such as 5 phases, 9 phases, or 11 phases.

Claim 10 of the present invention will now be described.

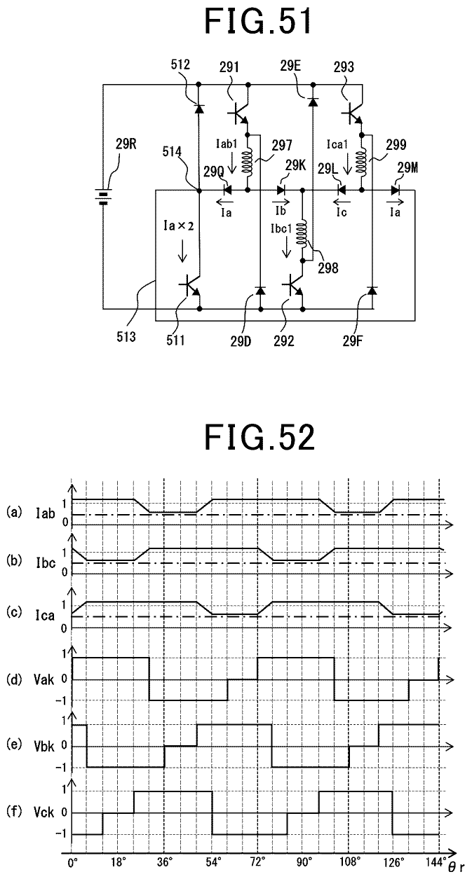

Claim 10 relates to a motor that continuously supplies a current component Ifk sufficient to excite magnetic fluxes to each stator winding and superimposes a current component It equivalent to torque on each phase current, with an example shown in FIG. 52. Previously, an example of applying the phase currents shown in FIG. 28 to the full-pitch winding motor of 6S10R shown in FIG. 26 has been explained. FIG. 28 shows the example of applying the phase currents Iab, Ibc, and Ica according to the rotor rotation position θr. For example, an example is explained where the current Ifk [A] shown by a dashed line is applied to each phase winding as Iab in FIG. 52(a), Ibc in FIG. 52(b), and Ica in FIG. 52(c). As can be seen from the positional relationship in FIG. 26, a magnetomotive force due to Ifk [A] acts on the path of the A-phase magnetic flux φa between the A-phase stator S magnetic pole 11 and the A/-phase stator N magnetic pole 14, as the sum of the currents of each phase. On the other hand, the magnetic characteristics of the rotor, as shown in FIG. 16, FIG. 17, FIG. 18, and FIG. 19, allow magnetic fluxes to be easily excited and generated in the magnetic forward direction of the rotor magnetic poles. However, the rotor magnetic flux generated in the magnetic reverse direction is small.

In this explanation, the motor model is simplified by assuming that no rotor magnetic flux is generated in the magnetic reverse direction.

In this case, the A-phase magnetic flux φa passes through the position where the A-phase stator pole S magnetic pole 11 faces the rotor N magnetic pole through the air gap. As described above, the circumferential width θsg of the stator magnetic pole shown in FIG. 26 and the circumferential width θrg of each of the rotor magnetic poles are set to 30°. Hence, when the rotor rotation angle θr=0°, the magnetic flux φa begins to generate, reaches its maximum at θr=30°, gradually decreases, and becomes zero at θr=60°. In this state, the value of the A-phase voltage Vak component becomes as shown in FIG. 52(d), and can be transformed into the following equation using equation (34).

$$Vak = N w \times d φ a / dt = Nw \times d ( φ a / d θ r \times d θ r / dt \qquad ( 99 )$$

$$Vbk = Nw \times d φ b / d θ r \times d θ r / dt \qquad ( 100 )$$

$$Vck = Nw \times d φ c / d θ r \times d θ r / dt \qquad ( 101 )$$

An increase or decrease in the A-phase magnetic flux φa is associated with the rotation of the rotor and is not caused by a sudden decrease in the magnetic flux due to a sudden decrease in the A-phase current Ia. Therefore, it does not result in a large reverse voltage reaching the power supply voltage during regeneration. In this state, the value of the A-phase voltage Vak is proportional to the rotational speed of the rotor, dθr/dt, similarly to the induced voltage of a surface magnet type synchronous motor (SPMSM). Furthermore, the magnetic energy accumulated in the magnetic flux φath for the A-phase magnetic flux φa at the rotor rotation position θr=30° is regenerated to the DC power source during the interval from θr=30° to 60°, as provided by the product between a negative voltage shown in FIG. 52(d) and a constant value Ifk [A] indicated by a dashed line drawn with the current Iab in FIG. 52(a).

Similarly, a magnetomotive force of a constant value Ifk [A], indicated by a dashed line, acts on the path of the B-phase magnetic flux φb between the B-phase stator S magnetic pole 13 and the B/-phase stator N magnetic pole 16. The value of the B-phase voltage Vbk calculated by equation (100) is provided in FIG. 52(e). A magnetomotive force of a constant value Ifk [A], indicated by a dashed line, acts on the path of the C-phase magnetic flux φc between the C-phase stator S magnetic pole 15 and the C/-phase stator N magnetic pole 12. The value of the C-phase voltage Vck calculated using Equation (101) is provided in FIG. 52(f). Moreover, the phase voltages Vab, Vbc, and Vca across the full-pitch windings are related by equations (51), (52), and (53) as well as equations (54), (55), and (56), and are provided in FIGS. 52(d), (e), and (f).

To generate torque using the motor shown in FIG. 26, subtract the current components corresponding to the magnetic flux excitation from Iab, Ibc, and Ica in FIGS. 28(a), (b), and (c), respectively, and add them to the current shown by the dashed line in FIG. 52. This results in current values similar to the solid lines in FIGS. 52(a), (b), and (c). Under these operating conditions, assuming that the current values of the dashed lines in FIG. 52 are sufficiently large, the magnetic characteristics of the soft magnetic member are ideal as shown by the solid lines in FIG. 6, and that no rotor magnetic flux is generated in the magnetic reverse direction as described above, and that the magnetic fluxes from the permanent magnets also remains unchanged. Under this assumption, the voltage across each winding remains unchanged from the voltages shown in (d), (e), and (f) of FIG. 52.

However, in reality, the magnetic characteristics are all nonlinear and complex, not the assumed characteristics, so that the voltages shown in FIGS. 52(d), (e), and (f) become voltages mixed with the voltage components in FIGS. 24(d), (e), and (f). In any case, by continuously applying a constant current Ifk [A] indicated by the dashed lines in FIGS. 52(a), (b), and (c), it is possible to reduce the magnitude of the voltage applied to the motor to induce magnetic energy and the voltage regenerated back to the power source. Furthermore, as an example of the drawbacks associated with the voltage changes caused by the application and regeneration of magnetic energy, there is an issue of restricted current flow of the torque current component, but this problem can be reduced.

It is possible to magnetically excite each stator magnetic pole by continuously energizing the DC exciting current component in each phase winding. The reason for this is that the polarities of the N and S magnetic poles for each stator magnetic pole is fixed, and the current to each winding is a one-way DC current. In contrast, this is difficult to achieve with an AC current-driven motor. The same is true for the concentrated windings winding shown in FIG. 23 instead of the full-pitch winding shown in FIG. 26. The magnitude of the continuously energized current component is variable. For example, the magnitude of the continuously energized exciting current component can be reduced to decrease the induced voltage at high speeds.

A field current component may be energized by additionally arranging a field winding that energizes the field current component to the stator magnetic pole. The field current component may also be energized by arranging an additional field winding to the rotor. Another method to reduce the rate of reduction of motor magnetic fluxes and to reduce a regenerative voltage to be induced in the full-pitch windings of the other phase is to provide a second power supply smaller than the power supply voltage and to be connected to a diode for regenerative use.

Another method to reduce the rate of reduction of motor magnetic fluxes is to provide a third connection terminal in the middle of each winding in addition to the first terminal on the low voltage side and the second terminal on the high voltage side, so that power supply is done at the third connection terminal and regeneration is done at the second terminal. If it is desired to shorten the regenerative time, the connection relationship can be reversed. These variations can also be applied to the present invention.

Claim 11 according to the present invention will now be described.

The purpose of claim 11 is to reduce the number of transistors to be installed in the driving circuit that drives the motor current. The motor with concentrated windings, which is type of 6S10R, shown in FIG. 1 and FIG. 23 supplies currents to respective phases using the driving circuit shown in FIG. 25, which is described as above. In this case, two transistors are used to drive a single direct current.

In contrast, as shown in the example of FIG. 46, in a driving circuit configured with a positive power supply 462 and a negative power supply 463 centered on the neutral point 461, a single direct current can be driven by a single transistor. Although two power supplies (positive and negative) are required, the driving of individual currents becomes simpler.

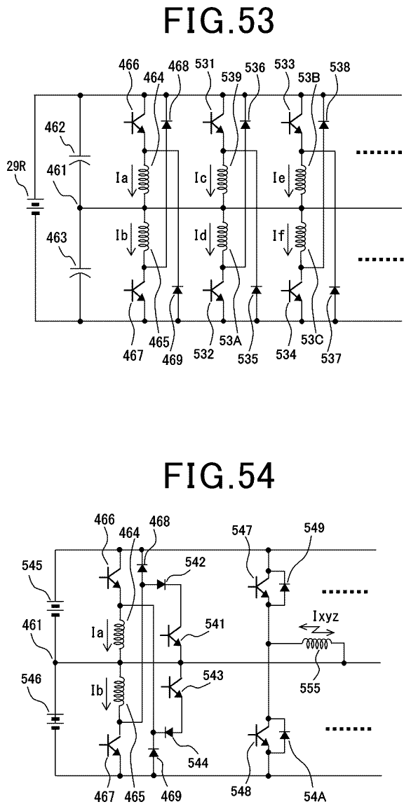

FIG. 53 shows a driving circuit which adopts the configuration shown in FIG. 46 with the following additions. Specifically, a current Ic flows through a transistor 531 to a winding 539, a current Id flows through a transistor 532 to a winding 53A, a current Ie flows through a transistor 533 to a winding 53B, and a current If flows through a transistor 534 to a winding 53C. Reference numbers 535, 536, 537, and 538 show diodes for regeneration. Additionally, windings and driving circuits can be added in parallel. Since a single transistor can drive the direct current flowing through the single winding, the motor driving circuit can be simplified by including the peripheral circuit required to drive the transistor.

A breakdown voltage required for each transistor in FIG. 53 is twice the voltage of one of the power supplies shown in FIG. 53. Compared to the driving circuit shown in FIG. 25, the number of transistors is halved, but the voltage is doubled, resulting in that it can be considered equivalent in terms of the product of current and voltage. However, from the perspectives of cost, space requirements, and size, including peripheral circuits, the configuration with fewer transistors as shown in FIG. 53 is more advantageous. Moreover, for power devices such as IGBTs and power MOSFETs, there are many cases where the cost does not increase significantly even if the voltage rating is doubled, and the size of the power device often depends on the current value. In addition, the voltage imbalance between capacitors 462 and 463 can be balanced using various methods, such as adjusting a current flowing through each capacitor or using the windings to move the charge. Even in the case of odd-phase windings, there are methods such as dividing a single-phase winding.

Additionally, in the driving circuit shown in FIG. 53, it is possible to either apply no voltage, apply the power supply voltage, or perform power regeneration to the power supply. However, the flywheel operation, which involves the circulation of the winding current, cannot be achieved.

An example of a driving circuit that requires this flywheel operation is shown in FIG. 54. Transistors 466 and 467 are the same as those in FIG. 53, with additional transistors 541 and 543 for the flywheel function. During flywheel operation, turning on the transistor 541 or 543 enables the flywheel operation. Diodes 542 and 544 block reverse direction voltages and currents. In FIG. 54, instead of the capacitors 462 and 463 provided in FIG. 53, examples of DC power sources 545 and 546 are shown. In FIG. 53 and FIG. 54, a DC power source such as a battery can also be used.

Claim 12 of the present invention will now be explained.

In each motor shown as an example of the present invention, there have been described a motor configuration, driving circuit, and driving method that supplies unidirectional electric current, i.e., direct current, to each winding of the stator. By adding a reverse direction driving circuit Drhv to this unidirectional drive circuit, it is possible to supply both positive and negative currents to each winding of the stator. When the current in each winding is unidirectional electric current, as shown in FIG. 38, the polarities of the N magnetic poles and S magnetic poles of each stator magnetic pole are fixed. On the other hand, if positive and negative currents can be supplied to each winding, it is obvious that the polarities of the N magnetic poles and S magnetic poles of each stator magnetic pole can be changed. If the polarities of the N magnetic poles and S magnetic poles of the stator magnetic pole can be changed, the opportunity at which torque is generated can be doubled. However, in this case, the stator configuration cannot accommodate the permanent magnets PMsbi positioned between the stator magnetic poles. Alternatively, the magnetic properties of the permanent magnets Pmsbi must be weakened.

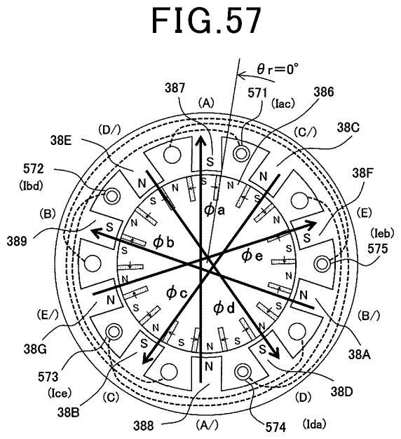

FIG. 57 shows a cross-sectional view of a 10S18R type of motor, which is an example of a motor capable of conducting both positive and negative currents. The motor shown in FIG. 57 is a modification of the 10S18R motor shown in FIG. 38, which is driven by unidirectional electric current using stator magnets PMsbi, to a motor driven by positive and negative bidirectional currents. Double-circled winding symbols shown in FIG. 57 indicate that a current flows from the front side of the paper to the back side thereof when the current value is positive. In contrast, single-circled winding symbols shown in FIG. 57 indicate that a current flows from the back side of the paper to the front side thereof when the current value is positive.

The connection of the coil ends of each full-pitch winding are shown by dashed lines. The polarities of the N magnetic poles and S magnetic poles attached to each stator magnetic pole, as well as the magnetic flux components φa, φb, φc, φd, and φe for each phase, correspond to the polarities and directions of the magnetic fluxes when the exciting current components Ia, Ib, Ic, Id, and Ie for each phase stator magnetic pole are positive values, as shown in Equations (80) to (84). In this configuration, a reference number 571 indicates an AC-phase winding through which an AC-phase current Iac flows, a reference number 572 indicates a BD-phase winding through which a BD-phase current Ibd flows, a reference number 573 indicates a CE-phase winding through which a CE-phase current Ice flows, a reference number 574 indicates a DA-phase winding through which a DA-phase current Ida flows, and a reference number 575 indicates an EB-phase winding through which an EB-phase current Ieb flows. The remaining components are the same as those in the 10S18R type of motor shown in FIG. 38. The motor shown in FIG. 57 does not have stator magnets as understood from the figure. Additionally, the motor shown in FIG. 57 can increase the maximum value of the passing magnetic flux by modifying the shape of the stator magnetic poles or changing the material, as shown in FIG. 47.

As shown in FIG. 57, by making modifications and adding the reverse direction driving circuit Drhv, it is possible to apply currents in both positive and negative directions.

The same applies to other motors. Additionally, as an example of motor torque characteristics, the linearly developed view of the 10S14R motor shown in FIG. 41, (a) to € thereof, represents a case where torque generation opportunities are limited. Compared to the 10S18R motor shown in FIG. 38 and FIG. 39, there is an issue where the output torque is reduced.

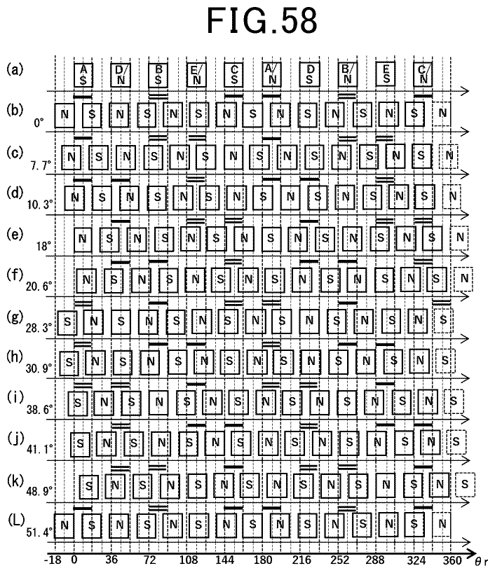

FIG. 58 shows an example of improving the problem of low torque, by modifying the 10S14R type of motor shown in FIG. 41, so that each phase current can be supplied with both positive and negative values, and illustrates the linearly developed view of its operation. The overall configuration and shape of the motor shown in FIG. 58 are derived from the full-pitch windings shown in FIG. 57, with the windings modified to concentrated windings and the number of rotor magnetic poles reduced to 14.

Additionally, like FIG. 57, the stator does not include the permanent magnets PMsbi described before. FIG. 58(a) shows the shape of the air gap surface obtained by linearly expanding the stator magnetic poles of a 5-phase motor of 10S14R type, and the polarities of the N magnetic poles and S magnetic poles of the stator magnetic poles are indicated as A, B, C, D, and E for identification and reference when the current in each winding is a positive value of the unidirectional electric current. FIG. 58(b) shows the areas where each stator magnetic pole can generate a CCW torque at the rotor rotation angle θr=0°, with thick lines indicating the areas where A-phase and A/-phase, and C-phase and C/-phase can generate a CCW torque. Additionally, when the exciting currents of the stator magnetic poles are reversed to their negative currents, the areas where the CCW torque can be generated are indicated with double thick lines, written as B-phase and B/-phase. In FIG. 58(b), combining the thick lines and double thick lines, the CCW torque can be generated at six stator magnetic pole positions. The D phase and D/phase are also capable of generating a CCW torque in a strictly motor model sense, but the remaining rotation angles are negligible, and to avoid confusion, double thick lines are not drawn.

Similarly, in FIG. 58(c), at the rotor rotation angle θr=7.7°, the A-phase and A/-phase stator magnetic poles can generate a CCW torque, and are indicated by thick lines. The polarity of the stator magnetic poles are reversed to generate a CCW torque in the B-phase and B/-phase, and E-phase and E/-phase regions, which are indicated by double thick lines. In FIG. 58(c), the thick lines and double thick lines are combined to indicate that the CCW torque can be generated at six stator magnetic pole positions. Similarly, FIG. 58(d) corresponds to θr=10.3°, FIG. 58(e) to θr=18°, FIG. 58(f) to θr=20.6°, FIG. 58(g) to θr=28.3°, and FIG. 58(h) to θr=30.9°. FIG. 58(i) corresponds to θr=38.6°, FIG. 58(j) corresponds to θr=41.1°, and FIG. 58(k) corresponds to θr=48.9°, respectively, thereby enabling the generation of a CCW torque at six stator magnetic poles, respectively. FIG. 58(d) shows the rotor rotation angle θr=51.4°, which is the same state as that of FIG. 58(b). This cycle is repeated seven times for one rotation of the rotor.

In FIG. 58, the 10S14R motor configuration supplies both positive and negative currents to each concentrated winding, resulting in twice the number of current supply opportunities, compared to the unidirectional electric current configuration shown in FIG. 41.

In other words, each stator magnetic pole shown in FIG. 58 can generate torque for most of the time. Additionally, the windings of the motor shown in FIG. 58 can also be configured as full-pitch windings. However, care must be taken regarding the induced voltage in the full-pitch windings caused by the interaction with the excitation of the adjacent stator magnetic poles and the magnetic flux components of other phases.

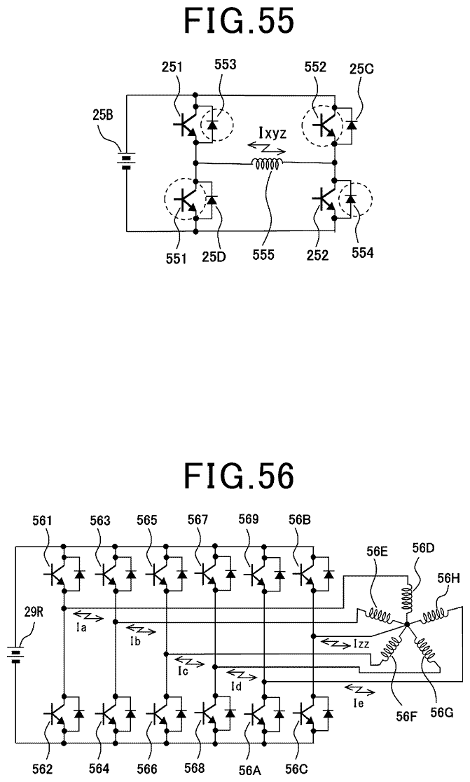

FIG. 55 shows an example of adding a reverse direction driving circuit Drhv to the unidirectional drive circuit Dhv, which is composed of the transistors 251 and 252 and diodes 25C and 25D shown in FIG. 25, to allow reverse direction currents to flow. In FIG. 55, the transistors 551 and 552, and the diodes 553 and 554, enclosed by the dashed circles, form the reverse direction driving circuit Drhv, which is added to the unidirectional drive circuit shown in FIG. 25. FIG. 55 shows the resulting driving circuit that conducts positive and negative bidirectional currents. By controlling the on/off states of the transistors 251, 551, 552, and 252, positive and negative currents Ixyz can be applied to a winding 555. These transistors are connected in parallel with reverse-conducting diodes 553, 25D, 25C, and 554. Additionally, as another example of the driving circuit, transistors 547 and 548 shown in FIG. 54 can supply positive and negative currents Ixyz to the winding 555. Reference numbers 549 and 54A show reverse-conducting diodes.

In FIG. 54, since the drive can be performed by two DC power sources 545 and 546, one positive and one negative current can be controlled by the two transistors. In this case, the unidirectional drive circuit Dhv corresponds to the transistor 547 and reverse-conducting diode 54A, while the reverse direction driving circuit Drhv corresponds to the transistor 548 and reverse-conducting diode 549. Additionally, while FIG. 55 and FIG. 54 only show a single-phase driving circuit, the same driving circuit can be added in parallel according to the number of phases to realize the entire motor driving circuit.

Additionally, other examples of the driving circuit for a 5-phase motor, which is exemplified in such FIG. 58, are shown in FIG. 56. A reference number 56D indicates a winding that connects the A-phase winding and the A/-phase winding in series, and transistors 561 and 562 conduct the A-phase current Ia. A reference number 56E indicates a winding that connects the B-phase winding and the B/-phase winding in series, and transistors 563 and 564 conduct the B-phase current Ib. A reference number 56F indicates a winding that connects the C-phase winding and the C/-phase winding in series, and transistors 565 and 566 conduct the C-phase current Ic. A reference number 56G indicates a winding that connects the D-phase winding and the D/-phase winding in series, and transistors 567 and 568 conduct the D-phase current Id. A reference number 56H indicates a winding that connects the E-phase winding and the E/-phase winding in series, and transistors 569 and 56A conduct the E-phase current Ie. Transistors 56B and 56C are connected to the interconnection point of the foregoing windings and conduct current Izz.

When controlling in such a manner that the sum of the currents Ia, Ib, Ic, Id, and Ie in the respective phases is zero, the foregoing current Izz is zero, and the transistors 56B and 56C can be omitted. Additionally, the driving circuit shown in FIG. 56 can also drive the current passing through full-pitch windings. The number of phases can also be changed by modifying the driving circuit for phase configurations such as 3-phase or 7-phase.

Additionally, as described above, when the positive and negative currents are applied to the respective windings, the polarities of the stator magnetic poles change. For example, as shown in FIG. 38, the polarities of the stator magnetic poles cannot be fixed. Furthermore, since the permanent magnets PMsbi placed between the stator magnetic poles, as shown in FIG. 38, cannot be mounted, the stator magnetic pole configuration should be structured as shown in FIG. 57. In this case, when driving a particular stator magnetic pole, the adjacent teeth in the circumferential direction cannot be utilized as magnetic paths. As a result, compared to the motor configuration shown in FIG. 38, the maximum magnetic flux density in the air gap portion decreases, thus leading to a reduction in maximum torque. The same applies to motors with 3 phases, 7 phases, 9 phases, etc.

However, even in the stator configuration shown in FIG. 57, which does not have permanent magnets in the stator, the widths of the stator teeth can be increased as shown in FIG. 47. This allows the maximum magnetic flux density near the air gap of the stator magnetic poles to be increased. Additionally, by using materials such as directional electromagnetic steel sheets, super core, or permendur steel sheets for the tooth portion, the passing magnetic fluxes can be increased. Furthermore, by setting the strength of these permanent magnets to be moderated, it is possible to utilize the advantages of driving with the unidirectional electric currents and the advantages of driving with the bidirectional currents.

Claim 13 of the present invention will now be described.

A motor 10S18R shown in FIG. 57 is a full-pitch winding motor that can also operate as a vernier motor when currents are made to flow in both the positive and negative directions. When a vernier motor has the number Npr of rotor magnetic poles, the number Nps of stator magnetic poles, and the number Npvern of magnetic poles, the following relationship is realized:

$$Npr = 2 \times Nsp \pm Npvern \qquad ( 102 )$$

In a case where Nps=10 and Npvern=2, the number of rotor magnetic poles Npr is 18 or 22. The motor shown in FIG. 57 with type of 10S18R, has a stator magnetic pole number Nps of 10 and is one of the motor configurations that follows equation (102).

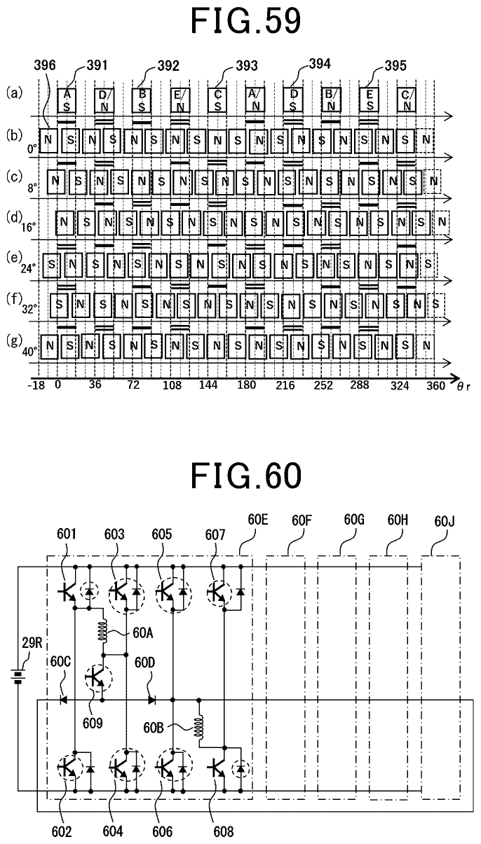

FIG. 59 shows a linearly developed view illustrating the operations of the 10S18R motor shown in FIG. 57. The motor shown in FIG. 59 is provided with a configuration in which a double thick line to the linearly developed view in FIG. 39 is added to indicate the range of stator magnetic poles that can be used for vernier drive by exciting the stator magnetic poles in the reverse direction to obtain CCW torque. The linearly developed view in FIG. 59 is a figure showing the possibility of each stator magnetic pole generating CCW torque, and does not indicate the type of winding and current values. FIG. 59, (a) thereof, shows a linearly developed shape of the stator magnetic pole facing the air gap portion. The A-phase and A/-phase stator magnetic poles are indicated by reference numbers 387 and 388 in FIG. 57. The N and S magnetic poles are shown for reference. These poles indicate the polarity of the stator magnetic poles provided when a positive current is applied to the windings marked with the double circles in FIG. 57. The B-phase and B/-phase stator magnetic poles are indicated by reference numbers 389 and 38A in FIG. 57. The C-phase and C/-phase stator magnetic poles are indicated by reference numbers 38B and 38C in FIG. 57. The D-phase and D/-phase stator magnetic poles are indicated by reference numbers 38D and 38E in FIG. 57. The E-phase and E/-phase stator magnetic poles are indicated by reference numbers 38F and 38G in FIG. 57.

FIG. 59, (b) thereof, shows a linearly projected shape of the rotor N and S magnetic poles which are opposed to each other via the air gap portion. The rotor rotation position is θr=0°, which is the rotor rotation position shown in FIG. 57. The positions indicated by thick lines are the stator magnetic poles that can generate CCW torque when the stator magnetic poles are magnetically excited in the forward direction. The positions indicated by double thick lines represent stator magnetic poles that can generate CCW torque when being magnetically excited in the reverse direction (negative direction). Exciting the four stator magnetic poles (A-phase, D/phase, B-phase, and E/phase) to the S magnetic poles generates CCW torque. Since the rotor is point-symmetric with respect to its center point, exciting the four stator magnetic poles (A/phase, D-phase, B/-phase, and E-phase) to the N magnetic poles generates CCW torque. A specific example of exciting current is as follows: applying a positive current Iac to the AC-phase winding 571 and a negative current Ice to the CE-phase winding 573 will excite the motor to the state shown in FIG. 59(b). The four magnetic flux components, which are a positive A-phase magnetic flux φa, a negative D-phase magnetic flux od, a positive B-phase magnetic flux φb, and a negative E-phase magnetic flux φe, act on the eight stator magnetic poles to generate a counterclockwise (CCW) torque.

In this case, different excitation methods are also possible. For example, since the C-phase and C/-phase stator magnetic poles are at a rotor rotation position θr where no torque is generated, either the positive current in the AC-phase winding 571 or the negative current in the CE-phase winding 573 can generate a counterclockwise (CCW) torque. Additionally, as shown in FIG. 57, adding a negative current Ida as the DA-phase current and a positive current Ieb as the EB-phase current, which are the same magnitude, increases the D-phase magnetic flux φd and φb, thereby increasing the CCW torque.

Furthermore, the BD-phase current Idb affects the magnetic flux of each phase, but at this rotor rotation position, the magnetic fluxes cancel each other out, so that their influence on torque is theoretically minimal.

Similarly, FIG. 59(c) shows that the rotor rotates to a position of θr=8°. When the rotor moves a counterclockwise (CCW) direction, the range of stator magnetic poles capable of generating CCW torque shifts by 72° to the left on the drawing of FIG. 59. When the four stator magnetic poles (E-phase, C/-phase, A-phase, and D/phase) are magnetically excited to the S magnetic pole, a CCW torque is generated. When the four stator magnetic poles (E/-phase, C-phase, A/-phase, and D-phase) are magnetically excited to the N magnetic pole, a CCW torque is generated. An Exciting current is applied to the BD phase winding 572 with a positive current Ibd and to the DA phase winding 574 with a negative current Ida. FIG. 59(d) shows that when the rotor rotates to a position of θr=16°, where applying magnetic excitation to the four stator magnetic poles (C-phase, A/-phase, D-phase, and B/-phase) to the S magnetic poles results in generating a counterclockwise (CCW) torque. Applying magnetic excitation to the four stator magnetic poles (C/-phase, A-phase, D/phase, and B-phase) to the N magnetic pole results in counterclockwise (CCW) torque. The exciting current is applied as a positive current Ice to the CE phase winding 573 and as a negative current Ieb to the EB-phase winding 575. FIG. 59(e) shows that the rotor rotation position is θr=24°, where magnetically exciting the four stator magnetic poles (C-phase, A/phase, D-phase, and B/-phase) with the S magnetic pole, thus generating a CCW torque. Further, mantically exciting the four stator magnetic poles (C/-phase, A-phase, D/-phase, and B-phase) to the N magnetic pole results in generation of a CCW torque.

By applying an exciting current, a positive current Ida is supplied to the DA-phase winding 574 and a negative current Iac is supplied to the AC-phase winding 571. FIG. 59(f) shows that the rotor rotation position is θr=32°, where magnetically exciting the four stator magnetic poles (B-phase, E/-phase, C-phase, and A/-phase) to the S magnetic pole generates a CCW torque. In addition, magnetically exciting the four stator magnetic poles (B/-phase, E-phase, C/-phase, and A-phase) to the N magnetic pole produces a CCW torque. An exciting current is applied as a positive current Ieb to the EB-phase winding 575 and as a negative current Ibd to the BD-phase winding 572. FIG. 59(g) shows that the rotor rotation position is θr=40° and then returns to the state shown in FIG. 59(b). Repeating these operations nine times causes the rotor to rotate 360°, completing one revolution. As described above, the motor can be rotated by applying power in this manner. There is not just one method of applying power; as described above, each power supply current can be adjusted or corrected as necessary.

In the foregoing drive method, a magnetomotive force generated in each current is applied to the four sets of eight stator magnetic poles. Compared to the method of applying the exciting current to each stator magnetic pole, this results in four times the torque being generated with the same current. An induced voltage in the respective windings is also four times greater in the configuration shown in FIG. 59, but in principle, it could be five times greater. When comparing motor copper losses at the same torque, depending on the method of current application, copper losses can be reduced to approximately one-fourth to one-tenth compared to driving each stator magnetic pole individually. Regarding waveform shapes of each current, the foregoing currents must change in accordance with the rotation of the rotor. For example, as shown in FIG. 24, the waveforms can be shaped into trapezoidal shapes with positive and negative values relative to the rotor rotation angle θr. However, there are no specific limitations, and various waveform shapes can be employed. Additionally, as the rotational speed increases, driving with rectangular wave currents becomes difficult due to constraints such as winding inductance, leading to smoother current waveforms, and so, in some cases, sinusoidal alternating current may be used.

Additionally, when driving the motor shown in FIG. 57 as described in FIG. 59, a notable characteristic is that the changes in each current associated with the rotor rotation occur rapidly. In the energization and drive conditions shown in FIG. 59, as the rotor rotates counterclockwise, the current to be energized moves rapidly from the right side to the left side on the paper depicting FIG. 59. For example, between θr=0° in FIG. 59(b) and θr=8° in FIG. 59(c), the current Iac in the AC-phase winding 571 must change to the current Ibd in the BD-phase winding 572 as described above. During the rotation of 8° of the rotor rotation angle θr, the vernier current rotates and moves by 72°. This rotation is nine times faster than the rotation speed of the rotor. At this time, it is necessary to rapidly increase and decrease the current in each phase in accordance with the rotor rotation. The conduction angle width of each winding current is 8° relative to the rotor rotation angle θr. Additionally, as explained in FIG. 59, when magnetically exciting with two full-pitch windings, each winding is interconnected with four magnetic flux components, and due to the large winding inductance, there are also constraints on the time for current increase and decrease. Therefore, when driving the motor shown in FIG. 57 as a vernier motor, there are constraints on high-speed rotation, and it is suitable for high efficiency driving at low speeds. For high speed rotation, there are constraints and issues related to the rate of current increase and decrease.

Furthermore, in the preceding description of FIG. 59, a method of driving by exciting four magnetic flux components mainly with two full-pitch windings has been explained. However, as the rotor rotation speed increases, it is also possible to change the control to a control that prioritizes current controllability over motor torque and motor efficiency. Specifically, for example, in FIG. 59(b), the positive current Iac is applied to the AC-phase winding 571 and the negative current Ice is applied to the CE-phase winding 573. This can be changed to apply the positive current Iac to the AC-phase winding 571 and the positive current Ieb to the EB-phase winding 575. As a result, the magnetic flux components excited by the confirmation shown in FIG. 57 are reduced from “φa, φd, σφb, φe” to “φa, φd, φb”, thereby reducing the number of magnetic flux components to three. This reduces a winding inductance, improves current controllability, and enables control at higher rotational speeds. Alternatively, to reduce the number of magnetic flux components to two (φa and φd), the positive current Iac can be applied to the AC-phase winding 571 and the negative current Ibd to the BD-phase winding 572. Since the interlinkage magnetic fluxes are reduced to two, the winding inductance further decreases, thus improving current control and enabling control at higher rotational speeds. In this way, the magnetic excitation range can be changed by adjusting the currents. Additionally, there are methods to change the current values of two or more windings. The same current settings can be applied to the other rotor rotation angles θr shown in FIG. 59.

In the motor according to the present invention, the magnitudes of the magnetic fluxes generated by the rotor magnetic poles that are basically not magnetically excited is small. Furthermore, the adverse effects caused by the magnetic flux components of the rotor magnetic poles that are not magnetically excited are small. In addition, as one method of driving the motor shown in FIG. 57, it is also possible to drive it by applying a five-phase sinusoidal current. In this case, the phase of the five-phase sinusoidal current should be set so that the phase of the magnetomotive force generated by each phase current is approximately the same as the phase described In FIG. 59.

Furthermore, FIG. 57 and FIG. 59 are examples of driving a five-phase motor as a vernier motor, but motors with three, seven, or nine phases can also be driven in the same manner. An efficiency improvement effect of the vernier motor is significant in multi-phase motors such as 7-phase and 9-phase motors, but conversely, the constraints and issues related to high-speed operation are also significant.

Claim 14 of the present invention will now be explained.

The motor 10S18R shown in FIG. 57 is driven efficiently at low speeds as described in FIG. 59, while at high speeds, the motor is driven by energizing, as shown, the motor configuration shown in FIG. 38 and shown by its linearly developed view in FIG. 39. As described above, the motor 10S18R shown in FIG. 57 can be driven efficiently as described in FIG. 59. However, since it is necessary to rapidly increase and decrease the phase currents, and the winding inductance also becomes large, this results in constraints and issues for high-speed rotation of the motor. On the other hand, in the motor configuration shown by FIG. 38 and shown by the operation explanation of the linearly developed view in FIG. 39, the number of stator magnetic poles generating torque is limited to four, and each pair of stator magnetic poles is magnetically excited and driven by two full-pitch windings on both circumferential adjacent sides. Although the number of stator magnetic poles generating torque is only four, this method utilizes most of the windings and most of the stator magnetic paths for driving, thus enabling the magnetic flux density in the air gap portion to be set to a large value.

To cancel out the interlinkage of magnetic flux components from other phases, two full-pitch windings are connected in series and driven, thus resulting in an average of one magnetic flux component interlinking with each winding. Therefore, the effective winding inductance during magnetic energization is small, thus leading to high-speed current control. The conduction angle width of each winding depends on the stator magnetic pole width and the rotor magnetic pole width. For example, in the configuration shown in FIG. 59, where the conduction angle width is 18°, the conduction angle width is more than twice as large. Therefore, the motor configuration shown in FIG. 38 and the operations shown in FIG. 39 enable faster rotation and driving, compared to the motor shown in FIG. 57 operating as shown in FIG. 59.

The driving circuit shown in FIG. 60 is able to drive the 10S18R motor shown in FIG. 57 as a vernier motor as described in FIG. 59, and to switch its drive modes, thus enabling individual drive of each stator magnetic pole as shown in FIG. 39. As described above, in the positive/negative current drive modes in FIG. 59, the motor operates as a vernier motor with high efficiency in the low-speed rotary range, and in the unidirectional electric current drive mode of FIG. 39, the motor is able to be driven in the high-speed rotary range. The drive mode shown in FIG. 39 can also be driven in the low-speed rotary range.

A driving circuit shown in FIG. 60 is a circuit that reduces, by two phases, the driving circuit in FIG. 35, which is the 7-phase driving circuit for the motor shown in FIG. 34, for a 5-phase motor, and adds transistors to enable switching of the drive modes and driving of positive and negative bidirectional currents. Additionally, the driving circuit shown in FIG. 60 is a driving circuit where the number of stator magnetic pole pairs shown in FIG. 57 is set to 2, or each winding is double-wound, resulting in 10 full-pitch windings. A reference number 60A indicates the AC-phase full-pitch winding shown in FIG. 57 and is subject to supply of an AC-phase current Iac. A reference number 60B indicates the DA-phase full-pitch winding shown in FIG. 57 and is subjected to supply of an DA-phase current Ida.

First, the driving mode of positive and negative bidirectional currents in the driving circuit shown in FIG. 60 will be explained. In this positive and negative current mode, a transistor 609 is turned off. An AC-phase winding 60A can conduct, therethrough, positive or negative currents through transistors 601, 602, 603, and 604 by any controlled manner. A DA-phase winding 60B can also conduct, therethrough, positive or negative currents via transistors 605, 606, 607, and 608 by any controlled manner.

A circuit 60F indicated by a dashed line in FIG. 60 is a driving circuit similar to the driving circuit 60E enclosed by the dashed line. This driving circuit 60F includes a BD-phase winding and an EB-phase winding shown in FIG. 57, thereby creating a positive/negative current mode by turning off the transistor 609. As a result, positive or negative current can be supplied to the BD-phase winding and the EB-phase winding in a controlled manner. Similarly, a driving circuit 60G indicated by the dashed line includes a CE-phase winding and a second AC-phase winding shown in FIG. 57. This driving circuit 60G turns off the transistor 609 to create a positive/negative current mode. This allows positive or negative current to be supplied to the CE-phase winding and the AC-phase winding in a controlled manner. Similarly, a driving circuit 60H indicated by the dashed line includes a second DA-phase winding and a second BD-phase winding shown in FIG. 57. This driving circuit 60H creates a positive/negative current mode by turning off the transistor 609. This allows positive or negative current to be supplied to the DA-phase winding and the BD-phase winding in a controlled manner. Similarly, a driving circuit 60J indicated by the dashed line includes a second EB-phase winding and a second CE-phase winding shown in FIG. 57. This driving circuit 60J creates a positive/negative current mode by turning off the transistor 609. This allows positive or negative current to be supplied to the EB-phase winding and the CE-phase winding in a controlled manner.

Drive modes will now be described in which each stator magnetic pole is driven individually by a unidirectional direct current in the driving circuit shown in FIG. 60. In this individual drive mode which uses a unidirectional electric current, two full-pitch windings that magnetically excite the stator magnetic poles are connected in series, as explained in the drive shown in FIG. 35. As a result, the current components shown in equations (80) to (84) flow, thereby canceling out the induced voltages caused by changes in the magnetic flux of other phases. Therefore, the motor is less susceptible to the influence of other phases.

The specific method for individually driving the stator magnetic poles using the unidirectional electric current will now be described. According to this method, the transistor 609 in FIG. 60 is turned on, and the transistors 602, 603, 604, 605, 606, and 607 are turned off. Then, via the transistor 601, the AC-phase current Iac, which is a unidirectional electric current according to equation (80), is supplied to the AC-phase winding 60A. Additionally, via the transistor 608, the

DA-phase current Ida, which is a unidirectional electric current according to equation (83), is supplied to the DA-phase winding 60B. A reference number 60F shown by the dashed line in FIG. 60 is a driving circuit structured similarly to the one enclosed by the dashed line 60E, and includes a BD-phase winding and an EB-phase winding shown in FIG. 57. Therefore, a transistor corresponding to the transistor 609 is turned on and transistors corresponding to the transistors 602, 603, 604, 605, 606, and 607 are turned off. As the individual drive modes using the unidirectional electric current, the BD-phase current Ibd from equation (81) is supplied to a BD-phase winding, and the EB-phase current Ieb from equation (84) is supplied to an EB-phase winding Similarly, a driving circuit 60G indicated by the dashed line includes a CE-phase winding and a second AC-phase winding shown in FIG. 57, and the CE-phase current Ice is supplied to the CE-phase winding according to equation (82), and the AC-phase current Iac is supplied to the AC-phase winding according to equation (80).

Similarly, a driving circuit 60H indicated by the dashed line includes a second DA-phase winding and a second BD-phase winding shown in FIG. 57, and the DA-phase current Ida calculated using equation (83) is applied to the DA-phase winding, and the BD-phase current Ibd calculated using equation (81) is applied to the BD-phase winding. Similarly, a driving circuit 60J indicated by the dashed line includes a second EB-phase winding and a second CE-phase winding shown in FIG. 57, and the EB-phase current Ieb calculated using equation (84) is supplied to the EB-phase winding, and the CE-phase current Ice calculated using equation (82) is supplied to the CE-phase winding.

In this operating mode, the transistor 601 shown in FIG. 60 corresponds to the transistor 351 shown in FIG. 35, and the transistor 608 corresponds to the transistor 352 shown in FIG. 35. Furthermore, in the driving circuit shown in FIG. 60, the transistors and diodes indicated by dashed circles have been added, compared to the driving circuit shown in FIG. 35, to enable the flow of positive and negative bidirectional currents. Conversely, circuit elements without the dashed circles can be considered to be shared between the two drive modes. Furthermore, the driving circuit shown in FIG. 60 can be modified to reduce the number of transistors by approximately half, as shown in FIG. 50 and FIG. 51, by configuring the number of stator magnetic pole pairs adopted in the 10S18R stator in FIG. 57, not limited to one, but as five sets of full-pitch windings. Furthermore, the driving circuit shown in FIG. 60 can also use the transistors 604 and 605 together in the individual driving mode driven by the unidirectional electric current. Other modifications are also possible.

As described, in the positive and negative current mode of the driving circuit shown in FIG. 60, bidirectional currents are supplied to each full-pitch winding of the motor shown in FIG. 57 to drive the motor as a vernier motor, thus enabling highly efficient operation with low copper loss, especially at low speeds. Additionally, in the individual driving mode of the stator magnetic poles using the unidirectional electric current, high-speed rotation is possible, and short-term high-torque output is also achievable. The motor shown in FIG. 57 using the driving circuit shown in FIG. 60 can be driven in a wide range from a low-speed and high-torque range to a high-speed rotation range, by utilizing both driving modes. Specific application examples include such needs as electric vehicle main motors, typical requirements include low-speed rotation with high torque for climbing steep slopes, relatively low-speed rotation with high-efficiency drive for urban driving, and rapid acceleration/deceleration and high-speed rotation for normal driving and highway driving. Concurrently, electric vehicle transmissions require a simple structure from the perspectives of weight, space, and cost. The foregoing two drive modes can address these requirements.

Claim 15 of the present invention will now be described.

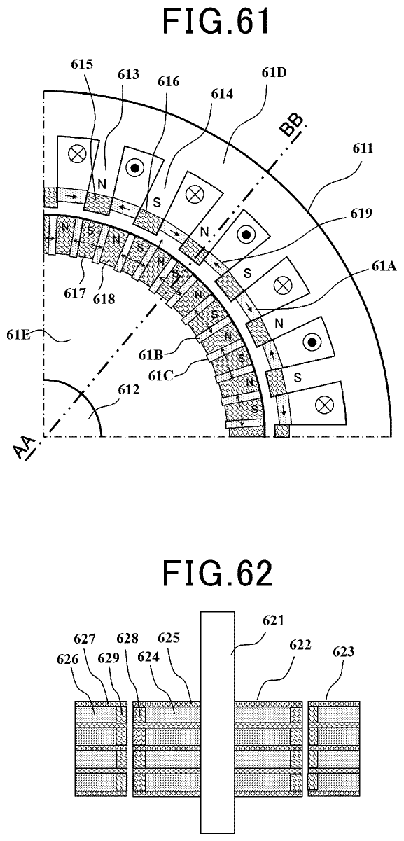

FIG. 61 shows an example of a configuration in which a component with a large maximum magnetic flux density is used as the soft magnetic member near the air gap. This is a method of increasing the maximum magnetic flux density of the air gap and its vicinity, thereby increasing the maximum torque of the motor. Concurrently, this method is also possible to reduce iron loss in the motor and prevent an increase in motor cost. FIG. 61 shows an enlarged view of the upper right portion of the motor shown in FIG. 34, corresponding to the first quadrant. A reference number 611 indicates a stator, and a reference number 612 indicates a rotor shaft. A reference number 613 indicates an N magnetic pole of the stator, and a reference number 615 indicates a permalloy steel plate used near the air gap at the tip of the respective magnetic poles. A reference number 614 indicates a stator S magnetic pole, and a reference number 616 indicates a permanent magnet steel plate used near the air gap at the tip of the respective magnetic poles. A reference number 617 indicates a rotor S magnetic pole, and a reference number 617 indicates a permanent magnet steel plate used near the air gap at the tip of the respective magnetic poles. A reference number 614 indicates a rotor N magnetic pole, and a reference number 618 indicates a permanent magnet steel plate used near the air gap at the tip of the respective magnetic poles. Reference numbers 619, 61A, 61B, and 61C show permanent magnets whose structures are similar to those shown in FIG. 34. A reference number 61D shows an electromagnetic steel plate that constitutes the main parts of the stator back yoke. A reference number 61E is an electromagnetic steel plate that constitutes the main parts of the rotor back yoke. These electromagnetic steel plates are laminated to form a core serving as a motor component, and further processing and assembly are performed.

As previously explained, in the motor of the present invention shown in FIG. 1 and FIG. 34, the effect of utilizing the magnetic flux of the rotor magnetic poles, which is given by utilizing the circumferential magnetic paths adjacent to each rotor magnetic pole to be operated, is employed. However, in such a motor configuration, even though it is only in the extremely limited area near the air gap of the respective rotor magnetic poles, when being excited with a large current, the magnetic flux becomes concentrated at the limited aera. This magnetic flux concentration can cause the magnetic flux density to exceed the saturation magnetic flux density of the soft magnetic member. As a result, problems arise such as the need for a large magnetomotive force [A·turn] to excite the magnetically saturated region, and the need for magnetomotive force in the surrounding permanent magnets, which requires consideration of magnetic properties and thickness [A/m·m]. Similar issues also arise for the stator magnetic poles. Additionally, even in motors like those shown in FIG. 1, where permanent magnets such as 619 and 61A are not installed in the stator, similar issues may occur when the tooth width of the stator is increased or when soft magnetic members with higher magnetic flux density are used for the teeth.

FIG. 61 explains a method for reducing the problems due to high magnetic flux densities. Permenjule steel plates 615, 616, 617, and 618 are used at the tips of the respective magnetic poles near the air gap between the rotor and stator. Since permenjule steel plates have a high saturation magnetic flux density, use of such permenjule steel plates can reduce the foregoing excitation load. Permenjule steel plates have a saturation magnetic flux density of approximately 2.4 [T], which allows it to handle a large magnetic flux, compared to currently available soft magnetic materials. However, Permendur steel plates contain an approximately 50% of cobalt (Co), thus being expensive, thus being used only in specific areas. In applications with strict cost constraints, the use of permenjule can be further reduced to an absolute minimum required in the pole regions, as shown in FIG. 61.

Furthermore, the motor of the present invention shown in FIG. 34 and FIG. 61 also require a reduction in iron loss when the rotor rotation speed increases. In particular, when the number of magnetic poles of the rotor is large, there is a problem of increased iron loss. Amorphous steel sheets or laminated cores are known to have iron loss that is ⅕ or 1/10 of that of conventional electromagnetic steel sheets. The low-iron loss soft magnetic member material can be used in the electromagnetic steel plates 61D and 61E shown in FIG. 61. The configuration of FIG. 61 enables low iron loss even at high rotational speeds, achieving high efficiency and large torque. Furthermore, power devices such as high-speed power MOSFETs, SiC, and GaN are expected to be used.

In addition, various materials can be used as soft magnetic member materials. Amorphous steel sheets have low iron loss but a relatively low saturation magnetic flux density of approximately 1.5 T and a thin sheet thickness of 25 [μm], so strength measures are necessary. Permenjule steel plates have a high maximum magnetic flux density of approximately 2.4 [T] but having a thin sheet thickness of 0.1 [mm], so that strength measures are necessary. In addition to conventional electromagnetic steel sheets with approximately 3.5% silicon, electromagnetic steel sheets with approximately 6.5% silicon are also commercially available, touted as super core, for their isotropy, high magnetic flux density, and low iron loss. However, with a plate thickness of approximately 0.1 [mm], strength measures are necessary. By using directional electromagnetic steel sheets for the stator teeth, it is possible to increase magnetic flux density and reduce iron loss. By combining these soft magnetic members, the motor configuration shown in FIG. 61 can be achieved. Furthermore, it is also possible to combine three or more types of soft magnetic members.

Additionally, as mentioned earlier, to reduce iron loss, various soft magnetic members are made thinner, which leads to issues such as insufficient strength, difficulty in sheet processing, and problems with layering and assembly. Furthermore, the rotor is subjected to a centrifugal force during rotation. As a countermeasure, the motor configuration shown in FIG. 62 can be adopted. FIG. 62 is an example of the cross-sectional view of an AA-BB section indicated by a two-dot line shown in FIG. 61. In this motor configuration, a reference number 621 indicates a rotor shaft, a reference number 622 indicates a rotor, and a reference number 623 indicates a stator. Reference numbers 625 and 627 indicate multiple layers of soft magnetic members with relatively high strength, arranged at intervals along the rotor shaft direction to reinforce the soft magnetic members 624 of the rotor and 626 of the stator. Reference numbers 624 and 626 indicate, for example, laminated bodies made of amorphous steel sheets with low iron loss. Moreover, reference numbers 628 and 629 indicate, for example, laminated bodies made of permalloy steel sheets with high saturation magnetic flux density. Additionally, the rotor requires particularly high strength due to the centrifugal force acting during rotation, whereas the stator does not experience centrifugal force, so that different configurations may be used. Furthermore, since the stator is not subjected to the centrifugal force during rotation, the soft magnetic member component 627 may be thinner or made of a different material.

The foregoing describes the present invention, but various modifications, applications, and combinations are still possible. The number of phases of the motor can be increased to five, seven, nine, eleven, or more, and other modifications are possible. The number of poles of the rotor can also be selected. In addition, the stator windings can be configured as distributed windings, short-pitch windings, toroidal windings (ring windings), and so on. Furthermore, for applications requiring high torque or minimizing losses, superconducting windings can be used in the windings.

Regarding motor configurations, it is possible to select from various motor shapes such as outer rotor type motors, axial gap type motors, or linear motors. Furthermore, it is possible to configure a composite motor with two motor elements in the inner and outer diameter directions, which enables effective utilization of the inner diameter space, simplification of the windings through toroidal windings (ring windings), and reduction of the coil end length in the rotor axis direction. Toroidal windings (ring windings) can be wound in an electromagnetically equivalent manner to concentrated windings. It can also be wound in an electromagnetically equivalent manner to full-pitch windings. Furthermore, it is possible to configure a composite motor with two motor elements in the rotor axis direction, and it is also possible to combine it with other types of motor elements. The power supply method for the rotor field windings includes non-contact power supply from the stator windings to the windings wound on the rotor core, power supply using an additional rotating transformer, and power supply using brushes and slip rings.

Additionally, various permanent magnets can be used, and it is possible to vary the magnetic properties of the magnets during operation. Varying magnets can be achieved using motor current or through dedicated devices. Furthermore, permanent magnets can be replaced by soft magnetic members and excitation windings by applying an exciting current. Furthermore, sensorless position detection technology can be utilized by taking advantage of the fact that the induced voltage and magnetic properties of each winding change with the rotation of the rotor. Additionally, to reduce motor torque ripple, vibration, and noise, deformation can be performed by moving some of the rotor magnetic poles circumferentially, i.e., by moving the electrical angular position of permanent magnets near the rotor periphery circumferentially. Since automotive main motors are primarily used for forward motion, a motor structure that prioritizes unidirectional torque is acceptable. Power control elements were described using transistors as an example, but various power control elements such as IGBTs, power MOSFETs, GaN semiconductors, and SiO semiconductors can be used. Technologies that apply or modify these are also included in the scope of the present invention.

### INDUSTRIAL APPLICABILITY

The present invention enables the motor to be driven with a larger magnetic flux, thereby increasing the magnetic flux density in the air gap portion and increasing torque.

This advantage also reduces copper loss, improves efficiency, enables miniaturization, and lowers costs. Therefore, the present invention can be used in main motors for electric vehicles, industrial motors, home appliance motors, and the like.

### PARTIAL REFERENCE SIGNS LIST

11 A-phase stator S magnetic pole
12 C/-phase stator N magnetic pole
13 B-phase stator S magnetic pole
14 A/-phase stator N magnetic pole
15 C-phase stator S magnetic pole
16 B/-phase stator N magnetic pole
17 stator
1A A-phase winding
1B C/-phase winding
1C B-phase winding
1D A/-phase winding
1E C-phase winding
1F B/-phase winding
1G rotor S magnetic pole
1J rotor S magnetic pole
1H rotor N magnetic pole
1S rotor shaft
1N, 1P, 1Q, 1R permanent magnets equipped in rotor

What is claimed is:

1. A motor comprising:
a plurality of stator magnetic poles Ps arranged in a stator in a circumferential thereof;
a plurality of slots SLs each provided between adjacent two of the respective stator magnetic poles Ps;
a plurality of stator windings each provided at each of the slots SLs and configured to magnetically excite each of the stator magnetic poles Ps;
unidirectional drive circuits Dhv each driving one-way current to each of the stator windings Ws;
a plurality of rotor N magnetic poles Prn arranged in a rotor in a circumferential thereof;
a plurality of rotor S magnetic poles Prs arranged in the rotor alternately to each of the rotor N magnetic poles Prn in the circumferential of the rotor;
a magnetic path MPrn made of a soft magnetic material and configured to magnetically connect each of the rotor N magnetic poles Prn to a rotor-common back yoke;
a magnetic path MPrs made of the soft magnetic material and configured to magnetically connect each of the rotor S magnetic poles Prs to the rotor-common back yoke; and
a permanent magnet PMrbi arranged between the magnetic path MPrn and the magnetic path MPrs which are arranged in the circumferential and provided to have magnetic poles whose direction is matched with both the rotor magnetic poles Prn and Prs.

2. The motor according to claim 1, characterized in that
the stator magnetic poles Ps are equipped with
stator N magnetic poles Psn, functioning as N magnetic poles, which are N magnetic poles and S magnetic poles alternately arranged in the circumferential;
stator S magnetic poles Pss, functioning as S magnetic poles, which are alternately arranged with the stator N magnetic pole Psn in the circumferential; and
permanent magnets PMsbi, each of which is arranged between the stator N magnetic pole Psn and the stator S magnetic pole Pss which are aligned in the circumferential, the permanent magnets being arranged to be oriented such that that the magnetic poles of the respective permanent magnets are made to agree with magnetic poles of both the stator magnetic poles Psn and Pss.

3. The motor according to claim 1, characterized in that
the stator magnetic-pole windings Ws are concentrated windings Wscp that magnetically excite each of the stator magnetic poles Ps.

4. The motor according to claim 1, characterized in that
the stator magnetic-pole windings Ws are full-pitch stator windings Wsfp with a winding pitch having approximately ½ of a cycle of magnetic-pole pairs of the stator.

5. The motor according to claim 1, characterized in that the motor comprises
Nps stator magnetic poles Ps, wherein Nps=2+4×Ns; and
rotor N magnetic poles Prn and rotor S magnetic poles Prs, which are in total Npr pieces, wherein Npr=2+4×Nr, Ns and Nr being integers greater than or equal to 1.

6. The motor according to claim 1, characterized in that
the number of phases of the plurality of stator magnetic poles Ps is Nph, and
the motor is provided with Nph stator magnetic poles which are partially provided in the stator in the circumferential, wherein phases of the stator magnetic poles to the rotor magnetic poles differ from each other by (2×θppr)/Nph, which are provided when the pitches of the rotor magnetic poles of the N-magnetic poles Prn and the S-magnetic poles Prs which are arranged alternately in the circumferential of the rotor, is given as θppr, and Nph is an integer greater than or equal to 2.

7. The motor according to claim 1, characterized in that
when a circumferential length of the magnetic poles facing an air gap portion of the stator magnetic poles Ps is Lsg, a circumferential width of a portion of teeth of the stator magnetic poles Ps is a width which is larger than Lsg by an amount of 20% or more.

8. The motor according to claim 1, characterized in that
the motor is equipped with permanent magnets PMssur whose polarities are made to agree with the polarities of the stator magnetic poles, the permanent magnets being arranged closer to an air gap faced to the N-magnetic pole Psn and the S-magnetic pole Pss of the stator magnetic pole Ps.

9. The motor according to claim 4, characterized in that the motor is provided with
the stator magnetic poles Ps whose number is Nkb×N1, of which stator magnetic poles Ps1, Ps2, Ps3, Ps4, and Ps5 are aligned in the circumferential;
a slot SLs1 located between the stator magnetic poles Ps1 and Ps2;
a slot SLs2 located between the stator magnetic poles Ps2 and Ps3;
a slot SLs3 located between the stator magnetic poles Ps3 and Ps4;
a slot SLs4 located between said stator magnetic pole Ps4 and Ps5;
a full-pitch winding Wsfp1, which is wound between two slots approximately ½ of a cycle of the stator pole pairs apart and is located in slot SLs1;
similarly, a full-pitch winding Wsfp2 arranged in the slot SLs2;
similarly, a full-pitch winding Wsfp3 arranged in the slot SLs3;
similarly, a full-pitch winding Wsfp4 arranged in the slot SLs4;
a rotor equipped with at least Nkb×N2 rotor magnetic poles of N magnetic poles and S magnetic poles arranged alternately in a circumference;
a transistor TR1 connected in series with the full-pitch winding Wsfp1;
a transistor TR2 connected in series with the full-pitch winding Wsfp2;
a transistor TR3 connected in series with the full-pitch winding Wsfp3; and
a transistor TR4 connected in series with the full-pitch winding Wsfp4;
wherein
the transistor TR1 energizes the full-pitch winding Wsfp1 with a DC current Isfp1 and connects the full-pitch winding Wsfp1 and the full-pitch winding Wsfp2 in series with the transistor TR2,
the transistor TR2 energizes the full-pitch winding Wsfp2 with a DC current Isfp2 and connects the full-pitch winding Wsfp2 and the full-pitch winding Wsfp3 in series with the transistor TR3;
the transistor TR3 energizes the full-pitch winding Wsfp3 with a DC current Isfp3 and connects the full-pitch winding Wsfp3 and the full-pitch winding Wsfp4 in series with the transistor TR4;
the transistor TR4 energizes the full-pitch winding Wsfp4 with a DC current Isfp4;
each of the full-pitch windings connected in series and each of the transistors TR1, TR2, TR3, and TR4 magnetically excite each of the stator magnetic poles Ps1, Ps2, Ps3, Ps4, and Ps5 by energizing each exciting current thereto; and
when the motor has three full-pitch windings, the full-pitch winding Wsfp1 and the full-pitch winding Wsfp4 are composed of the same winding, and the full-pitch winding Wsfp3 and the full-pitch winding Wsfp1 are arranged in parallel and connected to the transistor TR4 to conduct a DC current thereto,
wherein Nkb is the number of stator pole pairs and is an integer greater than or equal to 1, N1 is an integer greater than or equal to 6, and N2 is an integer greater than or equal to 6.

10. The motor according to claim 1, characterized in that
the respective phase windings of the stator windings Ws is configured to be supplied continuously with magnetic flux exciting current components depending on drive conditions thereof, or, magnetic flux exciting windings are wound in respective slots of the stator and connected in series to supply magnetic flux exciting currents thereto.

11. The motor according to claim 1, characterized in that the motor is equipped with
a DC power source POS2;
a DC power source POS3 connected in series with the DC power source POS2;
an intermediate potential portion TYV located between the DC power source POS2 and the DC power source POS3;
a transistor TR7 connected to the DC power source POS2;
a winding Ws2 arranged between the transistor TR7 and the intermediate potential portion TYV;
a transistor TR8 connected to the DC power supply POS3; and
a winding Ws3 arranged between the transistor TR8 and the intermediate potential portion TYV,
wherein both the DC power supply POS2 and the DC power supply POS3 are configured to supply the currents to the respective stator windings Ws.

12. The motor according to claim 1, characterized in that the motor is equipped with a reverse direction driving circuit Drhv configured to add negative current components to positive current components passing the stator windings Ws.

13. The motor according to claim 1, characterized in that the motor is equipped with a full-pitch winding Wsfpv1 arranged in a slot Slsv located adjacently to one of the stator magnetic poles Psv1, the full-pitch winding Wsfpv1 being supplied with a current component Isfpv1, and
the stator magnetic poles Psv1 include one or more full-pitch windings WsfpvN, arranged in one or more slots which are apart, by 2 or more slots, from the slot Slsv in an opposite direction to the slot Slsv in the circumferential, the one or more full-pitch windings WsfpvN being supplied with a part or all of a current component (−Isfpv1).

14. The motor according to claim 13, characterized in that
when the rotor is driven at a low-speed rotation, the stator magnetic poles PsvN are excited by the current component Isfpv1 and the part or all of a current component (−Isfpv1) supplied to the one or more full-pitch windings WsfpvN, and
when the rotor is driven at a high-speed rotation, full-pitch windings WsfpvF and Wsfpv, which are mutually adjacently located in the circumferential, are serially connected among the stator magnetic poles PsvN and supplied with a current component IsvN for exciting the stator magnetic poles PsvN.

15. The motor according to claim 1, characterized in that the rotor includes a main magnetic circuit composed of a soft magnetic member MagA, and
a soft magnetic member MagB is provided at a portion of both the rotor N magnetic poles Prn and the rotor S magnetic poles Prs, the portion being closer to the air gap, the soft magnetic member MagB being larger, in a saturation magnetic flux density, than the soft magnetic member MagA.
